(19) United States
(12) Patent Application Publication
(10) Pub. No.: US 2025/0322581 A1
(43) Pub. Date: Oct. 16, 2025

(54) INFORMATION PROCESSING APPARATUS, SCREEN GENERATION METHOD, NON-TRANSITORY RECORDING MEDIUM, AND INFORMATION PROCESSING SYSTEM

(71) Applicants: Naoki MOTOHASHI, Kanagawa (JP); Koretaka OGATA, Kanagawa (JP)

(72) Inventors: Naoki MOTOHASHI, Kanagawa (JP); Koretaka OGATA, Kanagawa (JP)

(21) Appl. No.: 19/080,253

(22) Filed: Mar. 14, 2025

(30) Foreign Application Priority Data
Apr. 10, 2024 (JP) 2024-063223
Apr. 30, 2024 (JP) 2024-073476
Jan. 20, 2025 (JP) 2025-007973

(51) Int. Cl. G06T 15/00; G06T 5/50

(52) U.S. Cl. CPC G06T 15/00; G06T 5/50; G06T 2207/20221

(57) ABSTRACT

An information processing apparatus includes circuitry to generate a screen including a first display area displaying a first predetermined-area image being a first predetermined area of a first image obtained by capturing an object by an image capturing device at a first position, a three-dimensional image display area displaying at least a part of a three-dimensional image aligned with the first image and a position image indicating a second position of the image capturing device at a specific image capturing date and time, and a second display area in which a specific image indicating a position of a specific area specified in a second image obtained at the specific image capturing date and time associated with the second position is superimposed on a second predetermined-area image being a second predetermined area of the second image based on the second predetermined area-image and the specific area stored in a memory.

### CROSS-REFERENCE TO RELATED APPLICATIONS

This patent application is based on and claims priority pursuant to 35 U.S.C. § 119 (a) to Japanese Patent Application Nos. 2024-063223, filed on Apr. 10, 2024, 2024-073476, filed on Apr. 30, 2024, and 2025-007973, filed on Jan. 20, 2025, in the Japan Patent Office, the entire disclosure of which is hereby incorporated by reference herein.

### BACKGROUND

### Technical Field

The present disclosure relates to an information processing apparatus, a screen generation method, a non-transitory recording medium, and an information processing system.

### Related Art

Currently, wide-field images with a wide field of view, such as 360-degree images (spherical images, omnidirectional images, or all-round images) capturing the entire surrounding area, are known as imaging ranges that include areas not covered by the regular field of view.

When such an entire wide-field image is displayed on a display terminal, the wide-field image is curved, and a user has difficulty viewing the displayed wide-field image. To cope with this, the display terminal displays a predetermined-area image indicating a predetermined area in the wide-field image to allow the user to view the predetermined-area image.

### SUMMARY

The present disclosure described herein provides an information processing apparatus including circuitry to generate a screen including a first captured image display area and a three-dimensional image display area. The first captured image display area displays a first predetermined-area image being a first predetermined area of a first captured image. The first captured image is obtained by capturing an object by an image capturing device at a first image capturing position. The three-dimensional image display area displays at least a part of a three-dimensional image aligned with the first captured image. The three-dimensional image includes a position image indicating a second image capturing position of the image capturing device at a specific image capturing date and time. The screen further includes a second captured image display area in which a specific image indicating a position of a specific area specified in a second captured image is superimposed on a second predetermined-area image being a second predetermined area of the second captured image, based on the second predetermined-area image and the specific area that are stored in a memory. The second captured image is obtained at the specific image capturing date and time associated with the second image capturing position.

The present disclosure described herein provides a screen generation method including generating a screen including a first captured image display area and a three-dimensional image display area. The first captured image display area displays a first predetermined-area image being a first predetermined area of a first captured image. The first captured image is obtained by capturing an object by an image capturing device at a first image capturing position. The three-dimensional image display area displays at least a part of a three-dimensional image aligned with the first captured image. The three-dimensional image includes a position image indicating a second image capturing position of the image capturing device at a specific image capturing date and time. The screen further includes a second captured image display area in which a specific image indicating a position of a specific area specified in a second captured image is superimposed on a second predetermined-area image being a second predetermined area of the second captured image, based on the second predetermined-area image and the specific area that are stored in a memory. The second captured image is obtained at the specific image capturing date and time associated with the second image capturing position.

The present disclosure described herein provides a non-transitory recording medium storing a plurality of instructions which, when executed by one or more processors, causes the one or more processors to perform the above-described method.

The present disclosure described herein provides an information processing system including the above-described information processing apparatus and a display terminal to display the screen. The display terminal is communicably connected to the information processing apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A, 1B, and 1C are a left side view, a front view, and a plan view of an image capturing apparatus, respectively;

FIG. 2 is a diagram illustrating how the image capturing device of FIGS. 1A to 1C is used;

FIG. 3A is a diagram illustrating a hemispherical image (front side) captured by the image capturing device of FIGS. 1A to 1C;

FIG. 3B is a diagram illustrating a hemispherical image (back side) captured by the image capturing device of FIGS. 1A to 1C;

FIG. 3C is a diagram illustrating an image represented by Mercator projection;

FIG. 4A is a diagram illustrating how a Mercator projection image covers the surface of a sphere;

FIG. 4B is a diagram illustrating a spherical image;

FIG. 5 is an illustration of the relative positions of a virtual camera and a predetermined area in a case where a spherical image is represented as a surface area of a three-dimensional solid sphere;

FIG. 6A is a perspective view of FIG. 5;

FIG. 6B is a diagram illustrating a predetermined-area image of FIG. 6A being displayed on a display;

FIG. 6C is a diagram illustrating a predetermined area after the viewpoint of a virtual camera in FIG. 6A is changed;

FIG. 6D is a diagram illustrating a predetermined-area image of FIG. 6C being displayed on a display;

FIG. 7 is a diagram illustrating points in a three-dimensional Euclidean space defined in spherical coordinates;

FIG. 8 is a diagram illustrating a relation between a predetermined area and a point of interest;

FIG. 9 is a schematic diagram of a communication system;

FIG. 10 is a block diagram illustrating a hardware configuration of the image capturing device of FIGS. 1A to 1C;

FIG. 11 is a block diagram illustrating a hardware configuration of a relay device;

FIG. 12 is a block diagram illustrating a hardware configuration of any one of a communication control apparatus and a communication terminal;

FIG. 13 is a block diagram illustrating a functional configuration of the communication system of FIG. 9;

FIG. 14 is a schematic diagram of a user/device management table;

FIG. 15 is a schematic diagram of a virtual room management table;

FIG. 16 is a schematic diagram of a three-dimensional image management table;

FIG. 17 is a schematic diagram of a three-dimensional image management table;

FIG. 18 is a schematic diagram of a movement history management table;

FIG. 19 is a sequence diagram illustrating a communication process in relation to content data in the communication system of FIG. 9;

FIG. 20 is a sequence diagram illustrating a process for starting image recording and sound recording in the communication system of FIG. 9;

FIG. 21 is a sequence diagram illustrating a process for stopping image recording and sound recording in the communication system of FIG. 9;

FIG. 22 is a sequence diagram illustrating a process for playback of a recorded image and recorded sound in the communication system of FIG. 9;

FIG. 23 is a diagram illustrating a recorded data selection screen;

FIG. 24 is a flowchart of a part of a screen display process performed by the communication control apparatus of FIG. 12;

FIG. 25 is a flowchart of another part of the screen display process performed by the communication control apparatus of FIG. 12;

FIG. 26 is a diagram illustrating an example of an initial display screen displayed on the communication terminal of FIG. 12;

FIG. 27 is a diagram illustrating an example of a screen displayed on the communication terminal of FIG. 12 and including a specific area that has been specified;

FIG. 28 is a diagram illustrating a screen in which a corresponding predetermined area, an icon of a virtual camera, and the line of sight of the virtual camera are displayed in a display area;

FIG. 29 is a diagram illustrating an example of a screen displayed on the communication terminal of FIG. 12 and including a specific area that has been specified;

FIG. 30 is a diagram illustrating a screen on which a display area for displaying text information is displayed;

FIG. 31 is a diagram illustrating an example of a screen displayed on the communication terminal of FIG. 12 and including a specific area that has been specified;

FIG. 32 is a diagram illustrating an example of a screen displayed on the communication terminal of FIG. 12 and including a specific area that has been specified;

FIG. 33 is another diagram illustrating a screen displayed on the communication terminal of FIG. 12, which includes an icon of a virtual camera, a corresponding predetermined area, and the line of sight of the virtual camera, each being superimposed on a display area;

FIG. 34 is a diagram illustrating an example of a screen displayed on the communication terminal of FIG. 12 and including multiple specific areas that have been specified;

FIG. 35 is a diagram illustrating an example of a screen displayed on the communication terminal of FIG. 12 and including multiple specific areas that have been specified;

FIG. 36 is a schematic diagram of a movement history management table;

FIG. 37 is a diagram illustrating an example of an initial display screen displayed on the communication terminal of FIG. 12;

FIG. 38 is a diagram illustrating a screen in which a corresponding predetermined area, an icon of a virtual camera, and the line of sight of the virtual camera are displayed in a display area;

FIG. 39 is a diagram illustrating an example of a screen displayed on the communication terminal of FIG. 12 and including a specific area that has been specified;

FIG. 40 is a flowchart of a part of a screen display process, performed by the communication control apparatus of FIG. 9 after registering an image capturing date and time;

FIG. 41 is a flowchart of a part of a screen display process, performed by the communication control apparatus of FIG. 9 after registering an image capturing date and time;

FIG. 42 is a diagram illustrating a screen for displaying the current predetermined-area image at the communication terminal of FIG. 9, after registering an image capturing date and time;

FIG. 43 is a diagram illustrating a screen for displaying the current predetermined-area image at the communication terminal of FIG. 9, after registering an image capturing date and time;

FIG. 44 is a flowchart of a part of a screen display process, performed by the communication control apparatus of FIG. 9 after registering an image capturing date and time;

FIG. 45 is a flowchart of a part of a screen display process, performed by the communication control apparatus of FIG. 9 after registering an image capturing date and time;

FIG. 46 is a diagram illustrating a screen for displaying the current predetermined-area image at the communication terminal of FIG. 9, after registering an image capturing date and time;

FIG. 47 is a diagram illustrating a screen for displaying the current predetermined-area image at the communication terminal of FIG. 9, after registering an image capturing date and time; and

FIG. 48 is a diagram illustrating a screen for displaying the current predetermined-area image at the communication terminal of FIG. 9, after registering an image capturing date and time.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the attached drawings.

### Overview of Spherical Image

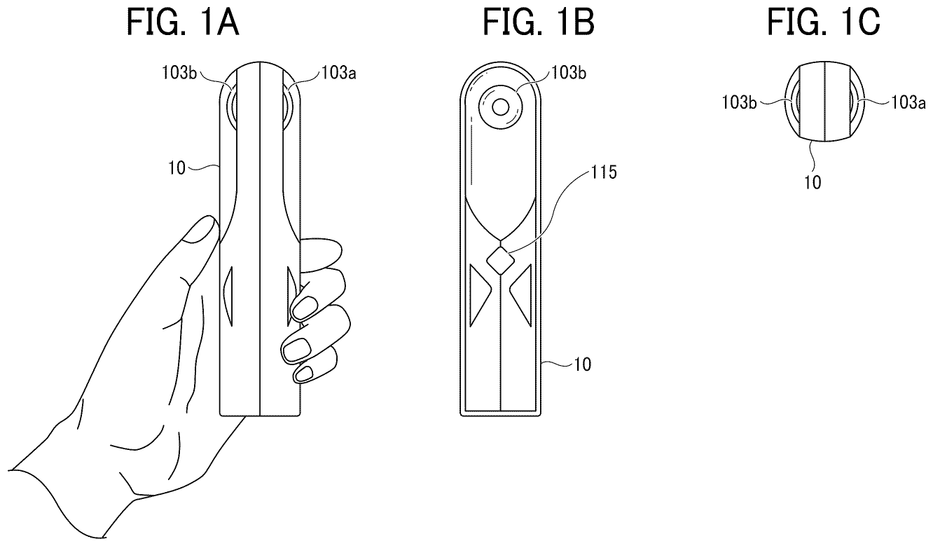

A method for generating a spherical image is described with reference to FIGS. 1 (1A to 1C) to 8. The spherical image is also referred to as a spherical panoramic image or a 360-degree panoramic image. The spherical image is an example of a wide-field video (wide-field moving image) having a wide field of view. The wide-field image includes a 180-degree panoramic image.

An external view of an image capturing device 10 is described with reference to FIG. 1 (FIGS. 1A to 1C). The image capturing device 10 is a digital camera for acquiring an image to be a spherical image. FIG. 1A, FIG. 1B, and FIG. 1C are a left side view, a front view, and a plan view, respectively, of the image capturing device 10.

As illustrated in FIG. 1A, the image capturing device 10 is sized to be held by hand. As illustrated in FIGS. 1A to 1C, the image capturing device 10 is provided with an imaging element 103a on the front side (anterior side) and an imaging element 103b on the back side (rear side) in the upper section. As illustrated in FIG. 1B, the image capturing device 10 is also provided with an operation unit 115 such as a shutter button on the opposite side of the front side.

The usage scenario of the image capturing device 10 is described below with reference to FIG. 2. FIG. 2 is a diagram illustrating how the image capturing device 10 is used. As illustrated in FIG. 2, the image capturing device 10 is communicably connected to a relay device 3 installed on a table 2 and is used to capture or acquire an image including the surrounding objects and scenery. The imaging elements 103a and 103b illustrated in FIG. 1A to FIG. 1C capture the surrounding objects of the user to obtain two hemispherical images. If the image capturing device 10 does not transmit the captured spherical images to another communication terminal or system, the relay device 3 is not needed.

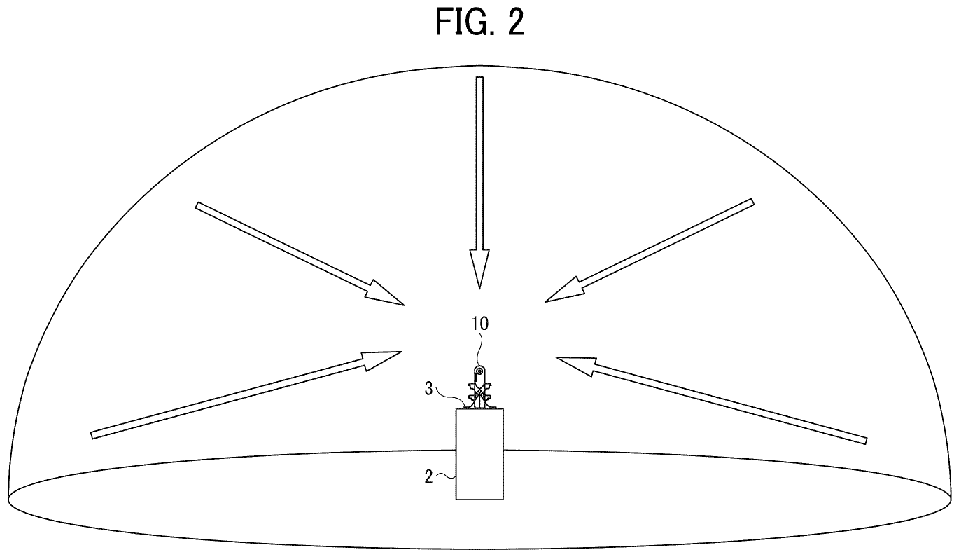

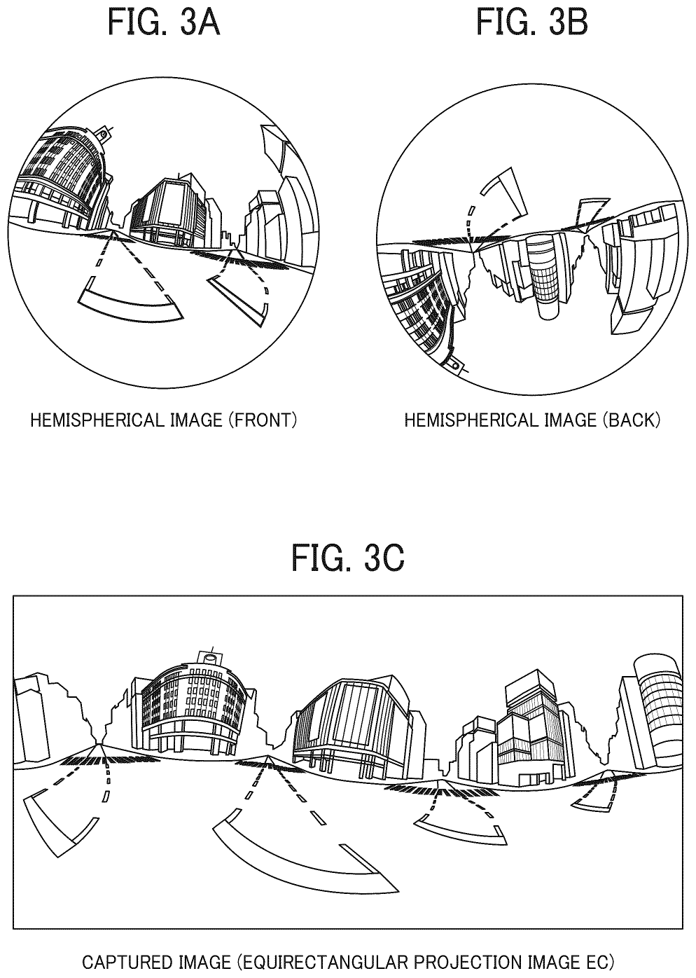

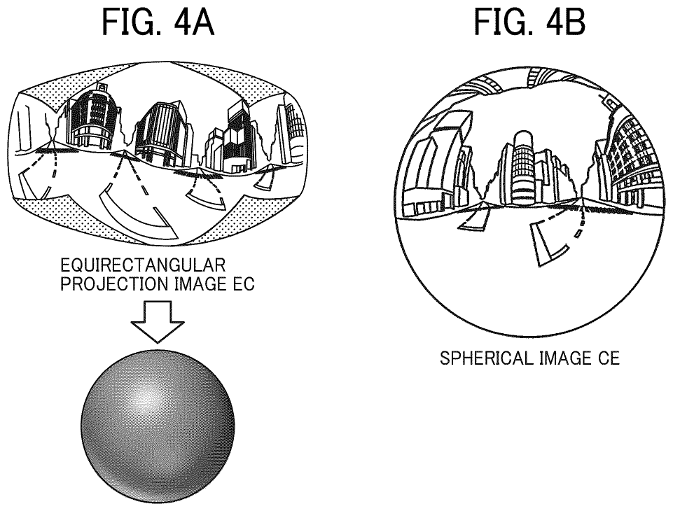

An overview of a process of generating a spherical image from images captured by the image capturing device 10 is described below with reference to FIG. 3 (FIG. 3A to FIG. 3C) and FIG. 4 (FIG. 4A and FIG. 4B). FIG. 3A is a diagram illustrating a hemispherical image (front side) captured by the image capturing device 10. FIG. 3B is a diagram illustrating a hemispherical image (back side) captured by the image capturing device 10. FIG. 3C is a diagram illustrating an image in equirectangular projection. The image in equirectangular projection may be referred to as an “equirectangular projection image.” For example, an image in Mercator projection may be used. The image in Mercator projection may be referred to as a “Mercator image.” FIG. 4A is a diagram illustrating an equirectangular projection image to cover a sphere. FIG. 4B is a diagram illustrating a spherical image. The “equirectangular projection image” is a spherical image in an equirectangular format and is an example of the wide-field image described above.

As illustrated in FIG. 3A, an image captured by the imaging element 103a is a hemispherical image (front side) curved by a wide-angle lens 102a such as a fisheye lens, which is described later. As illustrated in FIG. 3B, an image captured by the imaging element 103b is a hemispherical image (back side) curved by a wide-angle lens 102b such as a fisheye lens, which is described later. The image capturing device 10 combines the hemispherical image (front side) and the hemispherical image (rear side) inverted by 180 degrees to create an equirectangular projection image EC as illustrated in FIG. 3C.

The image capturing device 10 uses Open Graphics Library for Embedded Systems (OpenGL ES) to map the equirectangular projection image EC in a manner that the sphere surface is covered as illustrated in FIG. 4A to generate a spherical image CE as illustrated in FIG. 4B. In other words, the spherical image CE is represented as an image corresponding to the equirectangular projection image EC oriented toward the center of the sphere. OpenGL ES is a graphic library used for visualizing two-dimensional (2D) data and three-dimensional (3D) data. OpenGL ES is an example of software that executes image processing. Software other than Open ES may be used to generate the spherical image CE. The spherical image CE is either a still image or a moving image. Although the image capturing device 10 generates a spherical image in the above description, a communication control apparatus 5, a communication terminal 7, or a communication terminal 9 may perform substantially the same image processing or a part of the image processing instead of the image capturing device 10.

A Mercator image is mapped to cover a sphere surface using OpenGL ES as illustrated in FIG. 4A to generate a spherical image as illustrated in FIG. 4B. In other words, the spherical image is represented as an image corresponding to the Mercator image oriented toward the center of the sphere. OpenGL ES is a graphic library used for visualizing 2D data and 3D data.

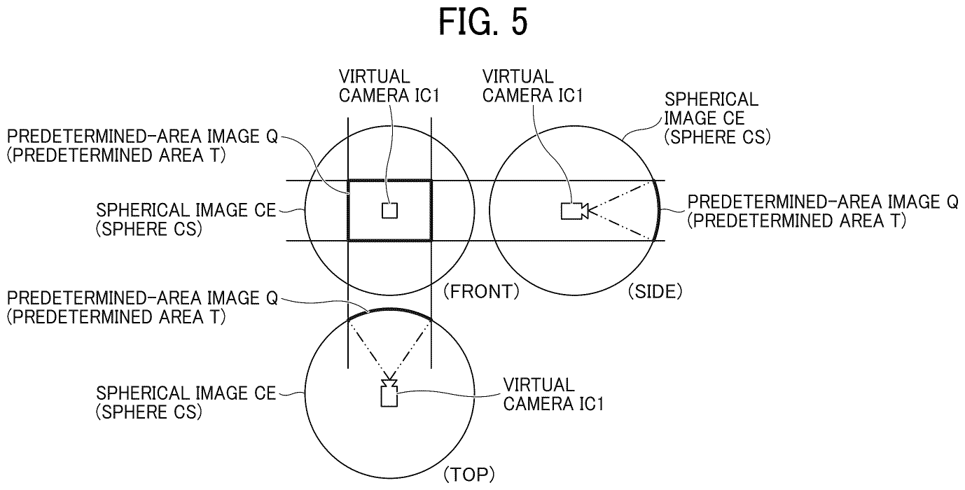

As described above, since the spherical image CE is an image mapped to the sphere surface to cover the sphere surface, a part of the image may look distorted when viewed from the user, giving a feeling of strangeness. To cope with this, each of the communication terminals 7 and 9 displays an image of a predetermined area, which is a part of the spherical image, as a planar image having fewer curves, allowing display without giving a feeling of strangeness to the user. The image of the predetermined area, which is viewable to the user, may be referred to as a predetermined-area image in the following description. A predetermined area and a predetermined-area image are described with reference to FIGS. 5 to 8.

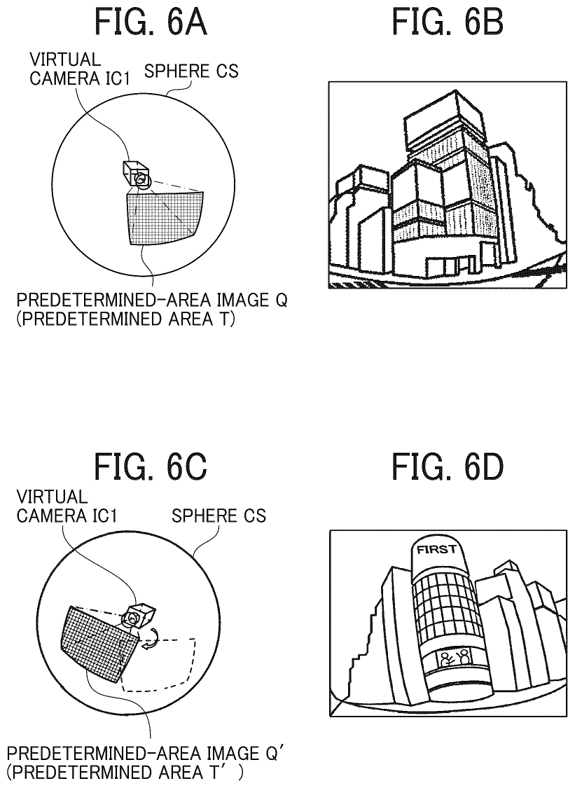

FIG. 5 is an illustration of relative positions of a virtual camera and a predetermined area when a spherical image is represented as a three-dimensional solid sphere. The position of the virtual camera IC1 corresponds to the position of the virtual viewpoint of the user viewing the spherical image CE represented as a surface area of the three-dimensional solid sphere. FIG. 6A is a perspective view of FIG. 5. FIG. 6B is a diagram illustrating a predetermined-area image of FIG. 6A being displayed on a display. FIG. 6C is a diagram illustrating a predetermined area after the viewpoint of a virtual camera in FIG. 6A is changed. FIG. 6D is a diagram illustrating a predetermined-area image of FIG. 6C being displayed on a display.

Assuming that the spherical image CE having been generated is the surface area of a solid sphere CS, the virtual camera IC1 is inside of the spherical image CE as illustrated in FIG. 5. A predetermined area T in the spherical image CE is an imaging area of the virtual camera IC1. Specifically, the predetermined area T is specified by field-of-view information indicating an imaging direction and a field of view of the virtual camera IC1 in a three-dimensional virtual space including the spherical image CE. The field-of-view information is also referred to as “area information.”

Further, zooming in or out the predetermined area T may be performed through bringing the virtual camera IC1 closer to or away from the spherical image CE. A predetermined-area image Q is an image of the predetermined area T in the spherical image CE. The predetermined area T is defined by a field of view α and a distance f from the virtual camera IC1 to the spherical image CE.

When the virtual viewpoint of the virtual camera IC1 is moved (changed) from the state illustrated in FIG. 6A to the right (left in the drawing) as illustrated in FIG. 6C, the predetermined area T in the spherical image CE is moved to a predetermined area T′, accordingly. As a result, the predetermined-area image Q displayed on a predetermined display is changed to a predetermined-area image Q′. As a result, the image displayed on the predetermined display changes from the image illustrated in FIG. 6B to the image illustrated in FIG. 6D.

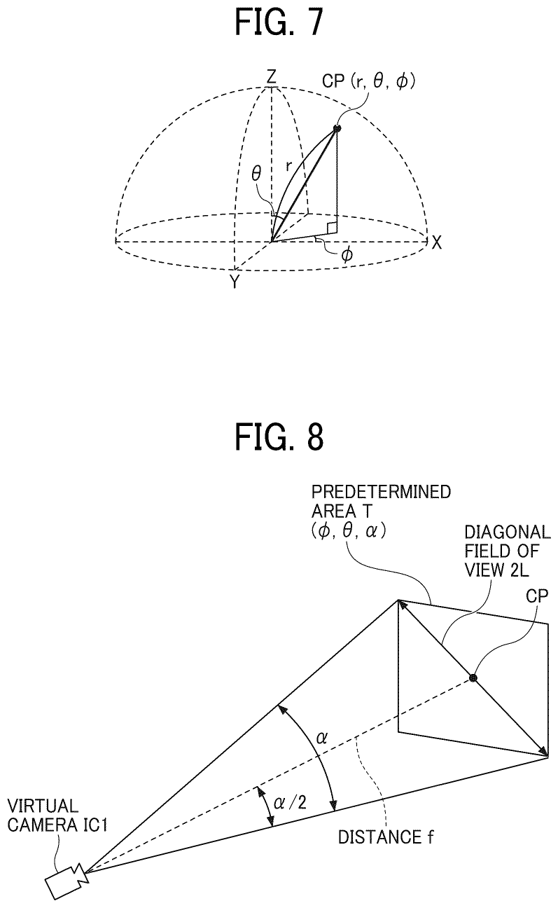

A relation between the field-of-view information and the image of the predetermined area T is described below with reference to FIGS. 7 and 8.

FIG. 7 is a diagram illustrating a point in a three-dimensional Euclidean space according to spherical coordinates. FIG. 8 is a diagram illustrating a relation between a predetermined area and a point of interest (center point).

Positional coordinates (r, 0, q) are given when a center point CP illustrated in FIG. 7 is represented by a spherical polar coordinate system. The positional coordinates (r, 0, q) represent a radius vector, a polar angle, and an azimuth angle. The radius vector r is the distance from the origin of a three-dimensional virtual space including the spherical image to any point (the center point CP in FIG. 8). Accordingly, the radius vector r is equal to the distance “f” illustrated in FIG. 8.

As illustrated in FIG. 8, when the center of the predetermined area T that is the imaging area of the virtual camera IC1 is assumed to be the center point CP in FIG. 7, a trigonometric function equation expressed by the following Formula 1 is satisfied.

(L/f)=tan(α/2) (Formula 1)

“f” denotes a distance from the virtual camera IC1 to the center point CP of the predetermined area T. “L” is the distance between the center point CP and a given vertex of the predetermined area T (2 L is a diagonal line). “α” is a field of view. In this case, the field-of-view information for specifying the predetermined area T can be represented by pan (θ), tilt (φ), and fov (α). Zooming in or out of the predetermined area T can be determined by increasing or decreasing the range (arc) of the field of view α.

### Overview of Communication System

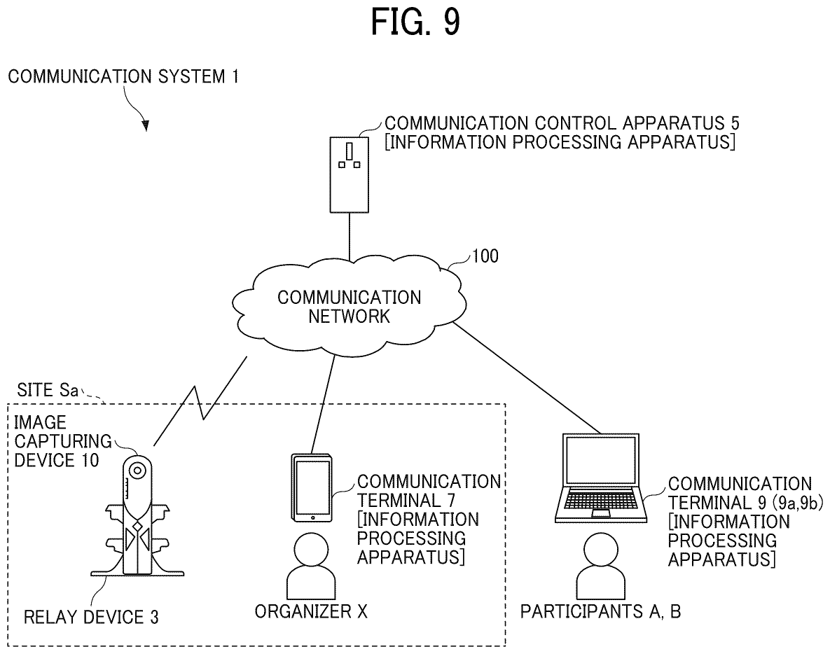

An overview of a communication system 1 is described below with reference to FIG. 9. FIG. 9 is a schematic diagram of the communication system 1.

As illustrated in FIG. 9, the communication system 1 includes the communication control apparatus 5, the image capturing device 10, the relay device 3, the communication terminal 7, and the communication terminal 9 (communication terminals 9a and 9b). The communication terminals 9a and 9b are collectively referred to as “communication terminal 9.” The communication control apparatus 5, the communication terminal 7, and the communication terminal 9 are also examples of an information processing apparatus. Each of the communication terminals 7 and 9 may be referred to as a “display terminal” that displays, for example, an image.

The image capturing device 10 is a digital camera for obtaining a wide-field image, such as a spherical image, as described above. The relay device 3 has a cradle function for charging the image capturing device 10 and transmitting and receiving data to and from the image capturing device 10. The relay device 3 can communicate with the image capturing device 10 via a contact point and can communicate with the communication control apparatus 5 via a communication network 100. The communication network 100 includes the Internet, a local area network (LAN), and a (wireless) router.

The communication control apparatus 5 is, for example, a computer, and can communicate with the relay device 3 and the communication terminals 7 and 9 via the communication network 100. The communication control apparatus 5 manages, for example, field-of-view information, and thus can be referred to as an “information management apparatus.”

The communication terminals 7 and 9 are computers such as notebook personal computers (PCs), and can communicate with the communication control apparatus 5 via the communication network 100. Each of the communication terminals 7 and 9 is installed with OpenGL ES and creates a predetermined-area image (see FIG. 6) from a spherical image received from the communication control apparatus 5. The communication control apparatus 5 may be configured by a single computer or a plurality of computers.

Further, the image capturing device 10 and the relay device 3 are installed at predetermined positions by an organizer (user) X on a site Sa such as a construction site, exhibition venue, educational institution, or medical facility. The communication terminal 7 is operated (used) by the organizer X. The communication terminal 9a is operated (used) by a participant (user) A such as a viewer at a remote location from the site Sa. The communication terminal 9b is operated (used) by a participant (user) B such as a viewer at a remote location from the site Sa. The participant A and participant B may be at the same location or at different locations.

The communication control apparatus 5 transmits (distributes) the wide-field image obtained from the image capturing device 10 via the relay device 3 to the communication terminals 7 and 9. The communication control apparatus 5 transmits (distributes) the captured image obtained from each communication terminal 7 to the communication terminals 7 and 9. The captured image transmitted from the image capturing device 10 via the relay device 3 is a wide-field image, but when, for example, a single-lens reflex camera is used instead of the image capturing device 10, the captured image is a standard narrow-field image. The captured image may be a moving image or a still image.

### Hardware Configuration

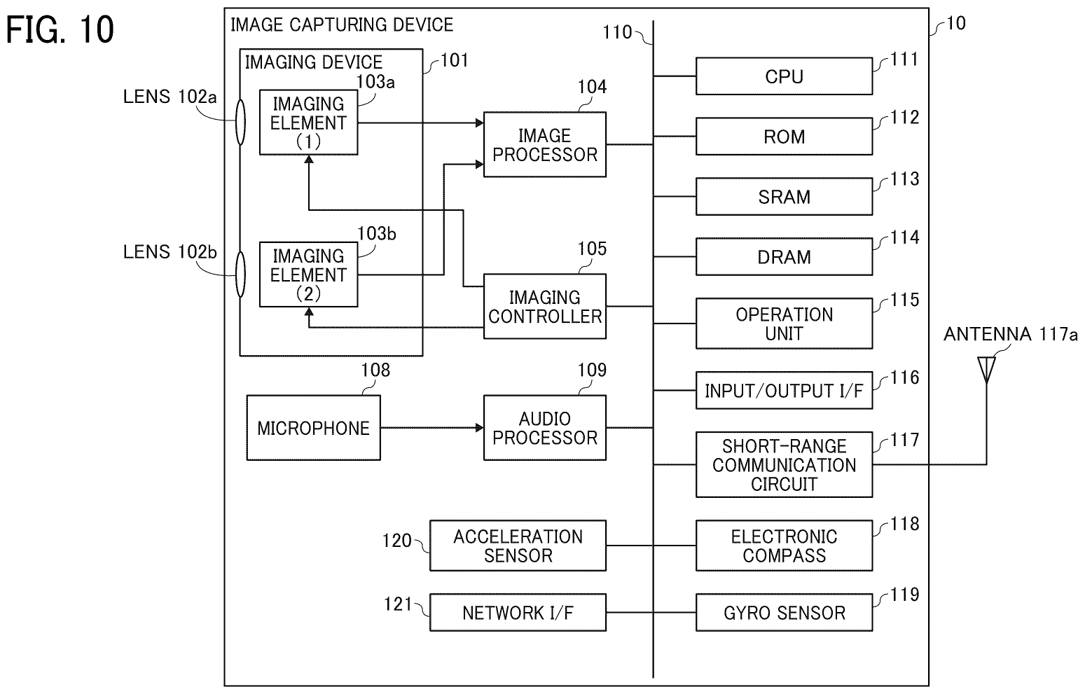

Hardware configurations of the image capturing device 10, the relay device 3, the communication terminal 7, and the communication terminal 9 are described in detail with reference to FIGS. 10 to 12.

### Hardware Configuration of Image Capturing Device

FIG. 10 is a block diagram illustrating a hardware configuration of the image capturing device 10. As illustrated in FIG. 10, the image capturing device 10 includes an imaging device 101, an image processor 104, an imaging controller 105, a microphone 108, an audio processor 109, a central processing unit (CPU) 111, a read-only memory (ROM) 112, a static random-access memory (SRAM) 113, a dynamic random-access memory (DRAM) 114, an operation unit 115, an input/output interface (I/F) 116, a short-range communication circuit 117, an antenna 117a for the short-range communication circuit 117, an electronic compass 118, a gyro sensor 119, an acceleration sensor 120, and a network I/F 121.

The imaging device 101 includes wide-angle lenses 102a and 102b (collectively referred to as lens 102 in the following description unless they need to be distinguished from each other), each having a field view of equal to or greater than 180 degrees so as to form a hemispherical image. The imaging device 101 further includes the two imaging elements 103a and 103b corresponding to the lenses 102a and 102b, respectively.

The imaging elements 103a and 103b each of which includes an imaging sensor such as a complementary metal oxide semiconductor (CMOS) sensor and a charge-coupled device (CCD) sensor, a timing generation circuit, and a group of registers. The imaging sensor converts an optical image formed by, for example, the lenses 102a and 102b into electrical signals to output image data. The timing generation circuit generates, for example, horizontal or vertical synchronization signals and pixel clocks for the imaging sensor. In the group of registers, for example, various commands and parameters for operations of the imaging elements 103a and 103b are set. As a non-limiting example, the imaging device 101 includes two wide-angle lenses. The imaging device 101 may include one wide-angle lens or three or more wide-angle lenses.

Each of the imaging elements 103a and 103b of the imaging device 101 is connected to the image processor 104 via a parallel I/F bus. Each of the imaging elements 103a and 103b of the imaging device 101 is further connected to the imaging controller 105 via a serial I/F bus such as an I2C bus.

The image processor 104, the imaging controller 105, and the audio processor 109 are connected to the CPU 111 via a bus 110. Further, the ROM 112, the SRAM 113, the DRAM 114, the operation unit 115, the input/output I/F 116, the short-range communication circuit 117, the electronic compass 118, the gyro sensor 119, the acceleration sensor 120, and the network I/F 121 are also connected to the bus 110.

The image processor 104 acquires image data from each of the imaging elements 103a and 103b via the parallel I/F bus and performs predetermined processing on the image data. Then, the image processor 104 performs image data combining to generate equirectangular projection image data (an example of a wide-field image), which is described later.

The image controller 105 functions as a master device while each of the imaging elements 103a and 103b functions as a slave device, and the image controller 105 sets commands in the group of registers of each of the imaging elements 103a and 103b through the I2C bus. The image controller 105 receives commands from the CPU 111. The imaging controller 105 obtains status data of the group of registers of each of the imaging elements 103a and 103b through the I2C bus and transmits the status data to the CPU 111.

The imaging controller 105 instructs the imaging elements 103a and 103b to output the image data at a time when the shutter button of the operation unit 115 is pressed. In some cases, the image capturing device 10 displays a preview image on a display (e.g., a display of an external terminal such as a smartphone that performs short-range communication with the image capturing device 10 through the short-range communication circuit 117) or displays a moving image (movie). In the case of displaying a moving image, the image data is continuously output from the imaging elements 103a and 103b at a predetermined frame rate (frames per minute).

Further, the imaging controller 105 operates in conjunction with the CPU 111 to synchronize the output timings of image data between the imaging elements 103a and 103b. Although the image capturing device 10 does not include the display in this example, the image capturing device 10 may include the display. The microphone 108 converts sound into audio data (signals).

The audio processor 109 obtains the audio data from the microphone 108 through an I/F bus and performs predetermined processing on the audio data.

The CPU 111 controls the entire operation of the image capturing device 10 and executes predetermined processing.

The ROM 112 stores various programs for execution by the CPU 111. Each of the SRAM 113 and the DRAM 114 operates as a working memory to store programs to be executed by the CPU 111 or data currently processed. More specifically, in one example, the DRAM 114 stores image data currently processed by the image processor 104 and equirectangular projection image data on which processing has been performed.

The operation unit 115 collectively refers to various operation buttons, a power switch, a shutter button, and a touch panel that functions both as a display for information and as an input device, and can be used in combination. The operation unit 115 allows the user operating the operation unit 115 to input various image capturing (image capturing) modes or image capturing (image capturing) conditions.

The input/output I/F 116 collectively refers to an interface circuit, such as a universal serial bus (USB) I/F, for an external medium such as a secure digital (SD) card or a personal computer. The input/output I/F 116 supports at least one of wired and wireless communications. The equirectangular projection image data stored in the DRAM 114 can be stored in an external medium via the input/output I/F 116 or transmitted to an external terminal (apparatus) via the input/output I/F 116, as appropriate.

The short-range communication circuit 117 communicates with an external terminal (apparatus) via the antenna 117a of the image capturing device 10 by short-range wireless communication such as near field communication (NFC), BLUETOOTH (registered trademark), and Wi-Fi. The short-range communication circuit 117 transmits the equirectangular projection image data to the external terminal (apparatus).

The electronic compass 118 calculates the orientation of the image capturing device 10 from the Earth's magnetism to output orientation information. The orientation information is an example of related information that is metadata described in compliance with Exif and is used for image processing such as image correction of captured images. The related information also includes an imaging date and time, that indicates the date and time when the image is captured, and a data size of the image data.

The gyro sensor 119 detects the change in tilt of the image capturing device 10 (roll, pitch, yaw) with the movement of the image capturing device 10. The change in tilt is one example of the related information (metadata) described in compliance with Exif, and used for image processing such as image correction performed on a captured image.

The acceleration sensor 120 detects acceleration in three axial directions.

The image capturing device 10 can also calculate the attitude (tilt with respect to the direction of gravity) of the own device (image capturing device 10) using, for example, the electronic compass 118 and the acceleration sensor 120. Further, the image capturing device 10 increases the accuracy of image correction by the acceleration sensor 120.

The network I/F 121 is an interface for data communication via such as a router using the communication network 100 such as the Internet. The hardware configuration of the image capturing device 10 is not limited to the one illustrated in FIG. 10, and may be any configuration as long as the functional configuration of the image capturing device 10 can be implemented. At least a part of the hardware configuration may be implemented by the relay device 3 or the communication network 100.

### Hardware Configuration of Relay Device

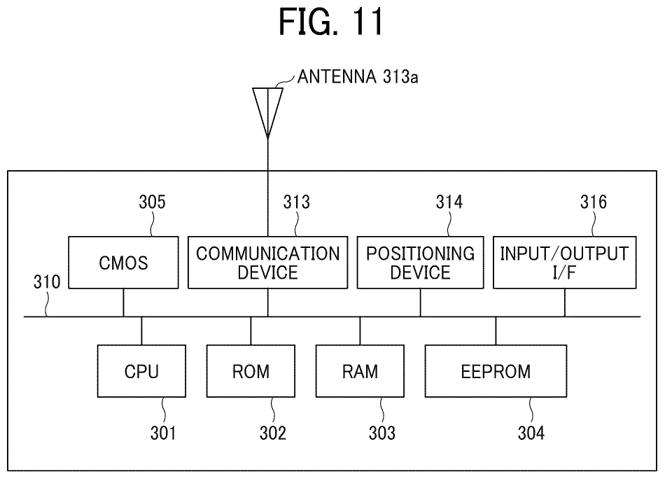

FIG. 11 is a block diagram illustrating a hardware configuration of the relay device 3. The relay device 3 having the hardware configuration illustrated in FIG. 11 has a cradle with a wireless communication function.

As illustrated in FIG. 11, the relay device 3 includes a CPU 301, ROM 302, RAM 303, electrically erasable and programmable ROM (EEPROM) 304, a CMOS sensor 305, a bus line 310, a communication device 313, an antenna 313a, a positioning device 314, and an input/output I/F 316.

The CPU 301 controls the entire operation of the relay device 3. The ROM 302 stores a control program such as an initial program loader (IPL) used for operating the CPU 301. The RAM 303 is used as a working area for the CPU 301.

The EEPROM 304 reads or writes under the control of the CPU 301. The EEPROM 304 stores an operating system (OS) and other programs executed by the CPU 301, and various data.

The CMOS sensor 305 is a solid-state imaging element that images a subject under the control of the CPU 301 and obtains image data.

The communication device 313 communicates with the communication network 100 by a wireless communication signal using the antenna 313a.

The positioning device 314 receives a positioning signal including position information (latitude, longitude, and altitude) of the relay device 3 using a global navigation satellite system (GNSS) satellite such as a global positioning system (GPS) satellite or using an indoor MEssaging system (IMES) as an indoor GPS.

The input/output I/F 316 is an interface circuit, such as a USB I/F, electrically connected to the input/output I/F 116 of the image capturing device 10. The input/output I/F 316 supports at least one of wired and wireless communications.

The bus line 310 includes an address bus and a data bus. The bus line 310 electrically connects the components, such as the CPU 301, with each other.

### Hardware Configuration of Communication Control Device/Communication Terminal

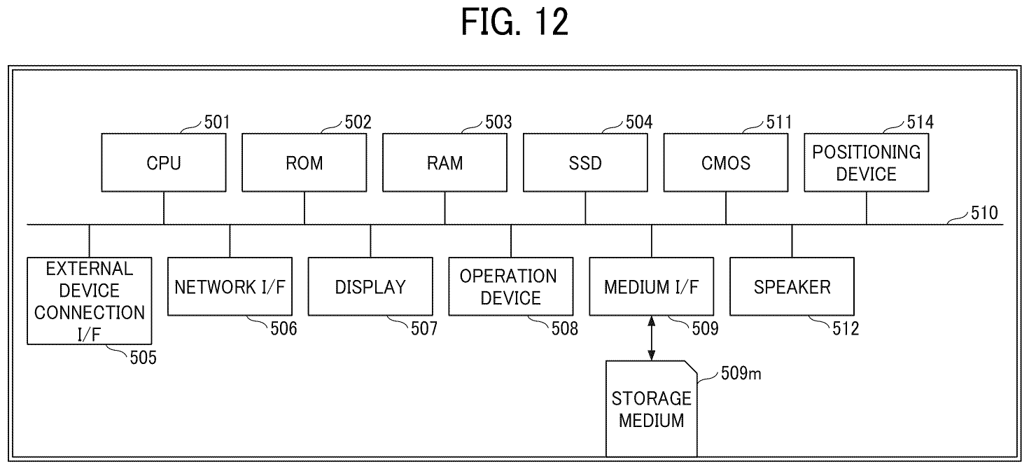

FIG. 12 is a block diagram illustrating a hardware configuration of the communication control apparatus 5. The hardware configuration of each of the communication terminals 7 and 9 is the same as that of the communication control apparatus 5, and thus the description thereof is omitted.

As illustrated in FIG. 12, the communication control apparatus 5 includes, as a computer, a CPU 501, a ROM 502, a RAM 503, a solid-state drive (SSD) 504, an external device connection I/F 505, a network I/F 506, a display 507, an operation device 508, a medium I/F 509, a bus line 510, a CMOS sensor 511, a speaker 512, and a positioning device 514.

The CPU 501 controls the entire operation of the communication control apparatus 5. The ROM 502 stores programs used for driving the CPU 501, such as an IPL. The RAM 503 is used as a working area for the CPU 501.

The SSD 504 reads or writes various data under the control of the CPU 501. When being, for example, a smartphone, each of the communication terminals 7 and 9 may not include the SSD 504. A hard disk drive (HDD) may be used instead of the SSD 504.

The external device connection I/F 505 is an interface that connects to various external devices (apparatuses). Examples of such external devices include a display, a speaker, a keyboard, a mouse, a universal serial bus (USB) memory, and a printer.

The network I/F 506 is an interface for data communication via the communication network 100.

The display 507 is a display unit such as a liquid crystal display (LCD) or an organic electroluminescence (EL) display that displays various images.

The operation device 508 is an input unit such as various operation buttons, a power switch, a shutter button, and a touch panel for operations including selecting or executing various instructions, selecting a processing target, and moving a cursor.

The medium I/F 509 controls reading and writing (storing) data from or to a recording medium (storage medium) 509m such as a flash memory. Examples of the recording medium 509m include a digital versatile disc (DVD) and a BLU-RAY DISC.

The CMOS sensor 511 is a built-in imaging unit that captures a subject under the control of the CPU 501 and obtains image data. A CCD sensor may be used instead of the CMOS sensor.

The speaker 512 is a circuit that generates sound such as music or voice by converting an electrical signal into physical vibration.

The positioning device 314 receives a positioning signal including position information (latitude, longitude, and altitude) of each of the communication terminals 7 and 9 using a GNSS satellite such as a GPS satellite or using an IMES as an indoor GPS.

The bus line 510 includes an address bus and a data bus. The bus line 510 electrically connects the components, such as the CPU 501, with each other.

### Functional Configuration

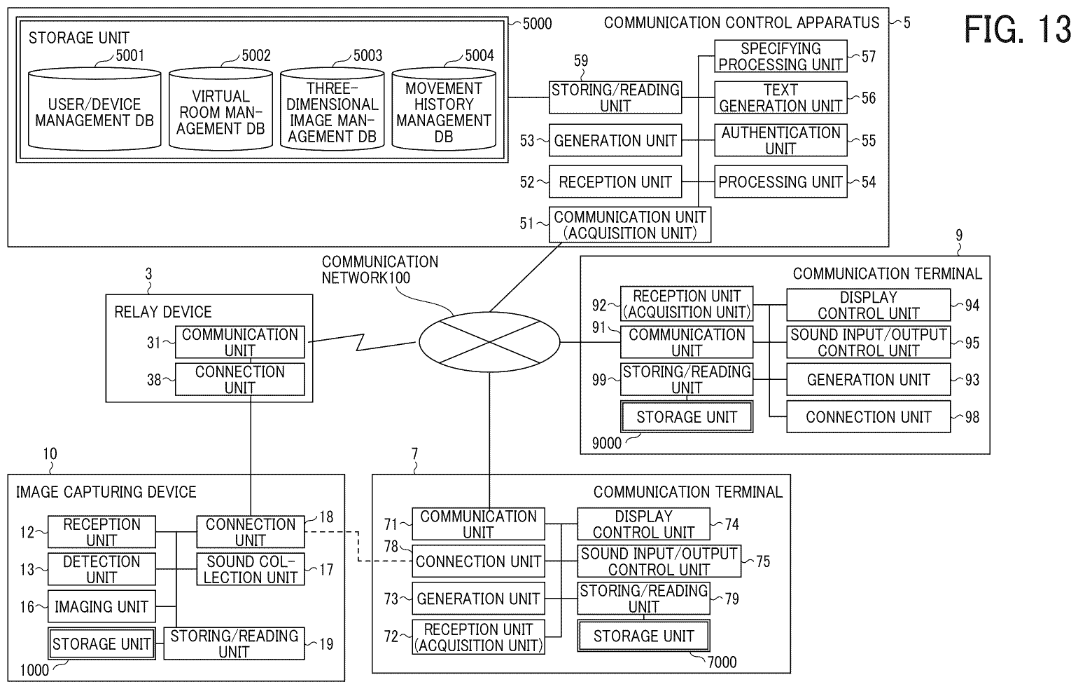

A functional configuration of the communication system 1 is described below with reference to FIGS. 13 to 18.

### Functional Configuration of Image Capturing Device

As illustrated in FIG. 13, the image capturing device 10 includes a reception unit 12, a detection unit 13, an imaging unit 16, a sound collection unit 17, a connection unit 18, and a storing/reading unit 19. Each of the above-mentioned units is a function or a means that is implemented by operating any one or more of the components illustrated in FIG. 10 according to instructions from the CPU 111 executing a program for an image capturing device after the program is loaded from the SRAM 113 to the DRAM 114.

The image capturing device 10 further includes a storage unit 1000. The storage unit 1000 is implemented by the ROM 112, the SRAM 113, and the DRAM 114 illustrated in FIG. 10.

### Functional Units of Image Capturing Device

The reception unit 12 of the image capturing device 10 is implemented by the operation unit 115 operating in accordance with instructions from the CPU 111. The reception unit 12 receives an operation input from the user.

The detection unit 13 is implemented by the electronic compass 118, the gyro sensor 119, or the acceleration sensor 120 operating in accordance with instructions from the CPU 111. The detection unit 13 detects the posture of the image capturing device 10 to obtain posture information.

The imaging unit 16 is implemented by the imaging device 101, the image processor 104, and the imaging controller 105 operating in accordance with instructions from the CPU 111. The imaging unit 16 captures, for example, scenery to obtain a captured image.

The sound collection unit 17 is implemented by the audio processor 109 operating in accordance with instructions from the CPU 111. The sound collection unit 17 picks up sounds around the image capturing device 10.

The connection unit 18 is implemented by the input/output I/F 116 operating in accordance with instructions from the CPU 111. The connection unit 18 performs data communication with the relay device 3.

The storing/reading unit 19 is implemented by, for example, processing of the CPU 111 and stores various data (or information) in the storage unit 1000 or reads various data (or information) from the storage unit 1000.

### Functional Configuration of Relay Device

As illustrated in FIG. 13, the relay device 3 includes a communication unit 31 and a connection unit 38. Each of the above-mentioned units is a function or a means that is implemented by operating any one or more of the components illustrated in FIG. 11 according to instructions from the CPU 301 executing a program for the relay device 3 after the program is loaded from the EEPROM 304 to the RAM 303.

### Functional Units of Relay Device

The communication unit 31 of the relay device 3 is implemented by the communication device 313 operating in accordance with instructions from the CPU 301 illustrated in FIG. 11. The communication unit 31 performs data communication with the image capturing device 10 and the communication control apparatus 5 via the communication network 100.

The connection unit 38 is implemented by the input/output I/F 316 operating in accordance with instructions from the CPU 301. The connection unit 38 performs data communication with the image capturing device 10.

### Functional Configuration of Communication Control Apparatus

The functional units of the communication control apparatus 5 are described below in detail with reference to FIG. 13. The communication control apparatus 5 includes a communication unit 51, a reception unit 52, a generation unit 53, a processing unit 54, an authentication unit 55, a text generation unit 56, a specifying processing unit 57, and a storing/reading unit 59. Each of the above-mentioned units is a function or a means that is implemented by operating any one or more of the components illustrated in FIG. 12 according to instructions from the CPU 501 executing a program for the communication control apparatus 5 after the program is loaded from the SSD 504 to the RAM 503.

The communication control apparatus 5 further includes a storage unit 5000 that is implemented by the RAM 503 or the SSD 504 illustrated in FIG. 12. The storage unit 5000 includes a user/device management database (DB) 5001, a virtual room management DB 5002, a three-dimensional image management DB 5003, and a movement history management DB 5004.

### User/Device Management DB

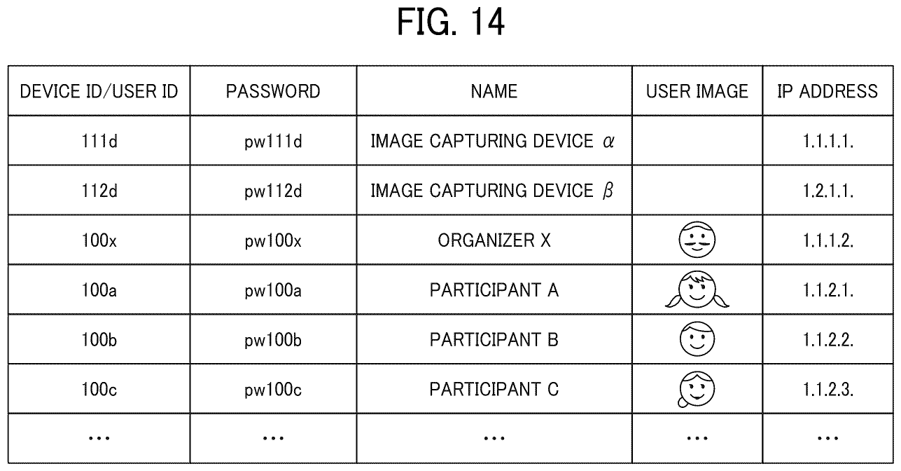

FIG. 14 is a schematic diagram of a user/device management table. The user/device management DB 5001 includes a user/device management table illustrated in FIG. 14. The user/device management table stores a user ID (or device ID), a password, a name, a user image, and an internet protocol (IP) address in association as data items to be managed.

The user ID is an example of user identification information for identifying a user, such as the organizer X, the participant A, or the participant B. The device ID is an example of device identification information for identifying a device such as the image capturing device 10. When a head mounted display or a similar device is used in addition to the image capturing device 10, the head mounted display or the similar device is also regarded as a device.

The name is the name of the user or the device. A user name may be the name of the communication terminal used by the user.

The user image is, for example, an image obtained by schematically modeling the face of the user, an image of a photograph of the face of the user. The user image is preregistered by the user.

The IP address is an example of destination identifying information of the device such as the communication terminal 7, communication terminal 9, or the image capturing device 10 used by the user.

### Virtual Room Management DB

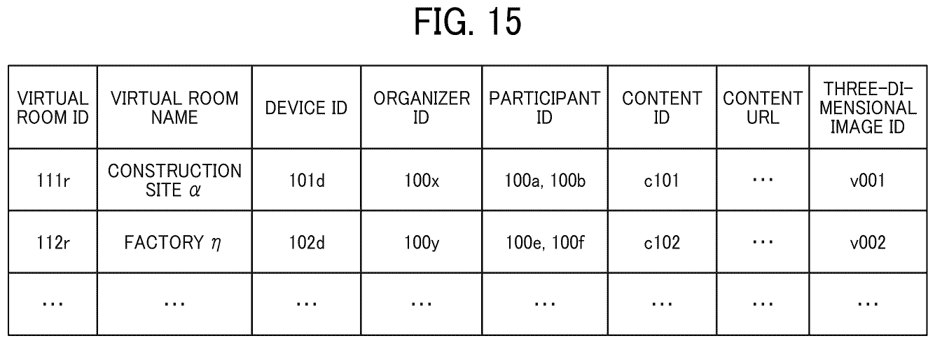

FIG. 15 is a schematic diagram of a virtual room management table. The virtual room management DB 5002 includes a virtual room management table illustrated in FIG. 15. In the virtual room management table, data items of virtual room ID, virtual room name, device ID, host ID, participant ID, content ID, content uniform resource locator (URL) (storage location information of content data including image data and sound (voice) data), and three-dimensional image ID are associated with each other and managed.

The virtual room ID is an example of virtual room identification information for identifying a virtual room.

The virtual room name is the name of the virtual room and is assigned by, for example, the user.

The device ID is the same as the device ID in FIG. 14 and is the ID of a device that has joined the virtual room indicated by the virtual room ID in the same record.

The organizer ID is an example of organizer identification information for identifying the organizer ID among the user IDs in FIG. 14 and is an ID of the organizer who participates in the virtual room indicated by the virtual room ID in the same record.

The participant ID is an example of participant identification information for identifying a participant ID among the user IDs in FIG. 14 and is an ID of a participant who participates in a virtual room indicated by the virtual room ID in the same record.

The content ID is an example of content identification information for identifying content data including image data and sound data. The image in this case is a wide-field image obtained at the time of imaging, and the sound including voice is obtained at the same time of imaging.

The content URL is an example of content storage location information indicating a location where content (wide-field image, sound information) data is stored. The content URL is stored in association with the content data, the time of imaging (image recording) and sound capturing (sound recording), and the image capturing position (absolute position on the earth).

The three-dimensional image ID is an example of three-dimensional image identification information for identifying a three-dimensional image to be displayed in a display area 620, which is described later.

### Three-dimensional Image Management DB

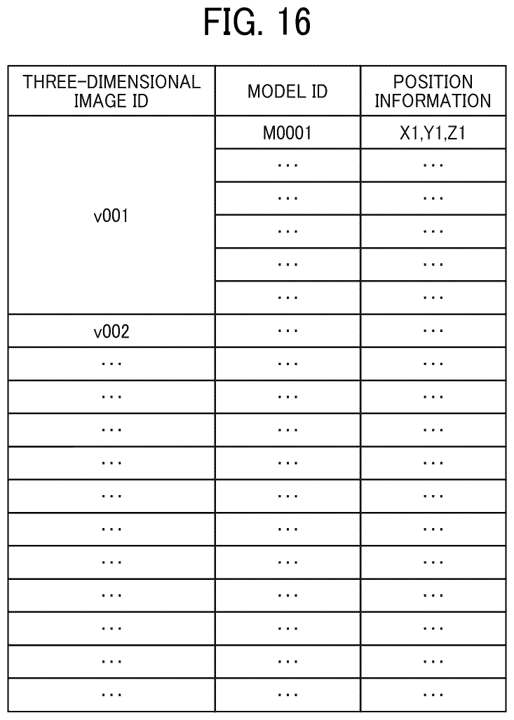

FIG. 16 schematically illustrates an example of three-dimensional image management table. The three-dimensional image management DB 5003 includes the three-dimensional image management table illustrated in FIG. 16. The three-dimensional image management table illustrated in 16 stores, for each three-dimensional image ID, a model ID and position information in association with each other, as data items to be managed.

The model ID is an example of three-dimensional model identification information for identifying a three-dimensional model, and the three-dimensional model is generated based on a point cloud acquired by, for example, a time-of-flight (TOF) camera.

The position information is information indicating the position of the three-dimensional model in a three-dimensional virtual space by three-dimensional coordinates of XYZ. The position information is indicated by, for example, the three-dimensional coordinates of eight points defining a rectangular parallelepiped space occupied by the three-dimensional model.

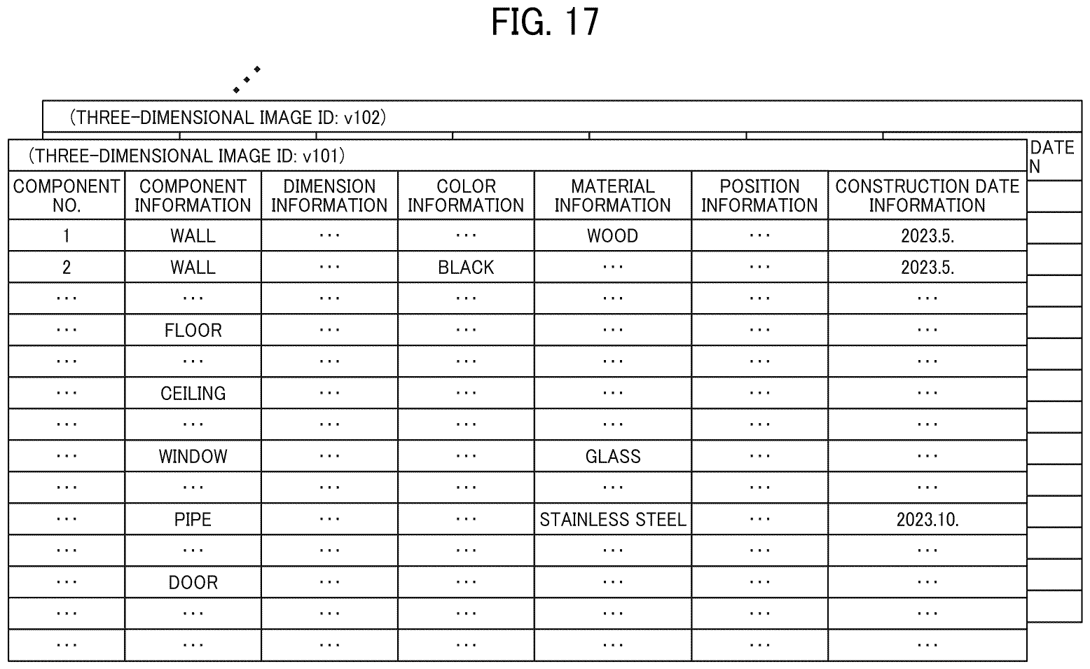

FIG. 17 schematically illustrates an example of three-dimensional image management table. The three-dimensional image management DB 5003 includes the three-dimensional image management table illustrated in FIG. 17. The three-dimensional image management table illustrated in FIG. 17 is a table for managing attribute information indicating attributes of components (three-dimensional models) constituting a structure included in a three-dimensional virtual space. The three-dimensional image management table illustrated in FIG. 17 stores, for each three-dimensional image ID, a part number (NO.), part information, dimension information, color information, material information, position information, and construction date information in association with one another, as attribute information.

The component information is information for identifying a component such as a wall, a floor, a ceiling, a window, a pipe, or a door.

The dimension information is information for identifying the dimension of a component in the virtual space and is indicated by, for example, numerical values in three-axis directions of XYZ.

The color information is information for identifying the color of a component, and the material information is information for identifying the material of a component.

The position information is information for identifying the position of a component in the virtual space and is indicated by, for example, coordinates in three-axis directions of XYZ. With the position information, whether multiple components are adjacent to each other can be determined.

The construction date information is information indicating a scheduled date when the component is to be constructed in the real world. With the construction date information, a structure excluding an unconstructed component at a certain point in time can be identified.

As described above, the position information in FIG. 16 and the position information in FIG. 17 are stored in association with the absolute position on the earth. For example, by associating the origin (X=0, Y=0, Z=0) of the position information in FIGS. 16 and 17 with the absolute position (latitudes, longitudes, altitudes) on the earth, all coordinates in the three-dimensional image including the three-dimensional model and components, are associated with the absolute position on the earth.

The three-dimensional image management DB 5003 may manage, for example, a three-dimensional point cloud, a mesh object, and a textured mesh object, instead of the three-dimensional model.

### Movement History Management DB

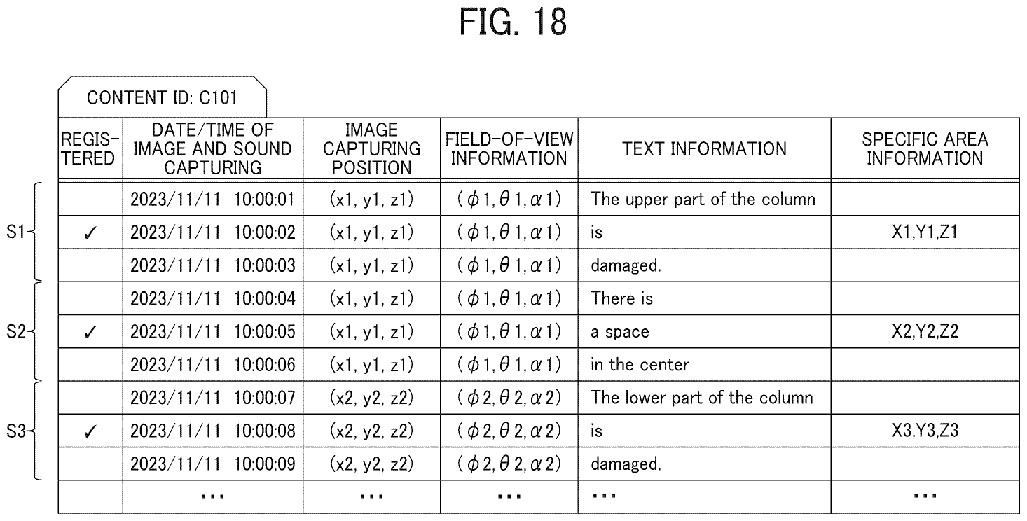

FIG. 18 schematically illustrates a movement history management table. The movement history management DB 5004 includes the movement history management table illustrated in FIG. 18. The movement history management table stores, for each content ID, the image and sound capturing date and time (date and time of image and sound capturing), the image capturing position, the field-of-view information, the text information, and the specific area information in association with one another, as data items to be managed. The position of the image capturing device 10 is measured by the positioning device 314 of the relay device 3 to which the image capturing device 10 is attached. A positioning unit similar to the positioning device 314 may be provided for the image capturing device 10, to measure the position of the image capturing device 10.

The content ID illustrated in FIG. 18 is the same as the content ID illustrated in FIG. 15.

The image and sound capturing date and time indicates the date and time when the image capturing device 10 captures the image and collects the sound.

The image capturing position indicates the position (absolute position on the earth) of the image capturing device 10 at the image capturing date and time. When sounds are collected (captured), the image capturing position is also a sound collection (capturing) position.

The field-of-view information is information for specifying a predetermined area to be displayed as a predetermined-area image on the communication terminal 9 (see FIG. 8). When the field-of-view information of multiple communication terminals (communication terminals 7, 9, etc.) is managed, the field-of-view information is managed for each communication terminal.

The text registered in the “TEXT INFORMATION” field is data obtained by converting the voice recorded at the recording date and time indicated in the same record of data into text.

The specific area information is information indicating the position of the specific area that is specified in the captured image. The information indicating the position of the specified area may be information represented by two-dimensional coordinates or a three-dimensional image. The specified area specified in the captured image is described in detail later.

The movement history management table further includes a “REGISTERED” field for registering the display position of the icon of the virtual camera IC1, for each image capturing date and time. The generation unit 53 may display, for example, an icon 622a of the virtual camera IC1 at an image capturing position in a display area 620, which is described later, when the flag is registered in the “REGISTERED” field. By registering a flag in the “REGISTERED” field, the generation unit 53 may associate an image capturing position in the display area 620, which is described later, with a specific area 611 that is specified in the captured image, which is described later.

In this disclosure, the image capturing positions being managed do not have to be the image capturing positions of the same image capturing device 10. In other words, as long as an image can be taken, any image capturing device, including the image capturing device 10, may be used. For example, a first image capturing position indicating the position at a particular time may be the position of one image capturing device (for example, a first image capturing device), and a second image capturing position at another particular time may be the position of another image capturing device (for example, a second image capturing device).

### Functional Units of Communication Control Apparatus

The functional units of the communication control apparatus 5 are described below in detail with reference to FIG. 13.

The communication unit 51 of the communication control apparatus 5 is implemented by the network I/F 506 operating in accordance with instructions from the CPU 501 illustrated in FIG. 12. The communication unit 51 performs data communication with other devices, such as the relay device 3 and the communication terminals 7 and 9, via the communication network 100. The communication unit 51 also functions as an acquisition unit and acquires instruction information indicating an instruction transmitted from the communication terminals 7 and 9.

The reception unit 52 is implemented by the operation device 508 operating in accordance with instructions from the CPU 501. The reception unit 52 receives an operation input from the user such as a system administrator.

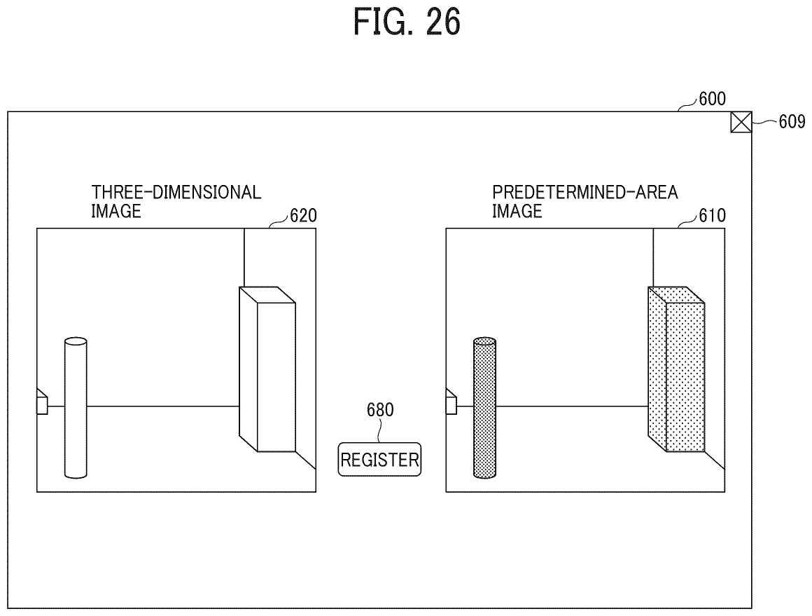

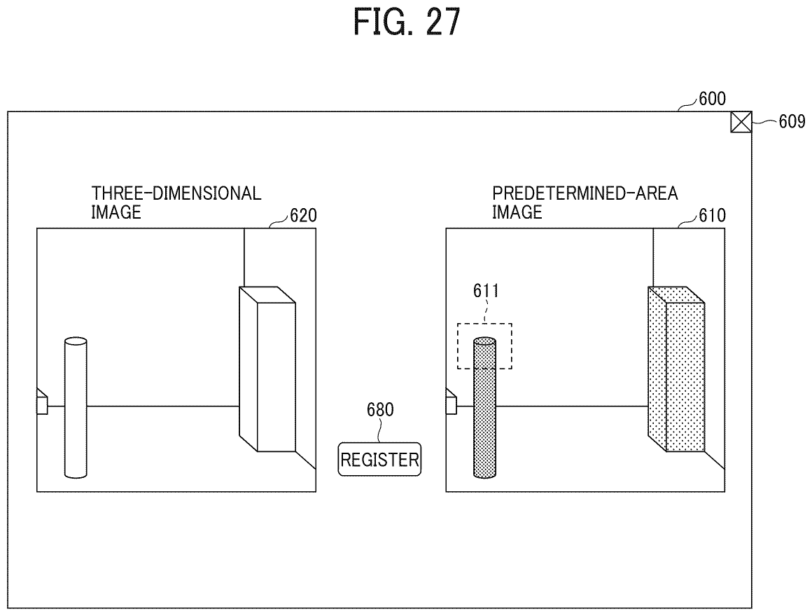

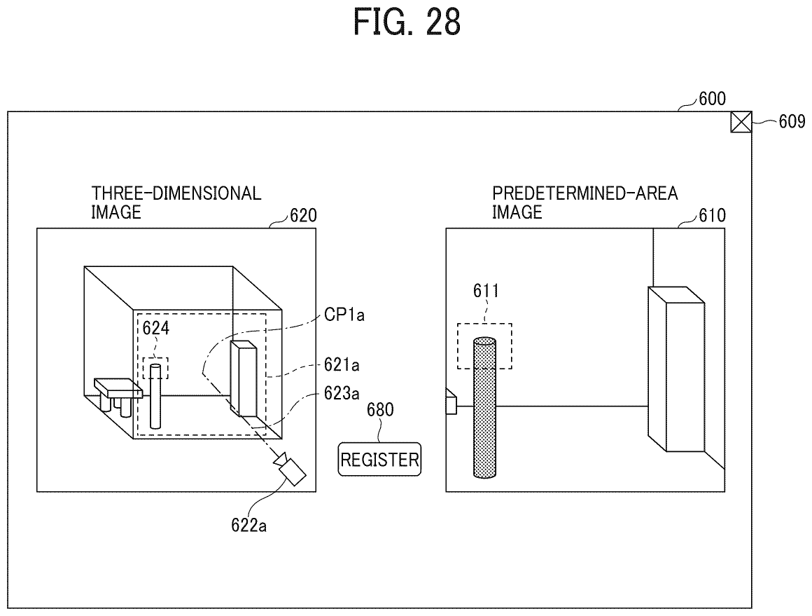

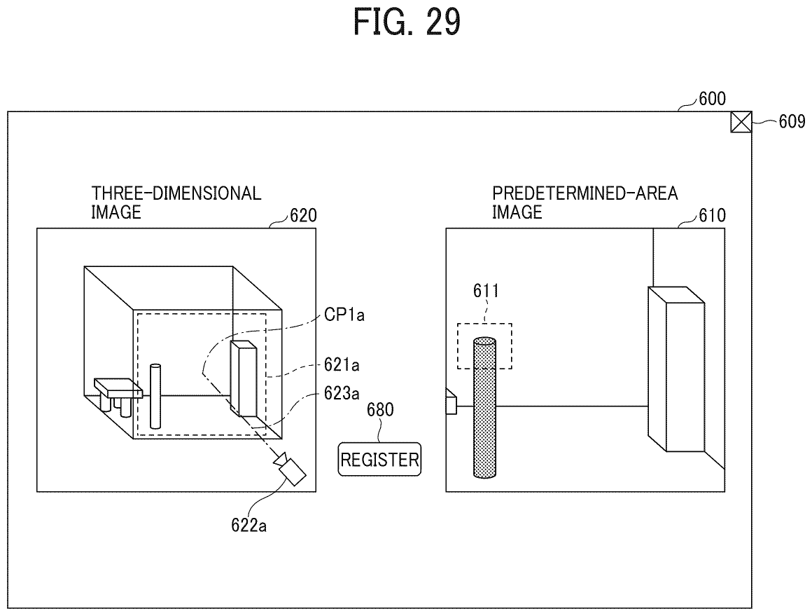

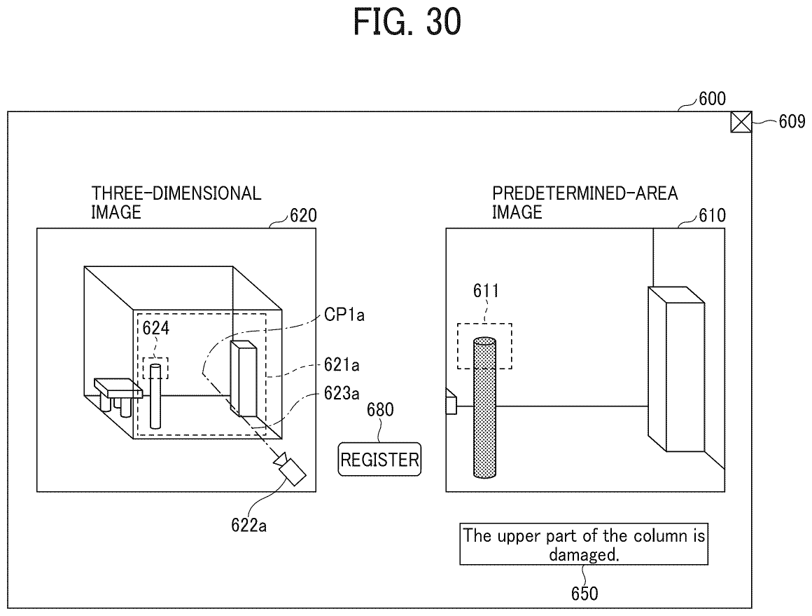

The generation unit 53 is implemented by processing of the CPU 501 and generates, using data stored in the storage unit 5000, a screen to be transmitted to each of the communication terminals 7 and 9. For example, the generation unit 53 creates a screen 600 including a display area 610 for displaying a predetermined-area image that is a predetermined area in a wide-field image (an example of a captured image) captured by the image capturing device 10 and a display area 620 for displaying at least a part of a three-dimensional image in which a first position and a second position in the wide-field image are associated with each other by the processing unit 54 (see FIG. 26).

The processing unit 54 is implemented by, for example, processing of the CPU 501 and associates position information indicating a position (an example of a first position) in a captured image obtained by imaging a target object by the image capturing device 10 with position information indicating another position (an example of a second position) in a three-dimensional image including a three-dimensional area corresponding to the target object. The processing unit 54 may be referred to as an “association unit.”

The authentication unit 55 is implemented by, for example, processing of the CPU 501 and authenticates, for example, whether the user has the authority to use the virtual room.

The text generation unit 56 is implemented mainly by the processing of the CPU 501, and generates text from sound (voice) in content data.

The specifying processing unit 57 is implemented by, for example, processing of the CPU 501, and specifies, as a specified area, an area in the captured image. The specific area is an area specified by an instruction input by the user in the display area 610. The specific area is an area specified by image recognition using text information representing text generated from sound collected (captured) together with the captured image or text input by the user.

The storing/reading unit 59 is implemented by, for example, processing of the CPU 501 and stores various data (or information) in the storage unit 5000 or reads various data (or information) from the storage unit 5000.

### Functional Configuration of Communication Terminal 7

The functional configuration of the communication terminal 7 is described below in detail with reference to FIG. 13. The communication terminal 7 includes a communication unit 71, a reception unit 72, a generation unit 73, a display control unit 74, a sound input/output control unit 75, a connection unit 78, and a storing/reading unit 79. Each of the above-mentioned units is a function or a means that is implemented by operating any one or more of the components illustrated in FIG. 12 according to instructions from the CPU 501 executing a program for the communication terminal 7 after the program is loaded from the SSD 504 to the RAM 503.

The communication unit 71 of the communication terminal 7 is implemented by the network I/F 506 operating in accordance with instructions from the CPU 501 of FIG. 12. The communication unit 71 performs data communication with other devices such as the communication control apparatus 5 via the communication network 100.

The reception unit 72 is implemented by the operation device 508 operating in accordance with instructions from the CPU 501. The reception unit 72 receives an operation input from the user such as the organizer X. The reception unit 72 also functions as an acquisition unit and acquires an instruction given according to a user operation.

The generation unit 73 is implemented by processing of the CPU 501 and generates, using data stored in the storage unit 7000, a screen to be displayed on the own terminal (in this example, the communication terminal 7). In a case where the generation unit 53 of the communication control apparatus 5 generates a screen, the communication terminal 7 may or may not include the generation unit 73.

The display control unit 74 is implemented by, for example, processing of the CPU 501, and controls the display 507 of the communication terminal 7 or an external display connected to the external device connection I/F 505 to display various images.

The sound input/output control unit 75 is implemented by, for example, processing of the CPU 501 of the communication terminal 7 and causes an external microphone connected to the external device connection I/F 505 to capture sound. When a microphone is built into the communication terminal 7, the sound input/output control unit 75 causes the built-in microphone to capture sound. The sound input/output control unit 75 further causes the speaker 512 of the communication terminal 7 or an external speaker connected to the external device connection I/F 505 to output sound.

The generation unit 73 is implemented by, for example, processing of the CPU 501 and adds, for example, narration and on-screen text to content data obtained by image recording and sound recording by the communication terminal 7 to generate content data for educational materials and similar purposes.

The storing/reading unit 79 is implemented by, for example, processing of the CPU 501 and stores various data (or information) in the storage unit 7000 or reads various data (or information) from the storage unit 7000.

### Functional Configuration of Communication Terminal 9

The functional configuration of the communication terminal 9 is described below in detail with reference to FIG. 13.

The communication terminal 9 includes a communication unit 91, a reception unit 92, a generation unit 93, a display control unit 94, a sound input/output control unit 95, a connection unit 98, and a storing/reading unit 99. Each of the above-mentioned units is a function or a means that is implemented by operating any one or more of the components illustrated in FIG. 12 according to instructions from the CPU 501 executing a program for the communication terminal 9 after the program is loaded from the SSD 504 to the RAM 503.

The communication terminal 9 further includes a storage unit 9000 that is implemented by the RAM 503 and the SSD 504 illustrated in FIG. 12.

The communication unit 91 of the communication terminal 9 is implemented by the network I/F 506 operating in accordance with instructions from the CPU 501. The communication unit 91 performs data communication with other devices such as the communication control apparatus 5 via the communication network 100.

The reception unit 92 is implemented by the operation device 508 operating in accordance with instructions from the CPU 501. The reception unit 72 receives an operation input from the user such as the participant A or B. The reception unit 92 also functions as an acquisition unit and acquires an instruction given according to a user operation.

The generation unit 93 is implemented by processing of the CPU 501 and generates, using data stored in the storage unit 9000, a screen to be displayed on the own terminal (in this example, the communication terminal 9). In a case where the generation unit 53 of the communication control apparatus 5 generates a screen, the communication terminal 9 may or may not include the generation unit 73.

The display control unit 94 is implemented by processing of the CPU 501, and controls the display 507 of the communication terminal 9 or an external display connected to the external device connection I/F 505 to display various images.

The sound input/output control unit 95 is implemented by, for example, processing of the CPU 501 of the communication terminal 9 and causes an external microphone connected to the external device connection I/F 505 to capture sound. When a microphone is built into the communication terminal 7, the sound input/output control unit 75 causes the built-in microphone to capture sound. The sound input/output control unit 95 further causes the speaker 512 of the communication terminal 9 or an external speaker connected to the external device connection I/F 505 to output sound.

The connection unit 98 is implemented by the external device connection I/F 505 operating in accordance with instructions from the CPU 501. The connection unit 98 performs data communication with an external device connected by wire or wirelessly.

The storing/reading unit 99 is implemented by, for example, processing of the CPU 501 and stores various data (or information) in the storage unit 9000 or reads various data (or information) from the storage unit 9000.

### Processes/Operations

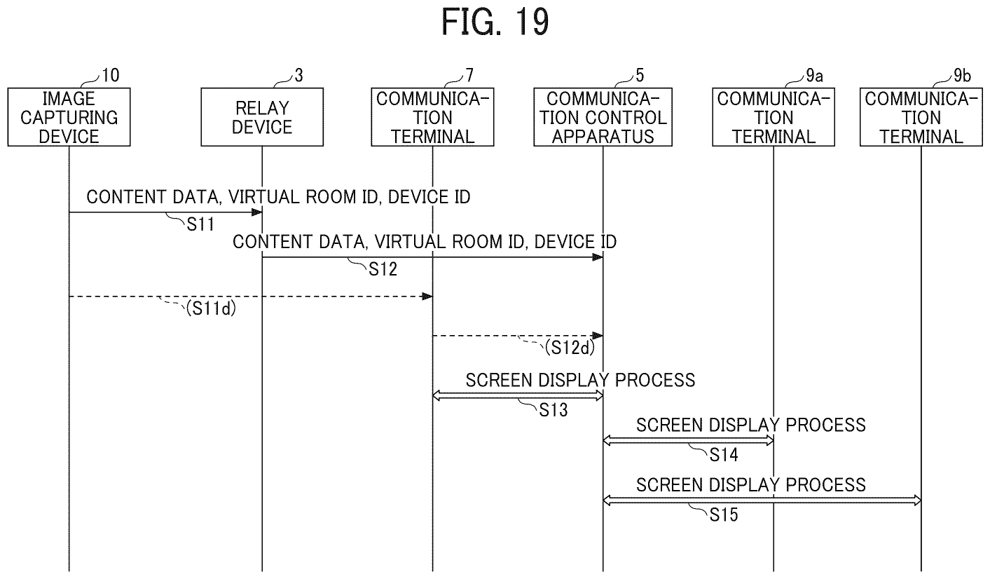

Processes or operations are described below with reference to FIG. 19 to FIG. 35. The processes described below are performed after the image capturing device 10 and the communication terminals 7 and 9 have entered the same virtual room.

### Process for Transmitting Content Data in Communication System

A process of data communication in relation to content data in the communication system 1 is described below with reference to FIG. 19. FIG. 19 is a sequence diagram illustrating a process of data communication in relation to a wide-field image and field-of-view information in the communication system 1. In the following description of the process, the image capturing device 10, the communication terminal 7 used by the organizer X, the communication terminal 9a used by the participant A, and the communication terminal 9b used by the participant B are in the same virtual room. When the virtual room is created, the storing/reading unit 79 adds one record for the created virtual room to the virtual room management DB 5002 (see FIG. 15), and stores the virtual room ID, the virtual room name, the device ID, the organizer ID, and the participant ID in association in the added record. The content ID, the content URL, and the three-dimensional image ID are stored later. The processing of Steps S11 to S15 of FIG. 19 is repeatedly performed, for example, about 30 times or 60 times per second.

Step S11: The image capturing device 10 acquires content (wide-field image and sound information) data by capturing a spherical image of an area in the site Sa along with sound by the imaging unit 16, and then, transmits the content data to the relay device 3 by the connection unit 18. In this case, the connection unit 18 also transmits the virtual room ID for identifying the virtual room in which the image capturing device 10 participates and the device ID for identifying the image capturing device 10. Further, the image capturing device 10 transmits information on an image capturing position that is a position (absolute position) of the image capturing device 10 to the relay device 3 at predetermined time intervals (for example, for each second). Accordingly, the relay device 3 acquires the content data, the virtual room ID, the device ID, the information on the image capturing position by the connection unit 38.

Step S12: The relay device 3 transmits to the communication control apparatus 5 via the communication network 100 the content data, the virtual room ID, the device ID, and the image capturing position received by the connection unit 38 in Step S11, by the communication unit 31. Accordingly, the communication control apparatus 5 receives the content data, the virtual room, the device ID, and the image capturing position by the communication unit 51. Then, the processing unit 54 stores the imaging information (the image and sound capturing date and time, the image capturing position, the field-of-view information, and the text information) in the movement history management DB 5004 for each image capturing date and time (for example, for each second). In this case, the text generation unit 56 converts the voice part into text using the audio data in the content data to generate text. The processing unit 54 stores the content data in the content URL (see FIG. 15) in the storage unit 5000.

The image capturing device 10 may transmit the content data, the virtual room ID, the device ID, and the image capturing position to the communication terminal 7 without transmitting to the relay device 3 (Step S11d). In this case, the communication terminal 7 transmits the content data, the virtual room ID, the device ID, and the image capturing position to the communication control apparatus 5 (Step S12d).

Step S13: The communication control apparatus 5 searches the virtual room management DB 5002 based on the virtual room ID received in Step S12 to read the user IDs (the organizer ID and the participant IDs) of the users who participate in the same virtual room as the image capturing device 10, by the storing/reading unit 59. The storing/reading unit 59 also searches the user/device management DB 5001 based on the read organizer ID and participant IDs to read the corresponding user images of the organizer X and the participants A and B and the corresponding IP addresses of the communication terminal 7, the communication terminal 9a, and the communication terminal 9b. The communication unit 51 refers to the IP address of the communication terminal 7 and transmits screen data including the content data (image data, audio data) and the three-dimensional image data received in Step S12 to the communication terminal 7. The communication unit 71 of the communication terminal 7 receives the content data and the three-dimensional image data. The processing (screen display process) is described in detail later.

Step S14: The communication control apparatus 5 refers to the IP address of the communication terminals 9a and transmits the content data received in Step S12 to the communication terminal 9a, by the communication unit 51. Accordingly, the communication terminal 9a receives the content data by the communication unit 91. The processing (screen display process) is described in detail later.

Step S15: Similarly, the communication control apparatus 5 refers to the IP address of the communication terminals 9b and transmits the content data received in Step S12 to the communication terminal 9b, by the communication unit 51. Accordingly, the communication terminal 9b receives the content data by the communication unit 91. The processing (screen display process) is described in detail later.

### Process for Starting Image Recording and Sound Recording in Communication System

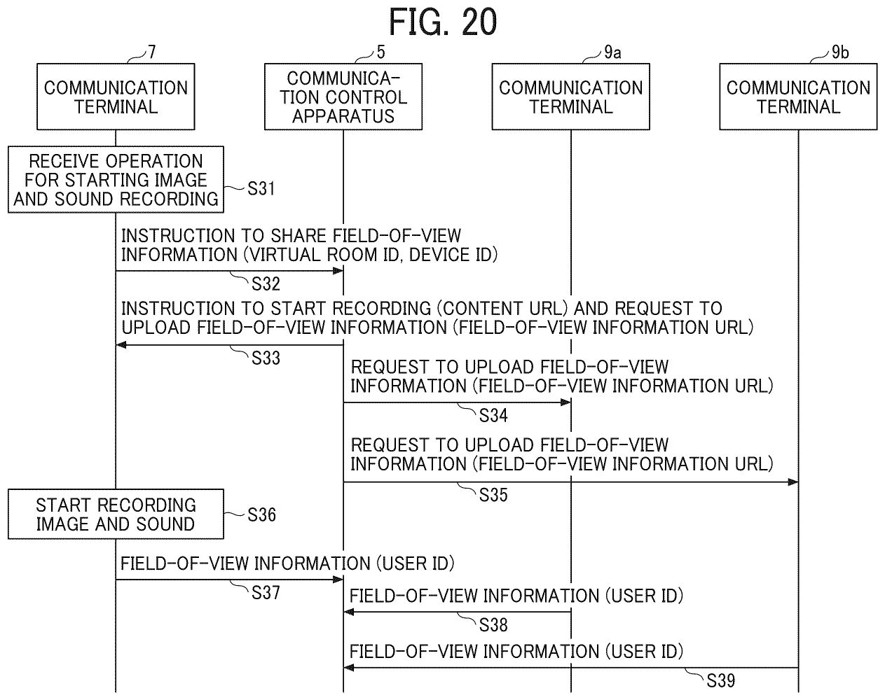

A process for starting image recording and sound recording in the communication system 1 is described below with reference to FIG. 20. FIG. 20 is a sequence diagram illustrating a process for starting image recording and sound recording in the communication system 1.

Step S31: The communication terminal 7 receives an operation to start image recording and sound recording from the organizer X by the reception unit 72.

Step S32: Before starting image recording and sound recording, the communication terminal 7 transmits an instruction to share field-of-view information (sharing instruction) to the communication control apparatus 5 by the communication unit 71. The sharing instruction includes the virtual room ID of the virtual room in which the communication terminal 7 participates and the device ID of the image capturing device 10. Accordingly, the communication control apparatus 5 receives the sharing instruction to share the field-of-view information by the communication unit 51.

Step S33: The communication control apparatus 5 sets the content URL and the field-of-view information URL in the virtual room management DB 5002 (see FIG. 15) by the storing/reading unit 59. Then, the communication unit 51 transmits an instruction to start recording and a request to upload field-of-view information to the communication terminal 7. The instruction includes information on a content URL indicating a location where the communication terminal 7 stores the content data after recording. The request includes information on a field-of-view information URL indicating a location where the field-of-view information is stored. Accordingly, the communication terminal 7 receives the instruction to start recording and the request to upload field-of-view information by the communication unit 71.

Step S34: The communication unit 51 transmits a request to upload field-of-view information to the communication terminal 9a. The request includes information on a URL where the field-of-view information is stored. Accordingly, the communication terminal 9a receives the request to upload field-of-view information by the communication unit 91.

Step S35: Similarly, the communication unit 51 transmits a request to upload field-of-view information to the communication terminal 9b. The request includes information on a URL where the field-of-view information is stored. Accordingly, the communication terminal 9b receives the request to upload field-of-view information by the communication unit 91.

Step S36: Subsequently, the communication terminal 7 starts recording of the content data received in Step S13 of FIG. 19, by the storing/reading unit 79 that is an example of a recording unit for image recording and sound recording. In the case of Step S12d of FIG. 19, the communication terminal 7 may start image recording and sound recording of the content data received from the image capturing device 10 in Step S11d, instead of the content data received from the communication control apparatus 5 in Step S13.

Step S37: When receiving, by the reception unit 72, an operation for changing a field of view by the organizer X, while displaying, for example, the predetermined-area image (see FIG. 6B) corresponding to the predetermined area (see FIG. 6A) of the wide-field image received in Step S13, the communication terminal 7 displays, by the display control unit 74, the predetermined-area image (see FIG. 6D) corresponding to the predetermined area (see FIG. 6C) that is changed from the previous predetermined area (see FIG. 6A) in the same wide-field image. In this case, the reception unit 72, which functions as an acquisition unit, acquires the field-of-view information (pan, tilt, fov) for specifying the predetermined area of the wide-field image to be displayed on the display 507, in response to reception of an operation for displaying the predetermined area of the wide-field image from the user, such as the organizer X. Then, the communication unit 71 transmits the field-of-view information for specifying the changed predetermined area to the image information URL (communication control apparatus 5) received in Step S33. The field-of-view information includes the user ID of the organizer X who uses the communication terminal 7 that is the transmission source. Accordingly, the communication control apparatus 5 receives the field-of-view information by the communication unit 51. The received field-of-view information is used as field-of-view information to be stored in the movement history management DB 5004 (see FIG. 18) by the storing/reading unit 79.

Step S38: Processing that is substantially the same as the processing of Step S37 is also performed between the communication terminal 9a and the communication control apparatus 5 independently of the processing of Step S37. The user ID transmitted in this case is the user ID of the participant A.

Step S39: Processing that is substantially the same as the processing of Step S37 or the processing of Step S38 is also performed between the communication terminal 9b and the communication control apparatus 5 independently of the processing of Step S37 and the processing of Step S38. The user ID transmitted in this case is the user ID of the participant B.

The processing of Step S37 to Step S39 may be executed on the communication control apparatus 5 at the end of the recording.

### Process for Stopping Image Recording and Sound Recording in Communication System

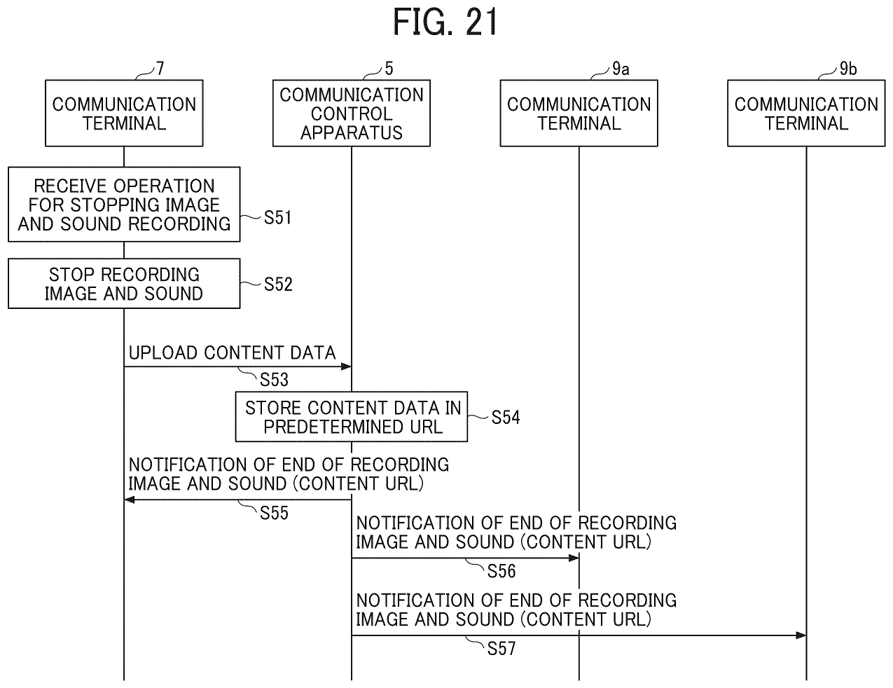

A process for stopping image recording and sound recording in the communication system 1 is described below with reference to FIG. 21. FIG. 21 is a sequence diagram illustrating the process for stopping image recording and sound recording, performed by the communication system 1.

Step S51: The communication terminal 7 receives an operation for stopping image recording and sound recording from the organizer X by the reception unit 72.

Step S52: The storing/reading unit 79 stops image recording and sound recording.

Step S53: The communication unit 71 uploads (transmits) the recorded content to a predetermined content URL (communication control apparatus 5) received in Step S33. The content data includes times (timestamps) each indicating a time when the image and the sound are recorded, from the start to the end of the recording. Accordingly, the communication unit 51 of the communication control apparatus 5 receives the content data. The timestamp is the same as the image and sound capturing date and time illustrated in FIG. 18.

Step S54: The communication control apparatus 5 stores the content data along with the timestamp in the predetermined content URL by the storing/reading unit 59. Further, the storing/reading unit 59 converts the timestamp managed in the movement history management DB 5004 (see FIG. 18) into an elapsed playback time in accordance with the total recording time of the content data of which the recording is stopped.

Step S55: The communication unit 51 transmits a notification of the end of the image recording and sound recording (end notification) to the communication terminal 7. The end notification includes information indicating a predetermined content URL. Accordingly, the communication terminal 7 receives the notification of the end of the image recording and sound recording by the communication unit 71.

Step S56: Similarly, the communication unit 51 transmits a notification of the end of the image recording and sound recording (end notification) to the communication terminal 9a. The end notification includes information indicating a predetermined content URL. Accordingly, the communication terminal 9a receives the notification of the end of the image recording and sound recording by the communication unit 91.

Step S57: Similarly, the communication unit 51 transmits a notification of the end of the image recording and sound recording (end notification) to the communication terminal 9b. The end notification includes information indicating a predetermined content URL. Accordingly, the communication terminal 9b receives the notification of the end of the image recording and sound recording by the communication unit 91.

In the case of the processing of Step S55, the end notification may not include a predetermined content URL.

### Process for Playback of Recorded Image and Recorded Sound in Communication System

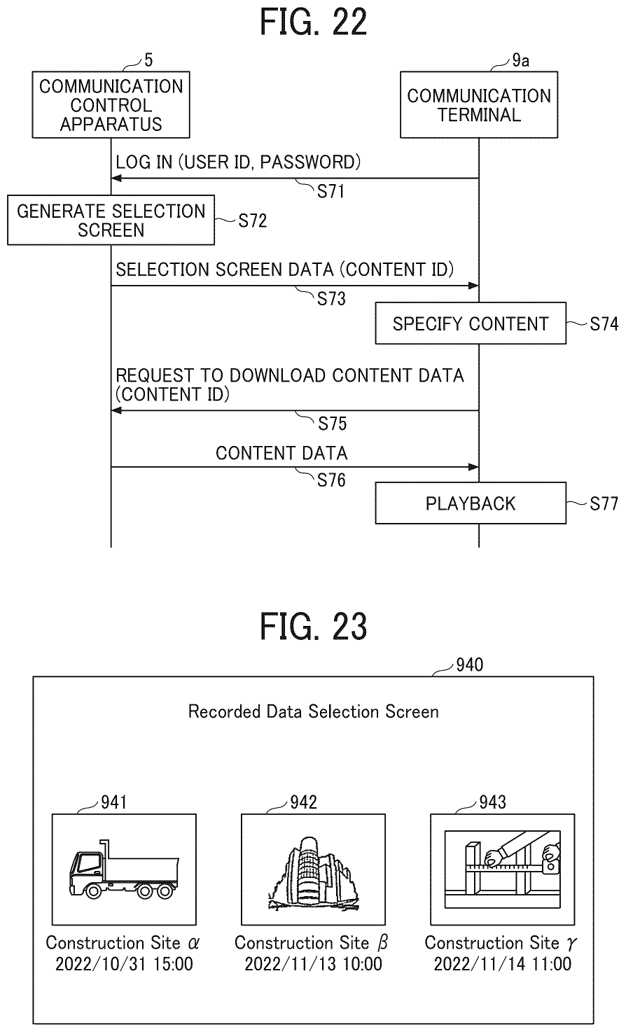

A process for playback of a recorded image and recorded sound in the communication system 1 is described below with reference to FIGS. 22 to 35. FIG. 22 is a sequence diagram illustrating the process of playing back the recorded images and recorded sounds, performed by the communication system 1. FIG. 23 is a diagram illustrating a recorded data selection screen. In this example, the participant A uses the communication terminal 9a to play recorded content.

Step S71: When receiving a login operation of inputting, for example, a login ID and a password from the user A by the reception unit 92, the communication terminal 9a transmits a login request to the communication control apparatus 5 by the communication unit 91. The request includes the user ID and password of the user A. The communication control apparatus 5 receives, by the communication unit 51, the login request and performs authentication, by the authentication unit 55, by referring to the user device management DB (see FIG. 14). The following description is given on the assumption that the user A is determined to be a valid accessor by the login authentication.

Step S72: The communication control apparatus 5 generates a recorded data selection screen 940 as illustrated in FIG. 23, the generation unit 53. In this case, the storing/reading unit 59 searches the virtual room management DB 5002 (see FIG. 15) using the user ID received in Step S71 as a search key and reads all the corresponding virtual room IDs, virtual room names, and content URLs. Then, the generation unit 53 generates thumbnails 941, 942, and 943 using an image of the corresponding content data (with a timestamp) stored in the content URL. Thus, the generation unit 53 adds a virtual room name, such as a “construction site a,” and a recording time, such as “2022 Oct. 31 15:00” indicating a predetermined time (for example, a recording start time) of a timestamp for each thumbnail.

Step S73: The communication unit 51 transmits the selection screen generated in Step S72 to the communication terminal 9a. The selection screen data includes content IDs each of which identifies a wide-field image used as the source for a corresponding thumbnail. The communication terminal 9a receives the selection screen data by the communication unit 91.

Step S74: The communication terminal 9a displays the recorded data selection screen 940 as illustrated in FIG. 23 on the display 507 of the communication terminal 9a by the display control unit 94. Then, the reception unit 92 receives an operation for specifying (selection of) a predetermined thumbnail from the participant A. The following description is given on the assumption that the thumbnail 941 is specified (selected).

Step S75: The communication unit 71 transmits a request to download the content data used as the source for the selected thumbnail 941 to the communication control apparatus 5. This request includes the content ID associated with the thumbnail 941. Accordingly, the communication control apparatus 5 receives the request to download the content data by the communication unit 51.

Step S76: The communication control apparatus 5 searches the virtual room management DB 5002 (see FIG. 15) using the content ID received in Step S75 as a search key by the storing/reading unit 59. The content data also includes position information (image capturing position) where the image capturing device 10 performs image and sound capturing. The position information is described later in detail. The storing/reading unit 59 searches the three-dimensional image management DB 5003 using the three-dimensional image ID associated with the content ID received in Step S75 as a search key and reads, for example, the model IDs and the parameters of the position information (see FIG. 16), or the component numbers and the parameters of the position information (see FIG. 17) associated with the three-dimensional ID.

The communication unit 51 transmits the three-dimensional image data along with the requested content data to the communication terminal 9a. Accordingly, the communication terminal 9a receives the content data and the three-dimensional image data by the communication unit 91.

Step S77: The communication terminal 9a performs a playback process. That is, the communication terminal 9a displays a screen including a recorded image on the display 507 of the communication terminal 9a by the display control unit 94 and outputs sound by the sound input/output control unit 95.

### Details of Screen Display Process (Registration Process)

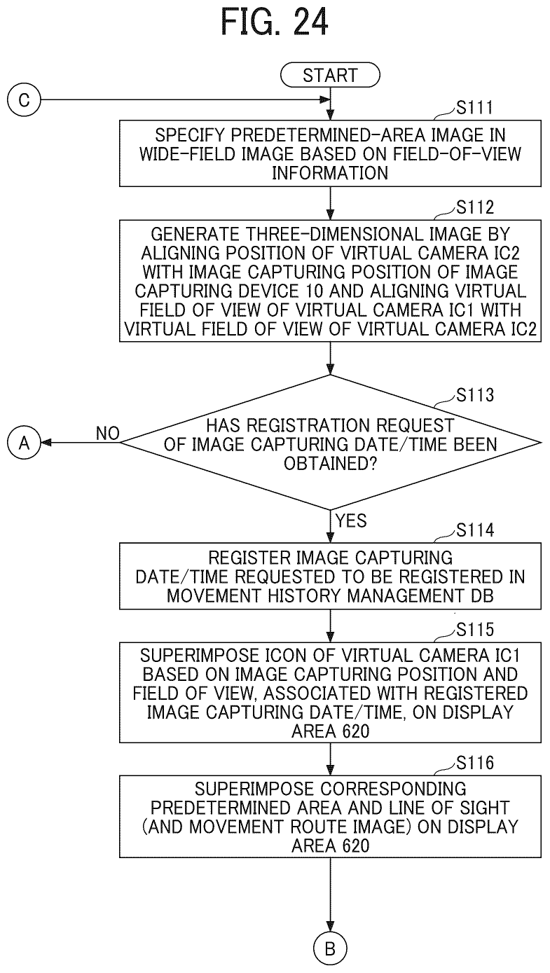

Among the screen display processes, Steps S13 to S15, of FIG. 19, the process of Step S14 is described below with reference to FIGS. 24 to 35. When the participant A operates the communication terminal 9a, the reception unit 92 receives the operation, and the communication unit 91 transmits operation information indicating the content of the operation (operation content) to the communication control apparatus 5. Accordingly, at the communication control apparatus 5, the communication unit 51 that is an example of an acquisition unit acquires the operation information, and the generation unit 53 generates a screen 600 based on the operation content indicated by the operation information. Then, the communication unit 51 transmits data on the screen 600 to the communication terminal 9a, and the communication unit 91 of the communication terminal 9a receives the data on the screen 600. Then, the display control unit 94 displays the screen 600, for example, on the display 507 of the communication terminal 9a. In this case, the communication control apparatus 5 is an example of an information processing apparatus.

The communication unit 91 of the communication terminal 9a may receive data used for generating the screen 600 from the communication control apparatus 5, and the reception unit 92 that is an example of an acquisition unit may acquire operation information indicating the content of the operation performed by the participant A. In this case, the generation unit 93 of the communication terminal 9a generates the screen 600. In this case, the communication terminal 9a is an example of an information processing apparatus. Each of the communication terminals 7 and 9b can perform substantially the same process or have substantially the same functions as the communication terminal 9a.

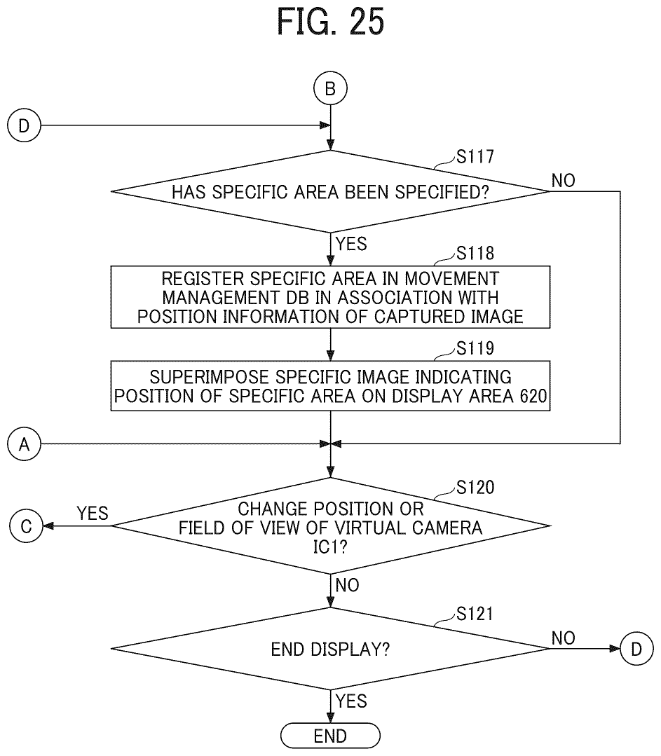

A process for generating the screen 600 to be displayed on the display 507 of the communication terminal 9a, performed by the communication control apparatus 5, is described below. In the processing of Step S13, the processing of Step S15, and the processing of Step S14, the operation of the communication control apparatus 5 is the same, but the terminals to display a screen differ. Thus, the description of the processing of Step S13 and the processing of Step S15 are omitted. FIGS. 24 and 25 illustrate a flowchart of the operation performed by the communication control apparatus 5, in the screen display process.

The generation unit 53 of the communication control apparatus 5 generates the screen 600 to be displayed on the communication terminal 9a as illustrated in FIG. 26. FIG. 26 is a diagram illustrating an example of an initial display screen displayed on the communication terminal 9a. The screen 600 includes the display area 610 and the display area 620. The display area 610 is an example of a captured image display area. The display area 620 is an example of a three-dimensional image area. In FIG. 26, the display area 610 and the display area 620 are displayed simultaneously in the same size on the screen 600. Alternatively, the display area 610 and the display area 620 may be displayed simultaneously in different sizes, or one of the display area 610 and the display area 620 may be displayed by switching by the selection of the participant A. Alternatively, the display area 610 of the screen 600 may be displayed on one of two displays, and the display area 620 of the screen 600 may be displayed on the other one of the two displays.

The display area 610 displays a predetermined-area image (see FIG. 6B) that is a predetermined area in a wide-field image (an example of a captured image) (see FIG. 6A) obtained by the image capturing device 10 capturing an image of a target object such as a desk, a pillar, or a window.

When the captured image is not a curved image such as a wide-field image, the display area 610 displays a predetermined-area image representing a predetermined area that is the same area as that of the imaging area of the captured image.

The display area 620 displays a part or all of a three-dimensional image that includes a three-dimensional model representing the shape of the target object in three dimensions. In the three-dimensional image, the coordinates (an example of the first coordinates) of the wide-field image and the coordinates (an example of the second coordinates) are associated with each other.

As described with reference to FIG. 11, the image capturing position that is the position of the image capturing device 10 is associated with the absolute position on the earth, and as described with reference to FIGS. 16 and 17, all coordinates in the three-dimensional image including the three-dimensional models and components managed in the three-dimensional image management DB 5003 are also associated with the absolute position on the earth.

Thus, the processing unit 54 performs alignment processing by associating, for example, the coordinates of a first position indicating the image capturing position in the wide-field image of the content data received by the communication control apparatus 5 in Step S12 (or Step S12d) and the coordinates of a second position in the three-dimensional image having the same absolute position as the coordinates of the first position. The coordinates are an example of the position information.

As another example of alignment processing, the processing unit 54 may associate the coordinates in the wide-field image with the coordinates indicating the second position in the three-dimensional image by image processing for matching a feature of the wide-field image and a feature of the three-dimensional image, without using the absolute position.

Then, the generation unit 53 generates the screen 600 including the display area 610 and the display area 620 as described above. The display area 610 displays the predetermined-area image, which represents a predetermined area of the wide-field image. The display area 620 displays at least a part of the three-dimensional image in which the second position (second coordinates) is associated with the first position (first coordinates) of the wide-field image by the processing unit 54.

When the table illustrated in FIG. 16 or 17 of the three-dimensional image management DB 5003 manages, for example, a three-dimensional point cloud, a mesh object, or a textured mesh object instead of the three-dimensional model, the display area 620 displays at least a part of a three-dimensional image including the three-dimensional point cloud, the mesh object, or the textured mesh object as a three-dimensional area corresponding to a target object included in a wide-field image.

The screen 600 further includes a “REGISTER” button 680. The “REGISTER” button 680 is pressed to display the icon of the virtual camera IC1 in the display area 620 at a position corresponding to the image capturing position of the image capturing device 10. The virtual camera IC1 has an imaging area that is determined by a field of view (or field-of-view information) for specifying a predetermined-area of the predetermined-area image being displayed in the display area 610.

The screen 600 further includes a close button 609 to be pressed to close the screen 600.

The display contents of the screen 600 are described in detail below. The virtual camera IC1 is used to specify a predetermined-area image displayed in the display area 610 (see FIG. 8). The virtual camera IC2 described below is used to specify a three-dimensional image displayed in the display area 620.

Step S111: The generation unit 53 of the communication control apparatus 5 specifies, in the wide-field image of the content data received by the communication unit 51, a predetermined-area image to be displayed in the display area 610 as illustrated in FIG. 26, based on the virtual field of view of the virtual camera IC1 set in advance (previously set)

Step S112: The processing unit 54 aligns the position of the virtual camera IC2 with an image capturing position associated with the wide-field image and aligns the virtual field of view of the virtual camera IC1 (an example of a first field of view), which is set in advance, with the virtual field of view of the virtual camera IC2 (an example of a second field of view). Accordingly, the generation unit 53 generates a three-dimensional image to be displayed in the display area 620.

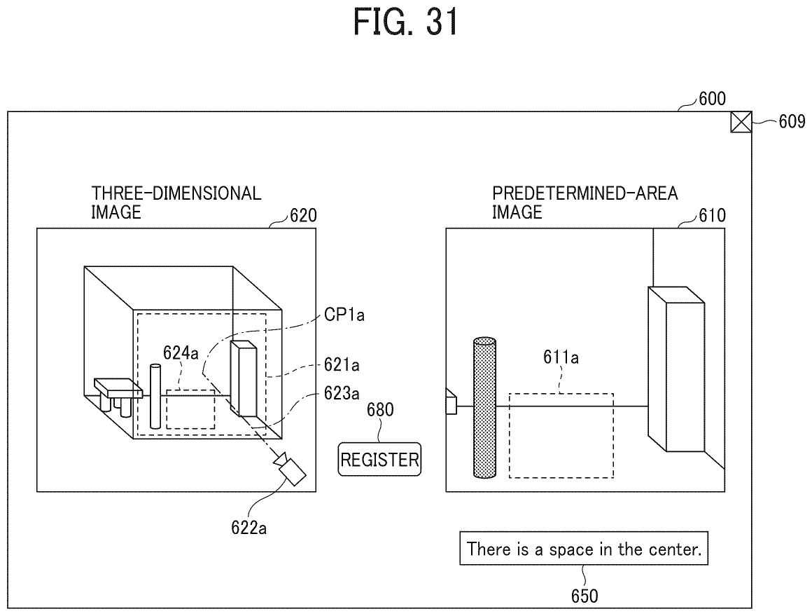

As illustrated in FIG. 27, the specifying processing unit 57 specifies a specific area 611 in a captured image within the display area 610. FIG. 27 is a diagram illustrating an example of a screen displayed on the communication terminal 9a and including a specific area that is specified. The specific area 611 is an area that is specified by an instruction input by the user in the display area 610. For example, the user specifies the specific area 611 by an instruction input with an input device such as a mouse. The user can specify a part of interest (for example, a part having a defect) as the specific area 611.

The specific area 611 may be an area that is specified by image recognition performed by using text information representing text generated from sound (voice) collected (captured) or text input by the user together with the captured image. For example, when the user speaks about a part of interest, and thereby, text information generated based on the voice of the user may be used to perform image recognition to specify the specific area 611. For example, “The upper part of the column is damaged” can be text information.

In FIG. 27, the specific area 611 is indicated by a broken line as an example of a display mode for the specific area 611. Other examples of the display mode include a broken line and a solid line in any color. Further, the thickness of the broken line and the solid line may be different from any other line in the display area 610. The specific area 611 may be an area to be masked.

Step S113: The communication unit 51 determines whether a registration request for registering the image capturing date and time is received from the communication unit 91, based on whether the “REGISTER” button 680 has been pressed at the communication terminal 9a.

Step S114: When the registration request is received (Step S113: YES), the processing unit 54 registers the image capturing date and time, which is requested to be registered, to the movement history management DB 5004 (see FIG. 18). The processing unit 54 registers (stores) a flag corresponding to the registration request in the “REGISTERED” field illustrated in FIG. 18. The date and time when the registration request is received is registered as the image capturing date and time.

As described above with reference to FIG. 18, the movement history management DB 5004 stores, for each content ID, the image and sound capturing date and time, the image capturing position, the field-of-view information, the text information, and the specific area information in association with one another, as data items to be managed.

As described above with reference to FIG. 15, the virtual room management DB 5002 stores, for each virtual room, the content ID and the content URL in association. The content URL is storage location information of content data including wide-field images and sounds.

The image capturing position, the field-of-view information, the wide-field image, and the sound (voice) text are associated with the registered image capturing date and time.

The field-of-view information is information for specifying the predetermined area, which corresponds to the predetermined-area image displayed on the communication terminal 9. Thus, the image capturing position, the predetermined-area image, the sound (voice), and the specific area are associated with the registered image capturing date and time.

Step S115: As illustrated in FIG. 28, the generation unit 53 superimposes the icon 622a of the virtual camera IC1 at a position corresponding to the image capturing position in the display area 620, based on the image capturing position and the field of view that are associated with the image capturing date and time that is registered in Step S114. FIG. 28 is a diagram illustrating a screen in which a corresponding predetermined area, the icon of the virtual camera IC1, and the line of sight of the virtual camera IC1 are displayed in the display area 620.

Step S116: The generation unit 53 superimposes a corresponding predetermined area 621a that corresponds to the field of view of the virtual camera IC1, on the display area 620 as illustrated in FIG. 28. In the screen illustrated in FIG. 28 and displayed on the communication terminal 9a, the icon of the virtual camera IC1, the corresponding predetermined area, and the line of sight of the virtual camera IC1 are superimposed. The corresponding predetermined area 621a corresponds to the predetermined area of the predetermined-area image being displayed in the display area 610. In FIG. 28, the corresponding predetermined area 621a is indicated by a broken line as an example of a display mode. The corresponding predetermined area 621a may be displayed in any other display mode. Other examples of the display mode include a broken line and a solid line in any color. Further, the thickness of the broken line and the solid line may be different from any other line in the display area 620.

The generation unit 53 superimposes the icon 622a of the virtual camera IC1 on the display area 620 to indicate a position corresponding to the image capturing position of the image capturing device 10. The icon 622a is placed, so that the virtual camera IC1 is directed to a center point CPla of the corresponding predetermined area 621a. The icon 622a is an example of a schematic diagram (position image) of the virtual camera IC1. The schematic diagram may include characters such as “camera” or a figure including the characters, in addition to an icon.

Further, the generation unit 53 superimposes a line 623a on the display area 620 to indicate the line of sight of the virtual camera IC1 from the icon 622a towards the center point CPla of the corresponding predetermined area 621a. The line 623a may be a solid line or a broken line or may be displayed with a thickness or color different from those of other lines.

Step S117: The specifying processing unit 57 determines whether the specific area 611 has been specified (is present) in the display area 610 as illustrated in FIG. 28.

Step S118: When the specific area 611 is present or has been specified: specific area 611 has been specified (is present) (Step S117: YES), the processing unit 54 registers the specific area 611 in the movement history management DB 5004 (see FIG. 18) in association with the image capturing position of the captured image.

Step S119: Further, as illustrated in FIG. 28, the generation unit 53 superimposes a specific image 624 indicating the position of the specific area 611 in the display area 620. The specific image 624 is an image indicating the position of the specific area 611 specified in the display area 610. This allows the user to refer to the three-dimensional image on which the specific image 624 indicating the position of the specific area 611 is superimposed, resulting in easier understanding of the position and enhanced convenience.

In FIG. 28, the specific image 624 is indicated by a broken line as an example of a display mode for the specific image 624. Other examples of the display mode include a broken line and a solid line in any color. Further, the thickness of the broken line and the solid line may be different from any other line in the display area 620.

Step S120: After the processing of Step S119, or when the registration request is not received in the processing of Step S113 (Step S113: NO), the generation unit 53 determines whether the position or the field of view of the virtual camera IC1 in the display area 610 has been changed (see FIG. 6C). For example, when the participant A performs an operation for changing the predetermined-area image in the display area 610 illustrated in FIG. 28, the reception unit 92 receives the changed field of view, and the communication unit 91 transmits field-of-view information indicating the changed field of view to the communication control apparatus 5. When the communication unit 51 receives the field-of-view information indicating the changed field of view, the generation unit 53 determines that the field of view of the virtual camera IC1 has been changed. When the position or the field of view of the virtual camera IC1 is changed (Step S120: YES), the process returns to Step S111. Through repeating the processing of Steps S111 to S119, even when the “REGISTER” button 680 is pressed at different times, the communication unit 51 accepts a registration request each time the “REGISTER” button 680 is pressed. The processing unit 54 registers a flag corresponding to each registration request to the movement history management DB 5004. The generation unit 53 may superimpose one or more icons 622a for multiple virtual cameras IC1 on the display area 620.

When the image capturing positions of the multiple virtual cameras IC1 are the same, the generation unit 53 may superimpose the icon 622a of the virtual camera IC1 for the multiple virtual cameras IC1 on the display area 620, and flag registration corresponding to multiple registration requests may be performed in the movement history management DB 5004 in association with the icon 622a of the virtual camera IC1.

Step S121, when the reception unit 92 receives an instruction to end display of the screen 600, for example, by pressing of the close button 609 by the participant A (YES), the display control unit 94 stops displaying the screen 600. When the reception unit 92 does not receive an instruction to end display of the screen 600 (NO), the process returns to Step S117. The processes of FIGS. 24 and 25 are continued until the transmission of the captured image by the communication control apparatus 5, performed in Step S14 of FIG. 19, ends.

The time when the specific area 611 is specified in the captured image is not limited to the time when the screen 600 illustrated in FIG. 27 is displayed, and may be, for example, the time when the screen 600 illustrated in FIG. 29 is displayed.

As illustrated in FIG. 29, the specifying processing unit 57 specifies the specific area 611 in the captured image within the display area 610. FIG. 29 is a diagram illustrating an example of a screen displayed on the communication terminal 9a and including a specific area that is specified. The specific area 611 is an area that is specified by an instruction input by the user in the display area 610. The specific area 611 may be an area that is specified by image recognition performed by using text information representing text generated from sound (voice) collected (captured) or text input by the user together with the captured image.

When the “REGISTER” button 680 is pressed on the screen 600 of FIG. 29, the processing unit 54 performs the processing of Steps S114 to S119, and stores, in the movement history management DB 5004 (see FIG. 18), the image and sound capturing date and time, the image capturing position, the field-of-view information, the text information, and the specific area in association with each other, as data items to be managed for the content ID. The image capturing position, the field-of-view information, the wide-field image, and the sound (voice) text are associated with the registered image capturing date and time.

As illustrated in FIG. 28, the generation unit 53 superimposes the icon 622a of the virtual camera IC1 at a position corresponding to the image capturing position in the display area 620, based on the image capturing position and the field of view that are associated with the image capturing date and time that is registered in Step S114.

Further, the generation unit 53 superimposes the corresponding predetermined area 621a, which corresponds to the field of view of the virtual camera IC1, in the display area 620 as illustrated in FIG. 28. The generation unit 53 superimposes the icon 622a of the virtual camera IC1 on the display area 620 to indicate a position corresponding to the image capturing position of the image capturing device 10. The icon 622a is placed, so that the virtual camera IC1 is directed to a center point CPla of the corresponding predetermined area 621a. Further, the generation unit 53 superimposes the line 623a on the display area 620 to indicate the line of sight of the virtual camera IC1 from the icon 622a towards the center point CP1a of the corresponding predetermined area 621a.

Further, as illustrated in FIG. 28, the generation unit 53 superimposes a specific image 624 indicating the position of the specific area 611 in the display area 620. Specifying the specific area 611 in the captured image may be performed on the screen 600 illustrated in FIG. 27 that is a screen before the icon 622a is displayed, and may be performed on the screen 600 illustrated in FIG. 29 that is a screen after the icon 622a is displayed.

### Another Example of Registration Process

Each screen 600 described above is an example, and the present disclosure is not limited to the example. For example, as illustrated in FIG. 30, a display area 650 for displaying text information may be displayed on the screen 600. FIG. 30 is a diagram illustrating a screen on which a display area for displaying text information is displayed.

The display area 650 is displayed below the display area 610 of the screen 600 illustrated in FIG. 30. In the display area 650, text information that is text based on voice within a predetermined time including the elapsed playback time of the image being displayed in the display area 610 is displayed. For example, when the date and time of imaging and sound capturing (elapsed playback time) is “2023 Nov. 11 10:00:01” in FIG. 18, the generation unit 53 uses the registered text of “The upper part of the column is damaged.” to generate the screen 600 including the display area 650 displaying the text (text information). The registered text has been registered during a period when there is no change in the image capturing position and the field-of-view information (2023 Nov. 11 10:00:01 to 2023 Nov. 11 10:00:03). The text information that represents text input by the user may be displayed in the display area 650.

When the “REGISTER” button 680 is pressed on the screen 600 of FIG. 30, the processing unit 54 performs the processing of Steps S114 to S119, and stores, in the movement history management DB 5004 (see FIG. 18), the image and sound capturing date and time, the image capturing position, the field-of-view information, and the text information indicating “The upper part of the column is damaged.” in association with each other, as data items to be managed for the content ID. Accordingly, the image capturing position, the field-of-view information, the wide-field image, the text information for the display area 650, and the specific area 611 in the display area 610 are associated with the registered image capturing date and time.

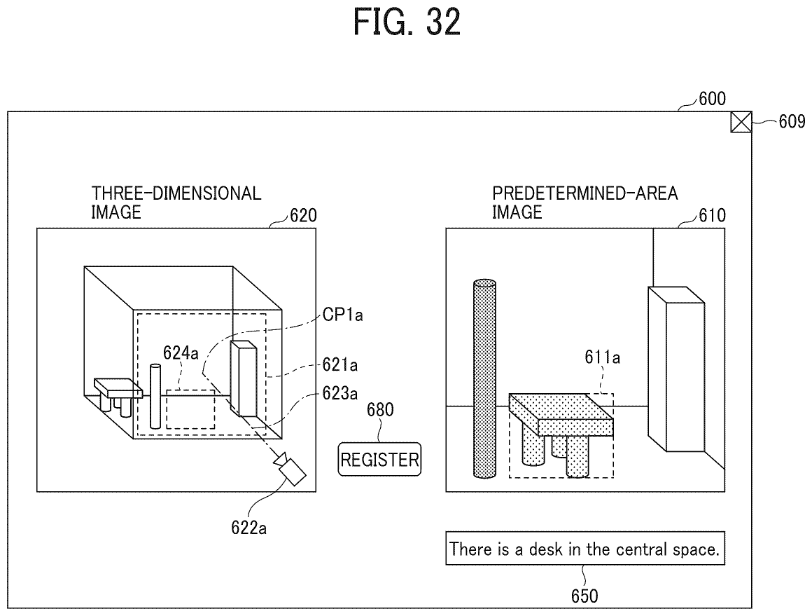

As illustrated in the screens 600 of FIGS. 31 and 32, the processing unit 54 associates the specific area 611 of each of multiple captured images captured at different timings in the position information (at the image capturing position) of the image capturing device 10 performing image and sound capturing with the icon 622a of the virtual camera IC1 based on the image capturing position and the field of view associated with the image capturing date and time registered in the processing of Step S114.

For example, as illustrated in FIG. 31, the specifying processing unit 57 specifies a specific area 611a in the captured image in the display area 610. FIG. 31 is a diagram illustrating an example of a screen displayed on the communication terminal 9a and including a specific area that is specified. The specific area 611a is an area specified by an instruction input by the user in the display area 610. For example, the user specifies the specific area 611a by an instruction input with an input device such as a mouse. The specific area 611a may be an area that is specified in the captured image of the display area 610 by image recognition performed by using the text information of “There is a space in the center.” displayed in the display area 650.

When the “REGISTER” button 680 is pressed on the screen 600 of FIG. 31, the processing unit 54 performs processing of Steps S114 to S119, and stores, in the movement history management DB 5004 (see FIG. 18), the image and sound capturing date and time, the image capturing position, the field-of-view information, the text information indicating “There is a space in the center.,” and the specific area 611a in association with each other, as data items to be managed for the content ID. Accordingly, the processing unit 54 associates the specific area 611a specified in the captured image of the display area 610 with the icon 622a of the virtual camera IC1 based on the image capturing position and the field of view associated with the image capturing date and time registered in the processing of Step S114.

For example, as illustrated in FIG. 32, the specifying processing unit 57 specifies the specific area 611a in the captured image in the display area 610. FIG. 32 is a diagram illustrating an example of a screen displayed on the communication terminal 9a and including a specific area that is specified. The specific area 611a is an area specified by an instruction input by the user in the display area 610. For example, the user specifies the specific area 611a by an instruction input with an input device such as a mouse. The specific area 611a may be an area that is specified in the captured image of the display area 610 by image recognition performed by using the text information of “There is a desk in the central space.” displayed in the display area 650.

When the “REGISTER” button 680 is pressed on the screen 600 of FIG. 32, the processing unit 54 performs the processing of Steps S114 to S119, and stores, in the movement history management DB 5004 (see FIG. 18), the image and sound capturing date and time, the image capturing position, the field-of-view information, the text information indicating “There is a desk in the central space.,” and the specific area 611a in association with each other, as data items to be managed for the content ID. Accordingly, the processing unit 54 associates the specific area 611a specified in the captured image of the display area 610 with the icon 622a of the virtual camera IC1 based on the image capturing position and the field of view associated with the image capturing date and time registered in the processing of Step S114.

The specific area 611a in FIG. 31 and the specific area 611a in FIG. 32 are examples of the specific area 611 of one of multiple captured images captured at different timings. Each specific area 611 of one of the multiple captured images captured at different timings can be associated with the icon 622a of the virtual camera IC1 based on the image capturing position and the field of view associated with the image capturing date and time registered in the processing of Step S114 in response to a user operation of pressing the “REGISTER” button 680 on the screen 600 of FIG. 31 or the screen 600 of FIG. 32.

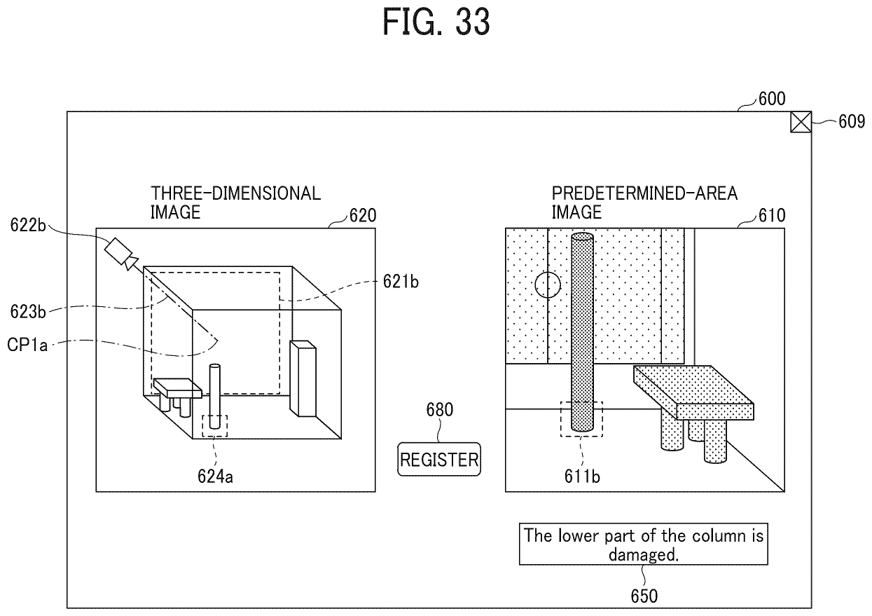

FIG. 33 is another diagram illustrating a screen displayed on the communication terminal 9a, which includes the icon of the virtual camera IC1, the corresponding predetermined area, and the line of sight of the virtual camera IC1, each being superimposed on the display area 620. As illustrated in FIG. 33, as the image capturing position of the image capturing device 10 changes from the one in FIG. 30, the contents displayed in the display areas 610 and 620 also change from those in FIG. 30. In the display area 620 in FIG. 33, a corresponding predetermined area 621b, an icon 622b of the virtual camera IC1, and a line 623b indicating the line of sight of the virtual camera IC1 are indicated.

As illustrated in the screens 600 of FIGS. 30 and 33, the positions of the icon 622a of the virtual camera IC1 and the specific area 611 of FIG. 30 are different from the positions of the icon 622b of the virtual camera IC1 and the specific area 611b of FIG. 33. The processing unit 54 associates an image indicating the image capturing position (for example, the icon 622a or 622b of the virtual camera IC1) with the specific area 611 or 611b in each of the captured images captured at different image capturing positions.

For example, as illustrated in FIG. 33, the specifying processing unit 57 specifies the specific area 611b in the captured image in the display area 610. The specific area 611b is an area specified by an instruction input by the user in the display area 610. The specific area 611b may be an area that is specified in the captured image of the display area 610 by image recognition performed by using the text information of “The lower part of the column is damaged.” displayed in the display area 650.

When the “REGISTER” button 680 is pressed on the screen 600 of FIG. 33, the processing unit 54 performs the processing of Steps S114 to S119, and stores, in the movement history management DB 5004 (see FIG. 18), the image and sound capturing date and time, the image capturing position, the field-of-view information, the text information indicating “The lower part of the column is damaged.” and the specific area 611b in association with each other, as data items to be managed for the content ID. Accordingly, the processing unit 54 associates the specific area 611b specified in the captured image of the display area 610 with the icon 622b of the virtual camera IC1 based on the image capturing position and the field of view associated with the image capturing date and time registered in the processing of Step S114.

The specific area 611 on the screen 600 of FIG. 30 can be associated with the icon 622a of the virtual camera IC1 and the specific area 611b on the screen 600 of FIG. 33 can be associated with the icon 622b of the virtual camera IC1, in response to a user operation of pressing the “REGISTER” button 680 on the screen 600 of FIG. 30 and the screen 600 of FIG. 32, respectively.

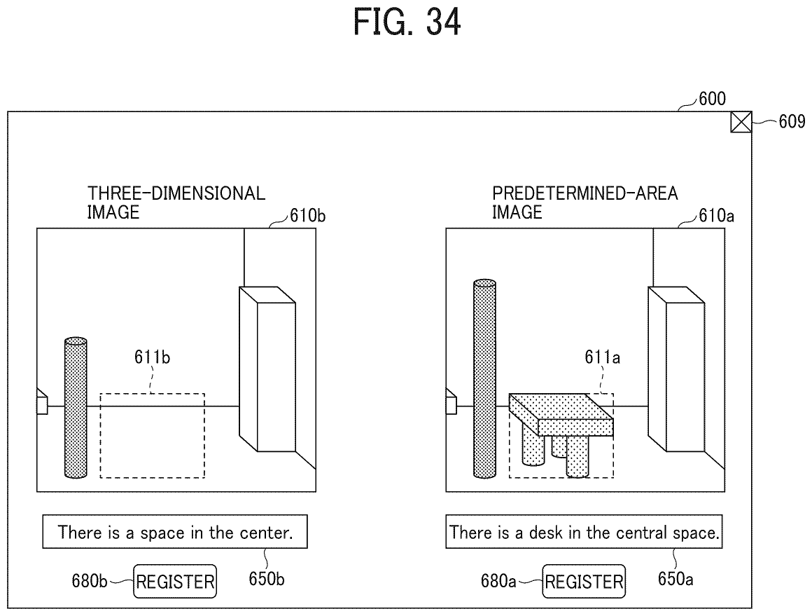

As illustrated in the screen 600 of FIG. 34, the generation unit 53 may display multiple specific areas specified in the captured image on the screen 600 to allow the user to specify a specific area to be associated with the icon 622a of the virtual camera IC1 based on the image capturing position and the field of view associated with the image capturing date and time registered in the processing of Step S114.

The screen 600 of FIG. 34 displays “REGISTER” buttons 680a and 680b. When the “REGISTER” button 680a is pressed on the screen 600 of FIG. 34, the processing unit 54 associates the specific area 610a specified in the captured image of the specific area 611a with the icon 622a of the virtual camera IC1 based on the image capturing position and the field of view. When the “REGISTER” button 680b is pressed on the screen 600 of FIG. 34, the processing unit 54 associates the specific area 610b specified in the captured image of the specific area 611b with the icon 622a of the virtual camera IC1 based on the image capturing position and the field of view.

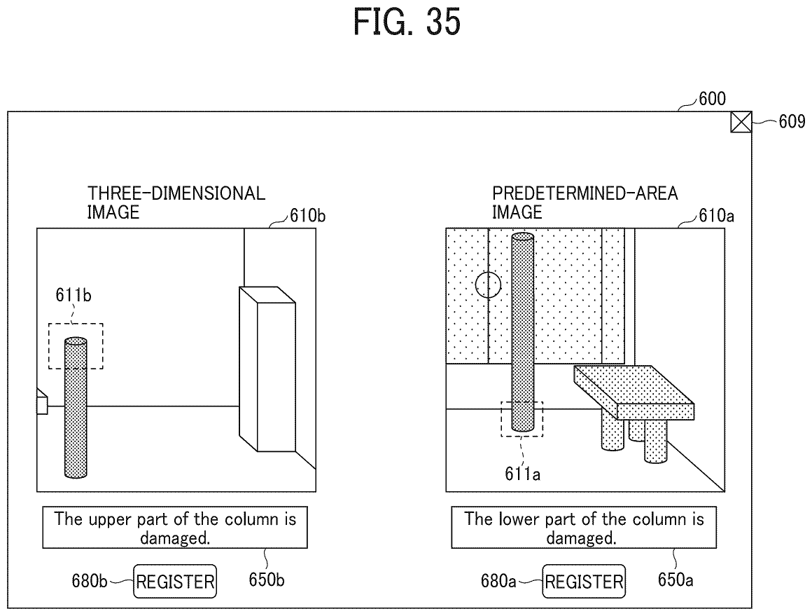

As illustrated in the screen 600 of FIG. 35, the generation unit 53 may display multiple specific areas specified in the captured image on the screen 600 to allow the user to specify a specific area to be associated with the icon 622a or 622b of the virtual camera IC1 based on the image capturing position and the field of view associated with the image capturing date and time registered in the processing of Step S114.

The screen 600 of FIG. 35 displays “REGISTER” buttons 680a and 680b. When the “REGISTER” button 680a is pressed on the screen 600 of FIG. 35, the processing unit 54 associates the specific area 610a specified in the captured image of the specific area 611a with the icon 622a of the virtual camera IC1 based on the image capturing position and the field of view. When the “REGISTER” button 680b is pressed on the screen 600 of FIG. 35, the processing unit 54 associates the specific area 610b specified in the captured image of the specific area 611b with the icon 622a or 622b of the virtual camera IC1 based on the image capturing position and the field of view.

According to the present embodiment described above, the processing unit 54 associates a first position in a captured image obtained by capturing a target object with a second position in a three-dimensional image including a three-dimensional area corresponding to the target object, and the generation unit 53 (or the generation unit 73, 93) generates the screen 600 including the display area 610 displaying a predetermined-area image that is the predetermined area in the captured image obtained by capturing the target object and the display area 620 displaying at least a part of the three-dimensional image in which the first position in the captured image and the second position are associated with each other by the processing unit 54.

Accordingly, the user can recognize what the predetermined-area image captures and where the predetermined-area image is captured by viewing the screen 600. Even if the back of an object is not captured, the user can check the state of the back of the object by viewing the screen 600. Accordingly, generating an image that complements the captured image obtained by image capturing enhances user convenience.

Further, the movement history management DB 5004 of FIG. 18 stores the image capturing date and time, the image capturing position, the field of view being displayed, the text, and the specific area in association. By so doing, when the participant A presses the “REGISTER” button 680 while the predetermined-area image is displayed in the display area 610, the processing unit 54 registers the image capturing date and time, the image capturing position, and the field of view, the text, and the specific area, for the image being displayed, in the movement history management DB 5004. Further, as illustrated in FIG. 28, the generation unit 53 superimposes the icon 622a of the virtual camera IC1 on the display area 620 at a position corresponding to the image capturing position. The imaging area of the virtual camera IC1 is defined by the field of view represented by the predetermined-area image being displayed. Further, as illustrated in FIG. 28, the generation unit 53 can display a three-dimensional image on which the specific image 624 indicating the position of the specific area 611 is superimposed in the display area 620. This allows the user to refer to the three-dimensional image on which the specific image 624 indicating the position of the specific area 611 is superimposed, resulting in easier understanding of the position and enhanced convenience.

### Movement History Management DB

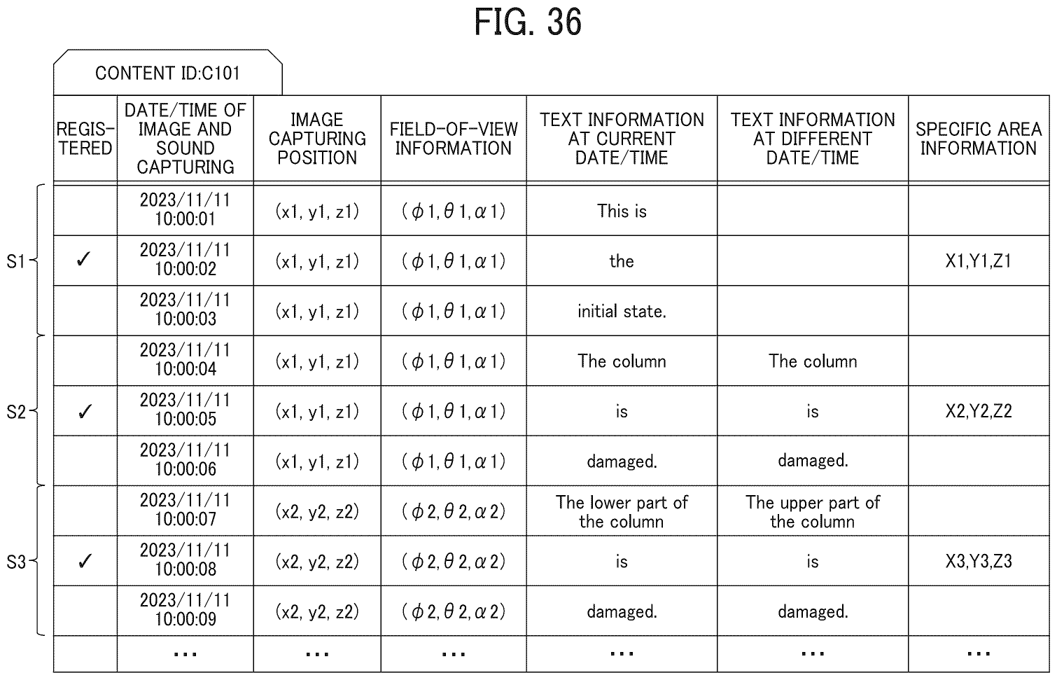

FIG. 36 schematically illustrates a movement history management table. The movement history management DB 5004 includes the movement history management table illustrated in FIG. 36. The movement history management table stores, for each content ID, the image and sound capturing date and time, the image capturing position, the field-of-view information, the text information for the current date and time, the text information for the different date and time, and the specific area information in association with one another, as data items to be managed. The position of the image capturing device 10 is measured by the positioning device 314 of the relay device 3 to which the image capturing device 10 is attached. A positioning unit similar to the positioning device 314 may be provided for the image capturing device 10, to measure the position of the image capturing device 10.

The content ID illustrated in FIG. 36 is the same as the content ID illustrated in FIG. 15.

The image and sound capturing date and time indicates the date and time when the image capturing device 10 captures the image and collects the sound.

The image capturing position indicates the position (absolute position on the earth) of the image capturing device 10 at the image capturing date and time. When sounds are collected (captured), the image capturing position is also a sound collection (capturing) position.

The field-of-view information is information for specifying a predetermined area to be displayed as a predetermined-area image on the communication terminal 9 (see FIG. 8). When the field-of-view information of multiple communication terminals (communication terminals 7, 9, etc.) is managed, the field-of-view information is managed for each communication terminal.

The text registered in the “TEXT INFORMATION OF CURRENT DATE AND TIME” field is data obtained by converting the voice recorded on the recording date and time in the same record into text, or data associated by the processing unit 54 by pressing an “ASSOCIATE” button 682 described later.

In the “TEXT INFORMATION OF DIFFERENT DATE AND TIME” field, the current being displayed in the display area 650 or past text previously displayed in a display area 652 is registered by the processing unit 54. The display areas 650 and 652 are examples of a text display area.

The specific area information is information indicating the position of the specific area that is specified in the current or different captured image. The captured image at the current date and time is an example of a first captured image. The captured image of different date and time is an example of a second captured image. The information indicating the position of the specified area may be information represented by two-dimensional coordinates or a three-dimensional image. The specific area specified in the current or different captured image is described in detail later.

The movement history management table further includes a “REGISTERED” field for registering the display position of the icon of the virtual camera IC1, for each image capturing date and time. The generation unit 53 may display, for example, an icon 622a of the virtual camera IC1 at an image capturing position in a display area 620, which is described later, when the flag is registered in the “REGISTERED” field. By registering a flag in the “REGISTERED” field, the generation unit 53 may associate an image capturing position in the display area 620, which is described later, with the specific area 611a that is specified in the captured image at the current date and time or a specific area 631a that is specified in the captured area at a different date and time. The specific areas 611a and 631a are described later.

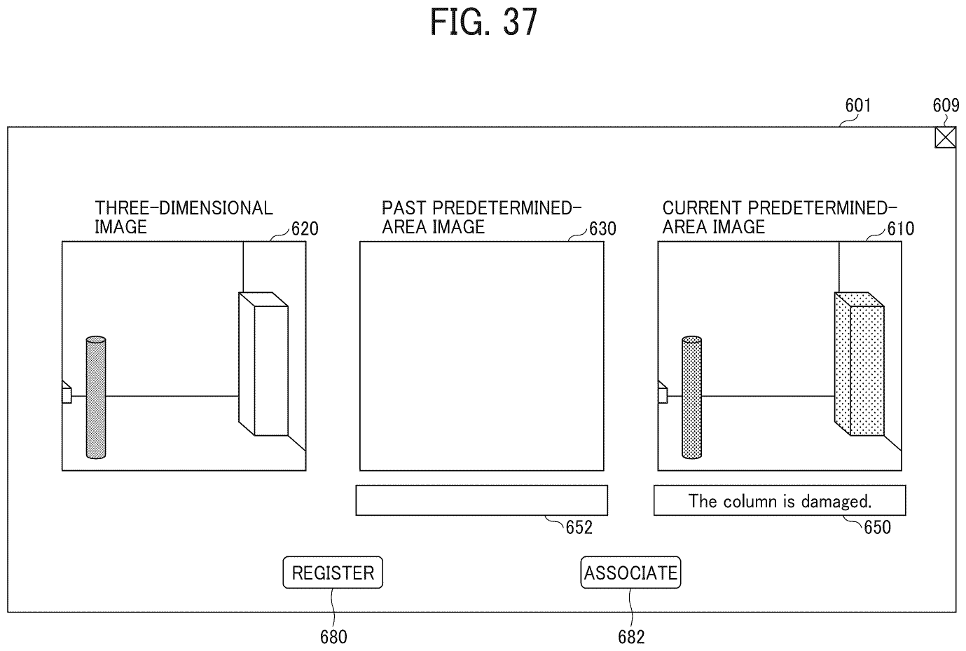

The generation unit 53 of the communication control apparatus 5 generates a screen 601 to be displayed on the communication terminal 9a as illustrated in FIG. 37. FIG. 37 is a diagram illustrating an example of an initial display screen displayed on the communication terminal 9a. The screen 601 includes the display area 610, the display area 620, and a display area 630. The display area 610 is an example of a first captured image display area. The display area 620 is an example of a three-dimensional image area. The display area 630 is an example of a second captured image display area. In FIG. 37, the display area 610, the display area 620, and the display area 630 are displayed simultaneously in the same size on the screen 601. Alternatively, the display area 610, the display area 620, and the display area 630 may be displayed simultaneously in different sizes. Alternatively, one of the display area 610, the display area 620, and the display area 630 may be selectively displayed according to the selection made by the participant A. Alternatively, the display area 610, the display area 620, and the display area 630 may be displayed, respectively, on a first display, a second display, and a third display.

The display area 610 displays a predetermined-area image (see FIG. 6B) that is a predetermined area in the current wide-field image (an example of a captured image) (see FIG. 6A) obtained by the image capturing device 10 capturing an image of a target object such as a desk, a pillar, or a window. When the current captured image is not a curved image such as a wide-field image, the display area 610 displays a predetermined-area image representing a predetermined area that is the same area as that of the imaging area of the current captured image.

The display area 620 displays a part or all of a three-dimensional image that includes a three-dimensional model representing the shape of the target object (table, column, etc.,) in three dimensions. In the three-dimensional image, the coordinates (an example of the first coordinates) of the wide-field image and the coordinates (an example of the second coordinates) are associated with each other.

The display area 630 displays a predetermined-area image (see FIG. 6B), which is a predetermined area of the past wide-field image (see FIG. 6A). The past wide-field image is an example of a past captured image that is previously obtained by the image capturing device 10 by capturing an image of a target object. When the past captured image is not a curved image such as a wide-field image, the display area 630 displays a predetermined-area image representing a predetermined area that is the same area as that of the imaging area of the past captured image.

As described with reference to FIG. 11, the image capturing position that is the position of the image capturing device 10 is associated with the absolute position on the earth, and as described with reference to FIGS. 16 and 17, all coordinates in the three-dimensional image including the three-dimensional models and components managed in the three-dimensional image management DB 5003 are also associated with the absolute position on the earth.

Thus, the processing unit 54 performs alignment processing by associating, for example, the coordinates of a first position indicating the image capturing position in the current wide-field image of the content data received by the communication control apparatus 5 in Step S12 (or Step S12d), the coordinates of a second position in the three-dimensional image having the same absolute position as the coordinates of the first position, and the coordinates of a third position indicating the image capturing position in the past wide-field image. The coordinates are an example of the position information.

As another example of alignment processing, the processing unit 54 may associate the coordinates of the first position in the current wide-field image, the coordinates of the second position in the three-dimensional image, and the coordinates of the third position in the past wide-field image by image processing for matching a feature of the current wide-field image and a feature of the three-dimensional image, without using the absolute position.

Then, as described above, the generation unit 53 generates the screen 601 including the display area 610, the display area 620, and the display area 630. The display area 610 displays the predetermined-area image, which represents a predetermined area of the current wide-field image. The display area 620 displays at least a part of the three-dimensional image in which the second position (second coordinates) is associated with the first position (first coordinates) in the wide-field image. The display area 630 displays the predetermined-area image, which represents a predetermined area of the past wide-field image, in which the third position (third coordinates) is associated with the first position (first coordinates).

When the table illustrated in FIG. 16 or 17 of the three-dimensional image management DB 5003 manages, for example, a three-dimensional point cloud, a mesh object, or a textured mesh object instead of the three-dimensional model, the display area 620 displays at least a part of a three-dimensional image including the three-dimensional point cloud, the mesh object, or the textured mesh object as a three-dimensional area corresponding to a target object included in a wide-field image.

Further, the screen 601 further includes the “REGISTER” button 680 and the “ASSOCIATE” button 682. The “REGISTER” button 680 is pressed to display the icon of the virtual camera IC1 in the display area 620 at a position corresponding to the image capturing position of the image capturing device 10. The virtual camera IC1 has an imaging area that is determined by a field of view (or field-of-view information) for specifying a predetermined-area of the predetermined-area image being displayed in the display area 610. The “ASSOCIATE” button 682 is pressed to associate specific images indicating the position of a specific area, which is described later, between the current captured image and the past captured image.

The screen 601 further includes the close button 609 to be pressed to close the screen 601.

The display contents of the screen 600 are described in detail below. The virtual camera IC1 is used to specify a predetermined-area image displayed in the display area 610 (see FIG. 8). The virtual camera IC2 described below is used to specify a three-dimensional image displayed in the display area 620.

Step S111: The generation unit 53 of the communication control apparatus 5 specifies, in the current wide-field image of the content data received by the communication unit 51, a current predetermined-area image to be displayed in the display area 610 as illustrated in FIG. 37, based on the virtual field of view of the virtual camera IC1 set in advance.

Step S112: The processing unit 54 aligns the position of the virtual camera IC2 with an image capturing position associated with the current wide-field image and aligns the virtual field of view of the virtual camera IC1 (an example of a first field of view), which is set in advance, with the virtual field of view of the virtual camera IC2 (an example of a second field of view). Accordingly, the generation unit 53 generates a three-dimensional image to be displayed in the display area 620.

Step S113: The communication unit 51 determines whether a registration request for registering the image capturing date and time is received from the communication unit 91, based on whether the “REGISTER” button 680 has been pressed at the communication terminal 9a.

Step S114: When the registration request is received (Step S113: YES), the processing unit 54 registers the image capturing date and time, which is requested to be registered, to the movement history management DB 5004 (see FIG. 36). The processing unit 54 registers (stores) a flag corresponding to the registration request in the “REGISTERED” field illustrated in FIG. 36. The date and time when the registration request is received is registered as the image capturing date and time.

As described above with reference to FIG. 36, the movement history management DB 5004 stores, for each content ID, the image and sound capturing date and time, the image capturing position, the field-of-view information, the text information for the current date and time, the text information for the different date ant time, and the specific area information in association with one another, as data items to be managed.

As described above with reference to FIG. 15, the virtual room management DB 5002 stores, for each virtual room, the content ID and the content URL in association. The content URL is storage location information of content data including wide-field images and sounds.

The image capturing position, the field-of-view information, the wide-field image, and the sound (voice) text are associated with the registered image capturing date and time.

The field-of-view information is information for specifying the predetermined area, which corresponds to the predetermined-area image displayed on the communication terminal 9. Thus, the image capturing position, the predetermined-area image, the sound (voice), and the specific area are associated with the registered image capturing date and time.

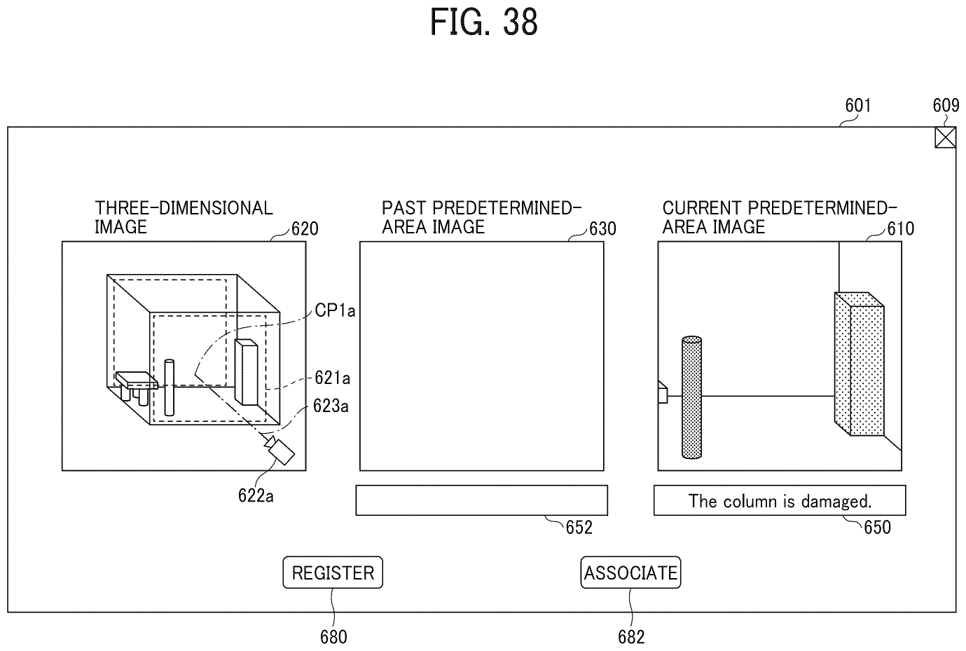

Step S115: As illustrated in FIG. 38, the generation unit 53 superimposes the icon 622a of the virtual camera IC1 at a position corresponding to the image capturing position in the display area 620, based on the image capturing position and the field of view that are associated with the image capturing date and time that is registered in Step S114. FIG. 38 is a diagram illustrating a screen in which a corresponding predetermined area, the icon of the virtual camera IC1, and the line of sight of the virtual camera IC1 are displayed in the display area 620.

Step S116: The generation unit 53 superimposes a corresponding predetermined area 621a that corresponds to the field of view of the virtual camera IC1, on the display area 620 as illustrated in FIG. 38. FIG. 38 is a diagram illustrating a screen displayed at the communication terminal 9a, which includes the icon of the virtual camera IC1, the corresponding predetermined area, and the line of sight of the virtual camera IC1, each being superimposed on the display area 620. The corresponding predetermined area 621a corresponds to the predetermined area of the predetermined-area image being displayed in the display area 610. In FIG. 38, the corresponding predetermined area 621a is indicated by a broken line as an example of a display mode. The corresponding predetermined area 621a may be displayed in any other display mode. Other examples of the display mode include a broken line and a solid line in any color. Further, the thickness of the broken line and the solid line may be different from any other line in the display area 620.

The generation unit 53 superimposes the icon 622a of the virtual camera IC1 on the display area 620 to indicate a position corresponding to the image capturing position of the image capturing device 10. The icon 622a is placed, so that the virtual camera IC1 is directed to a center point CPla of the corresponding predetermined area 621a. The icon 622a is an example of a schematic diagram (position image) of the virtual camera IC1. The schematic diagram may include characters such as “camera” or a figure including the characters, in addition to an icon.

Further, the generation unit 53 superimposes a line 623a on the display area 620 to indicate the line of sight of the virtual camera IC1 from the icon 622a towards the center point CPla of the corresponding predetermined area 621a. The line 623a may be a solid line or a broken line or may be displayed with a thickness or color different from those of other lines. Step S117: The specifying processing unit 57 determines whether the specific area 611 has been specified (is present) in the display area 610.

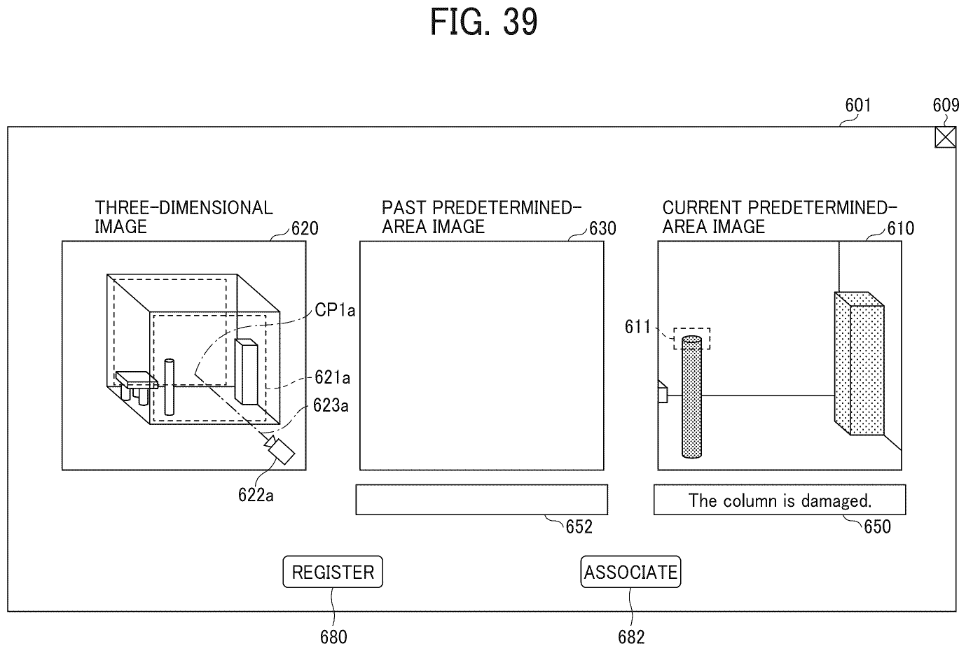

As illustrated in FIG. 39, the specifying processing unit 57 specifies the specific area 611 in the current captured image within the display area 610. FIG. 39 is a diagram illustrating an example of a screen displayed on the communication terminal 9a and including a specific area that is specified. The specific area 611 is an area that is specified by an instruction input by the user in the display area 610. For example, the user specifies the specific area 611 by an instruction input with an input device such as a mouse. The user can specify a part of interest (for example, a part having a defect) as the specific area 611.

The specific area 611 may be an area that is specified by image recognition performed by using text information representing text generated from sound (voice) collected (captured) or text input by the user together with the current captured image. For example, when the user speaks about a part of interest, and thereby, text information generated based on the voice of the user may be used to perform image recognition to specify the specific area 611. For example, “The upper part of the column is damaged” can be text information.

In FIG. 39, the specific area 611 is indicated by a broken line as an example of a display mode for the specific area 611. Other examples of the display mode include a broken line and a solid line in any color. Further, the thickness of the broken line and the solid line may be different from any other line in the display area 610. The specific area 611 may be an area to be masked.

Step S118: When the specific area 611 is present or has been specified: specific area 611 has been specified (is present) (Step S117: YES), the processing unit 54 registers the specific area 611 in the movement history management DB 5004 (see FIG. 36) in association with the image capturing position of the current captured image.

Step S119: Further, as illustrated in FIG. 28, the generation unit 53 superimposes the specific image 624 indicating the position of the specific area 611 in the display area 620. Step S120: After the processing of Step S119, when the specific area 611 has not been specified (is absent) in Step S117, or when the registration request is not received in the processing of Step S113 (Step S113: NO), the generation unit 53 determines whether the position or the field of view of the virtual camera IC1 in the display area 610 has been changed (see FIG. 6C). For example, when the participant A performs an operation for changing the current predetermined-area image in the display area 610 illustrated in FIG. 38, the reception unit 92 receives the changed field of view, and the communication unit 91 transmits field-of-view information indicating the changed field of view to the communication control apparatus 5. When the communication unit 51 receives the field-of-view information indicating the changed field of view, the generation unit 53 determines that the field of view of the virtual camera IC1 has been changed. When the position or the field of view of the virtual camera IC1 is changed (Step S120: YES), the process returns to Step S111. Through repeating the processing of Steps S111 to S119, even when the “REGISTER” button 680 is pressed at different times, the communication unit 51 accepts a registration request each time the “REGISTER” button 680 is pressed. The processing unit 54 registers a flag corresponding to each registration request to the movement history management DB 5004. The generation unit 53 may superimpose one or more icons 622a for multiple virtual cameras IC1 on the display area 620.

When the image capturing positions of the multiple virtual cameras IC1 are the same, the generation unit 53 may superimpose the icon 622a of the virtual camera IC1 for the multiple virtual cameras IC1 on the display area 620, and flag registration corresponding to multiple registration requests may be performed in the movement history management DB 5004 in association with the icon 622a of the virtual camera IC1.

Step S121: When the reception unit 92 receives an instruction to end display of the screen 601, for example, by pressing of the close button 609 by the participant A (YES), the display control unit 94 stops displaying the screen 601. When the reception unit 92 does not receive an instruction to end display of the screen 601 (NO), the process returns to Step S117. The processes of FIGS. 24 and 25 are continued until the transmission of the captured image by the communication control apparatus 5, performed in Step S14 of FIG. 19, ends.

The time when the specific area 611 is specified in the captured image is not limited to the time when the screen 601 illustrated in FIG. 39 is displayed, and may be, for example, the time when the screen 601 illustrated in FIG. 37 is displayed.

The display area 650 for displaying text information may be displayed on the screen 601. The display area 650 is displayed below the display area 610 of the screen 601. In the display area 650, text information that is text based on voice within a predetermined time including the elapsed playback time of the image being displayed in the display area 610 is displayed. For example, when the date and time of imaging and sound capturing (elapsed playback time) is “2023 Nov. 11 10:00:01” in FIG. 36, the generation unit 53 uses the registered text of “The column is damaged.” to generate the screen 601 including the display area 650 displaying the text (text information). The registered text has been registered during a period when there is no change in the image capturing position and the field-of-view information (2023 Nov. 11 10:00:04 to 2023 Nov. 11 10:00:06).

The text information that represents text input by the user may be displayed in the display area 650.

The screen 601 may display the display area 652 for displaying text information. The display area 652 is displayed below the display area 630 of the screen 601. In the display area 652, text information that is text based on voice within a predetermined time including the elapsed playback time of the image being displayed in the display area 630 is displayed.

When the “REGISTER” button 680 is pressed on the screen 601 of FIG. 39, the processing unit 54 performs the processing of Steps S114 to S118, and stores, in the movement history management DB 5004 (see FIG. 36), the image and sound capturing date and time, the image capturing position, the field-of-view information, and the text information for the current date and time in association with each other, as data items to be managed for the content ID. Accordingly, the image capturing position, the field-of-view information, the text information for the current date and time, and the specific area 611 in the display area 610 are associated with the registered image capturing date and time.

### Details of Screen Display Process (After Registration)

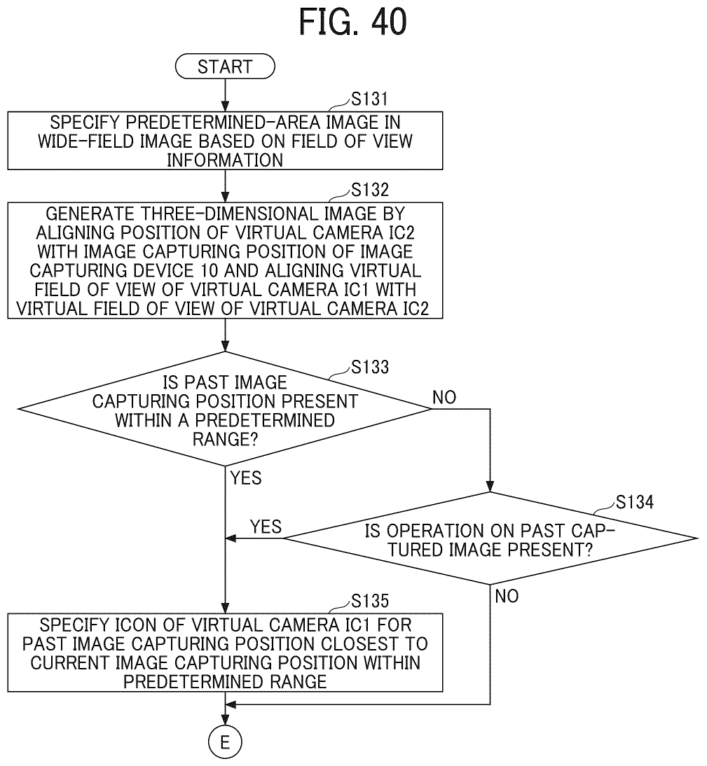

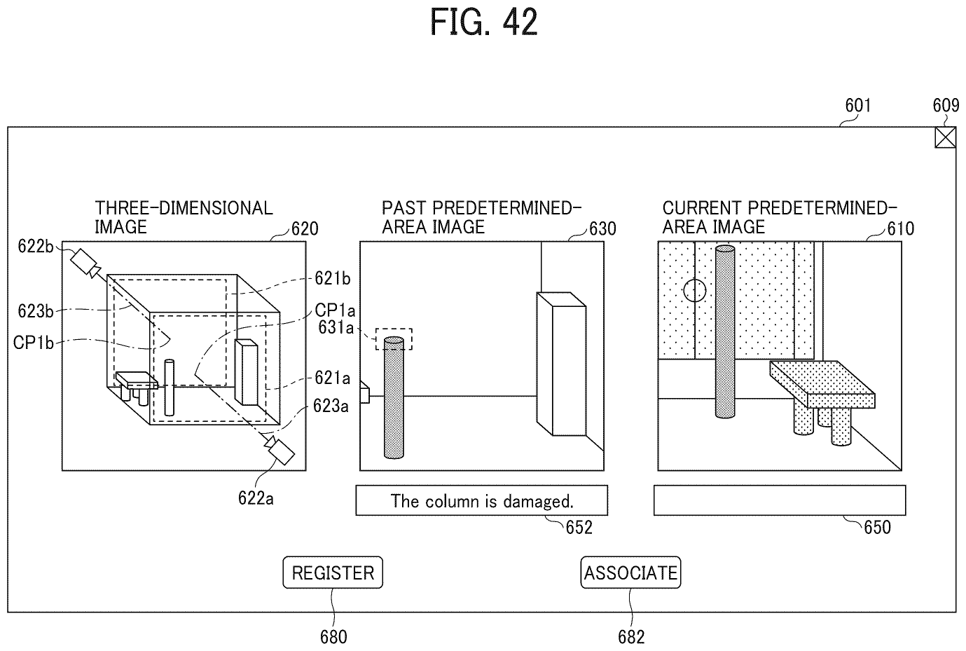

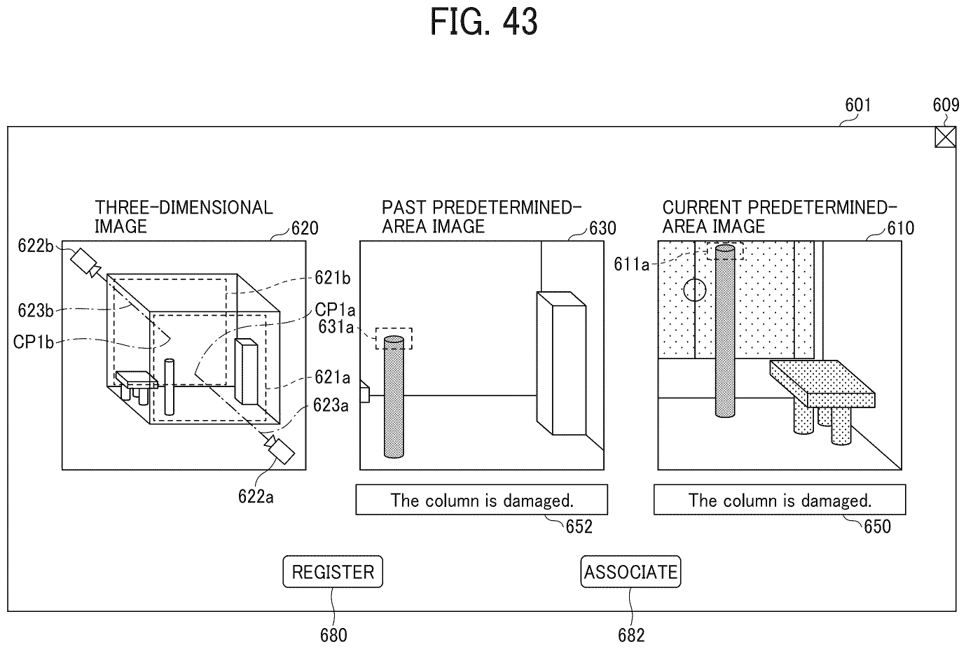

Among the screen display processes, Steps S13 to S15, of FIG. 19, the process of Step S14 is described below with reference to FIGS. 40 to 43. In FIGS. 42 and 43, the same reference numerals are given to the components in FIGS. 37 to 39, which function in substantially the same manner. When the participant A operates the communication terminal 9a, the reception unit 92 receives the operation, and the communication unit 91 transmits operation information indicating the content of the operation (operation content) to the communication control apparatus 5. Accordingly, at the communication control apparatus 5, the communication unit 51 that is an example of an acquisition unit acquires the operation information, and the generation unit 53 generates the screen 601 based on operation content indicated by the operation information. Then, the communication unit 51 transmits data on the screen 601 to the communication terminal 9a, and the communication unit 91 of the communication terminal 9a receives the data on the screen 601. Then, the display control unit 94 displays the screen 601, for example, on the display 507 of the communication terminal 9a. In this case, the communication control apparatus 5 is an example of an information processing apparatus.

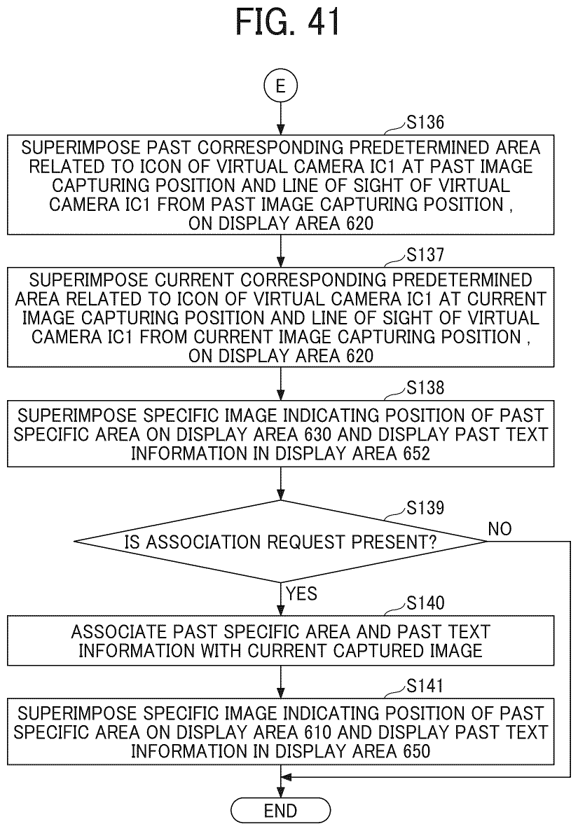

A process for generating the screen 601 to be displayed on the display 507 of the communication terminal 9a, performed by the communication control apparatus 5 is described below. In the processing of Step S13, the processing of Step S15, and the processing of Step S14, the operation of the communication control apparatus 5 is the same, but the terminals to display a screen differ. Thus, the description of the processing of Step S13 and the processing of Step S15 are omitted. FIGS. 40 and 41 are flowcharts of a process performed by the communication control apparatus in the screen display process after registering dates and times of image capturing.

The generation unit 53 of the communication control apparatus 5 generates the screen 601 to be displayed on the communication terminal 9a as illustrated in FIG. 42. FIG. 42 is a diagram illustrating a screen for displaying the current predetermined-area image at the communication terminal 9a, after registering the image capturing date and time. The screen 601 includes the display area 610, the display area 620, and a display area 630. The display area 610 is an example of a first captured image display area. The display area 620 is an example of a three-dimensional image area. The display area 630 is an example of a second captured image display area. In FIG. 42, the display area 610, the display area 620, and the display area 630 are displayed simultaneously in the same size on the screen 601. Alternatively, the display area 610, the display area 620, and the display area 630 may be displayed simultaneously in different sizes. Alternatively, one of the display area 610, the display area 620, and the display area 630 may be selectively displayed according to the selection made by the participant A. Alternatively, the display area 610, the display area 620, and the display area 630 may be displayed, respectively, on a first display, a second display, and a third display.

The display area 610 displays a predetermined-area image (see FIG. 6B), which is a predetermined area of the current wide-field image (see FIG. 6A). The current wide-field image is an example of the current image that is currently obtained by the image capturing device 10 by capturing an image of a target object.

The display area 620 displays a part or all of a three-dimensional image that includes a three-dimensional model representing the shape of the target object (table, column, etc.,) in three dimensions. In the three-dimensional image, the coordinates (an example of the first coordinates) of the wide-field image and the coordinates (an example of the second coordinates) are associated with each other.

The display area 630 displays a predetermined-area image (see FIG. 6B), which is a predetermined area of the past wide-field image (see FIG. 6A). The past wide-field image is an example of a past captured image that is previously obtained by the image capturing device 10 by capturing an image of a target object.

When the captured image is not the curved image such as the wide-field image, the display areas 610 and 630 each display a predetermined-area image, which represents a predetermined area that is the same area as that of the imaging area of the captured image.

The display area 620 displays a part or all of a three-dimensional image that includes a three-dimensional model representing the shape of the target object in three dimensions. In the three-dimensional image, the coordinates (an example of the first coordinates) of the wide-field image and the coordinates (an example of the second coordinates) are associated with each other.

The processing unit 54 aligns the positions of the display areas 610, 620, and 630 as described above. Then, as described above, the generation unit 53 generates the screen 601 including the display area 610, the display area 620, and the display area 630. The display area 610 displays the predetermined-area image, which represents a predetermined area of the current wide-field image. The display area 620 displays at least a part of the three-dimensional image in which the second position (second coordinates) is associated with the first position (first coordinates) in the wide-field image. The display area 630 displays the predetermined-area image, which represents a predetermined area of the past wide-field image, in which the third position (third coordinates) is associated with the first position (first coordinates).

Further, the screen 601 further includes the “REGISTER” button 680 and the “ASSOCIATE” button 682. The “REGISTER” button 680 is pressed to display the icon of the virtual camera IC1 in the display area 620 at a position corresponding to the image capturing position of the image capturing device 10. The virtual camera IC1 has an imaging area that is determined by a field of view (or field-of-view information) for specifying a predetermined-area of the predetermined-area image being displayed in the display area 610. The “ASSOCIATE” button 682 is pressed to associate a specific image indicating the position of a specific area 631a in the past captured image with the current captured image.

The display contents of the screen 601 are described in detail below. The virtual camera IC1 is used to specify the predetermined-area image displayed in each of the display areas 610 and 630 (see FIG. 8). The virtual camera IC2 described below is used to specify the three-dimensional image displayed in the display area 620.

Step S131: The generation unit 53 of the communication control apparatus 5 specifies, in the current wide-field image of the content data received by the communication unit 51, a current predetermined-area image to be displayed in the display area 610 as illustrated in FIG. 42, based on the virtual field of view of the virtual camera IC1 set in advance.

Step S132: The processing unit 54 aligns the position of the virtual camera IC2 with an image capturing position associated with the current wide-field image (content data) and aligns the virtual field of view of the virtual camera IC1 (an example of a first field of view), which is set in advance, with the virtual field of view of the virtual camera IC2 (an example of a second field of view). Accordingly, the generation unit 53 generates a three-dimensional image to be displayed in the display area 620.

As illustrated in FIG. 42, when the “REGISTER” button 680 is pressed, the same processing as the above-described processing of S113 to S116 are performed. Accordingly, the generation unit 53 can superimpose the corresponding predetermined area 621b at a position corresponding to the current image capturing position in the display area 620. The generation unit 53 can further superimpose the line 623b representing the line of sight of the icon 622b of the virtual camera IC1 with respect to the center point CP1b of the corresponding predetermined area 621b. The icon 622b is an example of an image indicating the first virtual camera.

Step S133: The generation unit 53 determines whether there is any icon representing the virtual camera IC1 and indicating a past image capturing position within a predetermined range (distance) from the current image capturing position. The predetermined range is, for example, 3 meters when an absolute position is assumed.

Step S134: When there is no past image capturing position within the predetermined range from the current image capturing position (Step S133: NO), the communication unit 51 determines whether an instruction to operate a past captured image has been acquired.

For example, the communication unit 51 determines whether an instruction to select (or designate) one icon from among multiple icons each representing the virtual camera IC1 and indicating a past image capturing position has been received from the participant A. When the communication unit 51 does not acquire an instruction to operate a past captured image (Step S134: NO), the communication unit 51 performs the processing of Step S136.

Step S135: When there is a past image capturing position within the predetermined range from the current image capturing position (Step S133: YES), or when an instruction to operate a past captured image is acquired (Step S134: YES), the generation unit 53 specifies a predetermined icon for a past image capturing position closest to the current image capturing position (the position of the icon 622b of the virtual camera IC1) within the predetermined range from the current image capturing position. In the example, the icon 622a is specified.

Step S136: The generation unit 53 superimposes, on the display area 620, the corresponding predetermined area 621b related to the icon 622b of the predetermined current virtual camera IC1. The generation unit 53 further superimposes, on the display area 620, the line 623b representing the line of sight of the virtual camera IC1 from the icon 622b to the center CP1b of the corresponding predetermined area 621b. The processing of Step S136 is substantially the same as or similar to that of Step S116.

Step S137: The generation unit 53 superimposes, on the display area 620, the corresponding predetermined area 621a related to the icon 622a of the predetermined current virtual camera IC1. The generation unit 53 further superimposes, on the display area 620, the line 623a representing the line of sight of the virtual camera IC1 from the icon 622a to the center CPla of the corresponding predetermined area 621a. The processing of Step S137 is substantially the same as or similar to that of Step S116.

Step S138: The generation unit 53 superimposes a specific image indicating the position of the specific area 631a specified in the past captured image, on the display area 630 (an example of a second captured image display area) displaying a past predetermined-area image (an example of a second predetermined area image) corresponding to the icon 622a of the virtual camera IC1 as illustrated in FIG. 42. Further, the generation unit 53 displays text information of the time of capturing the past predetermined-area image in the display area 652 that places below the display area 630 of the screen 601.

Step S139: The processing unit 54 determines whether an association request is present or has been received. The association request is an instruction to associate a specific image indicating the position of the specific area 631a specified in the past captured image, between the current captured image and the past captured image, and received in response to a user operation of pressing the “ASSOCIATE” button 682 by the acquisition unit (the reception unit 92, the communication unit 51).

Step S140: When the association request or the instruction to associate is present (Step 139: YES), the processing unit 54 registers the specific area 631a being displayed in the display area 630 in the “SPECIFIC AREA INFORMATION” field of the movement history management DB 5004 (see FIG. 36) in association with the image and sound capturing date and time of the current predetermined-area image (predetermined area) being displayed in the display area 610. The processing unit 54 registers the past text (text information) being displayed in the display area 652 in the “TEXT INFORMATION FOR DIFFERENT DATE AND TIME” field of the movement history management DB 5004 (see FIG. 36) in association with the image and sound capturing date and time of the current predetermined-area image (predetermined area) being displayed in the display area 610.

Step S141: As illustrated in FIG. 43, the generation unit 53 generates the screen 601 in which a specific image of the specific area 631a indicating the position of the specific area 611a specified in the past captured image being displayed in the display area 630 is superimposed on and displayed in the display area 610. Further, as illustrated in FIG. 43, the generation unit 53 generates the screen 601 on which the past text information being displayed in the display area 652 is displayed in the display area 650 that places below the display area 610. FIG. 43 is a diagram illustrating a screen for displaying the current predetermined-area image at the communication terminal 9a, after registering the image capturing date and time.

According to FIGS. 42 and 43, since the specific image indicating the position of the specific area 631a specified in the past captured image can be superimposed on the specific area 611a of the current predetermined-area image in the display area 610, the user can easily recognize in the current captured image a part (for example, a part having a defect) in which the user has interest in the past captured image.

Further, according to FIGS. 42 and 43, since the past text information being displayed in the display area 652 can be displayed in addition to the current text information being displayed in the display area 650, the user can check a part of interest in the past captured image not only by the specific image but also by the text information, and thus can easily recognize the part of interest.

### Another Example of Screen Display Process (After Registration)

In the processing of Step S133 of FIG. 40, the generation unit 53 determines whether there is any icon representing the virtual camera IC1 and indicating a past image capturing position within a predetermined range (distance) from the current image capturing position. Alternatively, the generation unit 53 may determine whether a past captured image similar to the current captured image present.

When it is determined that there is a past captured image similar to the current captured image, the generation unit 53 specifies a predetermined icon at the past image capturing position associated with the past captured image similar to the current captured image in Step S135. The similarity of the image can be measured by using, for example, an existing image similarity index.

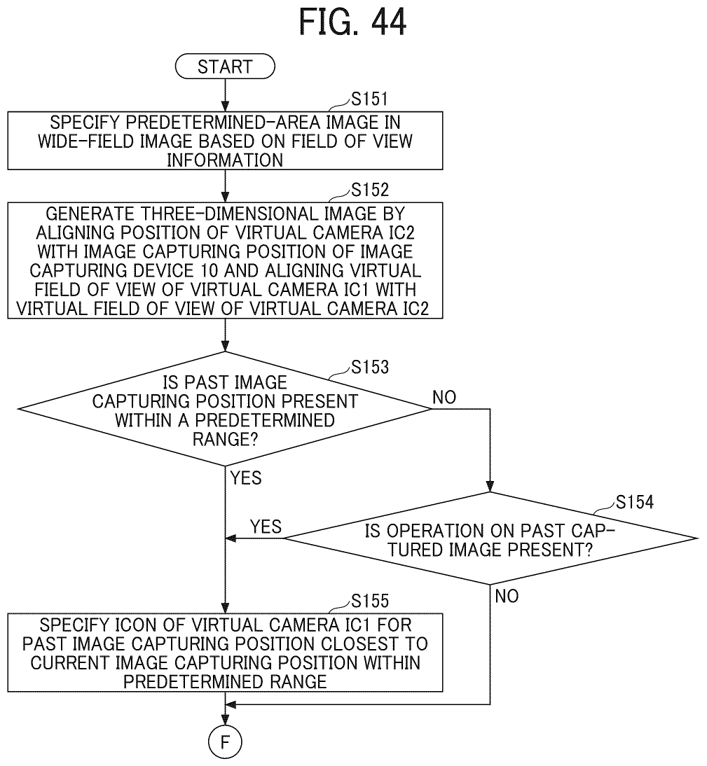

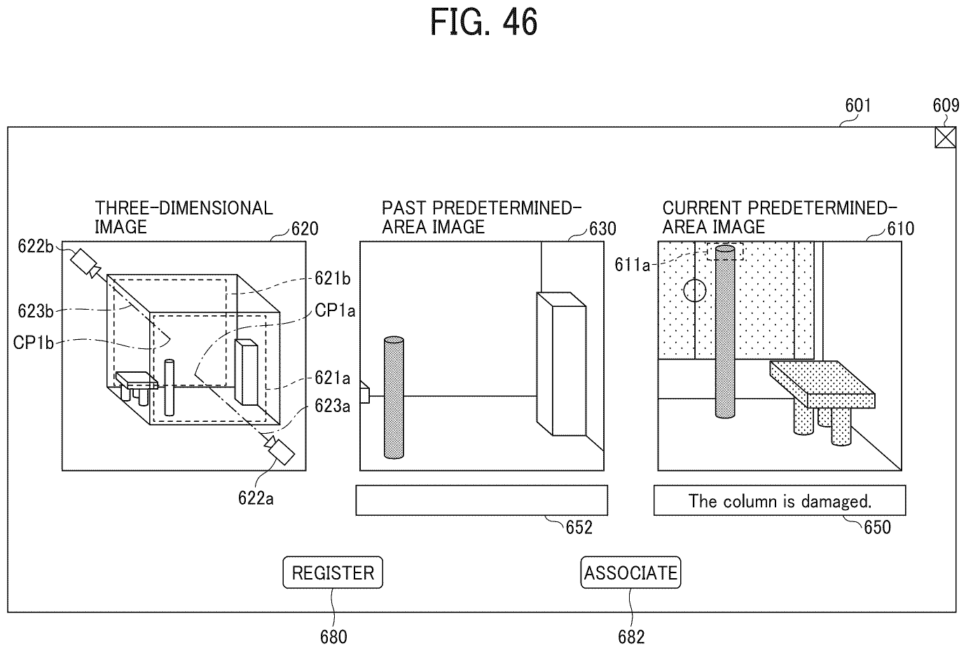

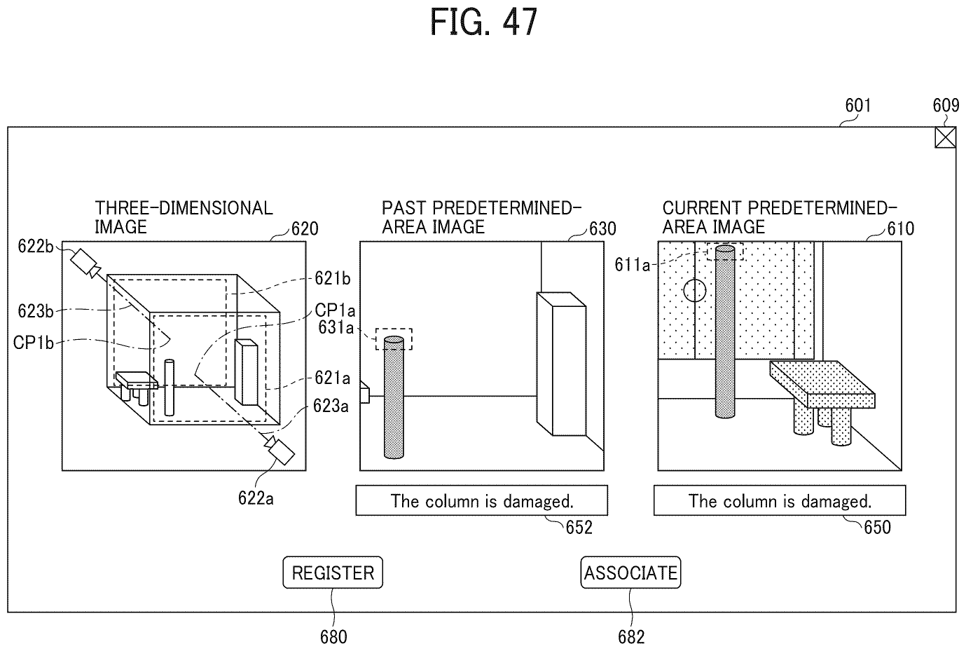

Among the screen display processes, Steps S13 to S15, of FIG. 19, the process of Step S14 is described below with reference to FIGS. 44 to 47. In FIGS. 46 and 47, the same reference numerals are given to the components in FIGS. 37 to 39, which function in substantially the same manner. When the participant A operates the communication terminal 9a, the reception unit 92 receives the operation, and the communication unit 91 transmits operation information indicating the content of the operation (operation content) to the communication control apparatus 5. Accordingly, at the communication control apparatus 5, the communication unit 51 that is an example of an acquisition unit acquires the operation information, and the generation unit 53 generates the screen 601 based on operation content indicated by the operation information. Then, the communication unit 51 transmits data on the screen 601 to the communication terminal 9a, and the communication unit 91 of the communication terminal 9a receives the data on the screen 601. Then, the display control unit 94 displays the screen 601, for example, on the display 507 of the communication terminal 9a. In this case, the communication control apparatus 5 is an example of an information processing apparatus.

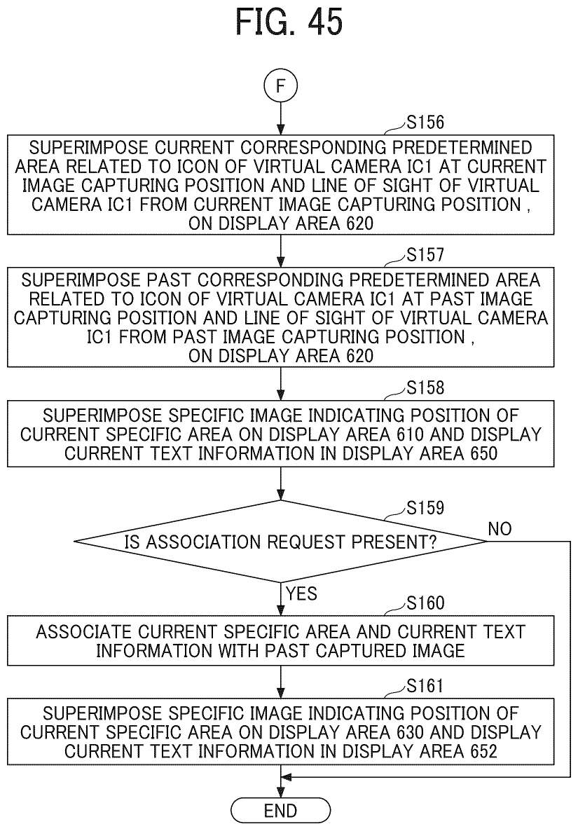

A process for generating the screen 601 to be displayed on the display 507 of the communication terminal 9a, performed by the communication control apparatus 5 is described below. In the processing of Step S13, the processing of Step S15, and the processing of Step S14, the operation of the communication control apparatus 5 is the same, but the terminals to display a screen differ. Thus, the description of the processing of Step S13 and the processing of Step S15 are omitted. FIGS. 44 and 45 are flowcharts of a process performed by the communication control apparatus in the screen display process after registering dates and times of image capturing.

The generation unit 53 of the communication control apparatus 5 generates the screen 601 to be displayed on the communication terminal 9a as illustrated in FIG. 46. FIG. 46 is a diagram illustrating a screen for displaying the current predetermined-area image at the communication terminal 9a, after registering the image capturing date and time. The screen 601 includes the display area 610, the display area 620, and a display area 630. The display area 610 is an example of a first captured image display area. The display area 620 is an example of a three-dimensional image area. The display area 630 is an example of a second captured image display area. In FIG. 46, the display area 610, the display area 620, and the display area 630 are displayed simultaneously in the same size on the screen 601. Alternatively, the display area 610, the display area 620, and the display area 630 may be displayed simultaneously in different sizes. Alternatively, one of the display area 610, the display area 620, and the display area 630 may be selectively displayed according to the selection made by the participant A. Alternatively, the display area 610, the display area 620, and the display area 630 may be displayed, respectively, on a first display, a second display, and a third display.

The display area 610 displays a predetermined-area image (see FIG. 6B), which is a predetermined area of the current wide-field image (see FIG. 6A). The current wide-field image is an example of the current image that is currently obtained by the image capturing device 10 by capturing an image of a target object.

The display area 620 displays a part or all of a three-dimensional image that includes a three-dimensional model representing the shape of the target object (table, column, etc.,) in three dimensions. In the three-dimensional image, the coordinates (an example of the first coordinates) of the wide-field image and the coordinates (an example of the second coordinates) are associated with each other.

The display area 630 displays a predetermined-area image (see FIG. 6B), which is a predetermined area of the past wide-field image (see FIG. 6A). The past wide-field image is an example of a past captured image that is previously obtained by the image capturing device 10 by capturing an image of a target object.

When the captured image is not the curved image such as the wide-field image, the display areas 610 and 630 each display a predetermined-area image, which represents a predetermined area that is the same area as that of the imaging area of the captured image.

The display area 620 displays a part or all of a three-dimensional image that includes a three-dimensional model representing the shape of the target object in three dimensions. In the three-dimensional image, the coordinates (an example of the first coordinates) of the wide-field image and the coordinates (an example of the second coordinates) are associated with each other.

The processing unit 54 aligns the positions of the display areas 610, 620, and 630 as described above. Then, as described above, the generation unit 53 generates the screen 601 including the display area 610, the display area 620, and the display area 630. The display area 610 displays the predetermined-area image, which represents a predetermined area of the current wide-field image. The display area 620 displays at least a part of the three-dimensional image in which the second position (second coordinates) is associated with the first position (first coordinates) in the wide-field image. The display area 630 displays the predetermined-area image, which represents a predetermined area of the past wide-field image, in which the third position (third coordinates) is associated with the first position (first coordinates).

Further, the screen 601 further includes the “REGISTER” button 680 and the “ASSOCIATE” button 682. The “REGISTER” button 680 is pressed to display the icon of the virtual camera IC1 in the display area 620 at a position corresponding to the image capturing position of the image capturing device 10. The virtual camera IC1 has an imaging area that is determined by a field of view (or field-of-view information) for specifying a predetermined-area of the predetermined-area image being displayed in the display area 610. The “ASSOCIATE” button 682 is pressed to associate a specific image indicating the position of a specific area 611a in the current captured image with the past captured image.

The display contents of the screen 601 are described in detail below. The virtual camera IC1 is used to specify the predetermined-area image displayed in each of the display areas 610 and 630 (see FIG. 8). The virtual camera IC2 described below is used to specify the three-dimensional image displayed in the display area 620.

Step S151: The generation unit 53 of the communication control apparatus 5 specifies, in the current wide-field image of the content data received by the communication unit 51, a current predetermined-area image to be displayed in the display area 610 as illustrated in FIG. 46, based on the virtual field of view of the virtual camera IC1 set in advance.

Step S152: The processing unit 54 aligns the position of the virtual camera IC2 with an image capturing position associated with the current wide-field image (content data) and aligns the virtual field of view of the virtual camera IC1 (an example of a first field of view), which is set in advance, with the virtual field of view of the virtual camera IC2 (an example of a second field of view). Accordingly, the generation unit 53 generates a three-dimensional image to be displayed in the display area 620.

As illustrated in FIG. 46, when the “REGISTER” button 680 is pressed, the same processing as the above-described processing of S113 to S116 are performed. Accordingly, the generation unit 53 can superimpose the corresponding predetermined area 621b at a position corresponding to the current image capturing position in the display area 620. The generation unit 53 can further superimpose the line 623b representing the line of sight of the icon 622b of the virtual camera IC1 with respect to the center point CP1b of the corresponding predetermined area 621b. The icon 622b is an example of an image indicating the first virtual camera.

Step S153: The generation unit 53 determines whether there is any icon representing the virtual camera IC1 and indicating a past image capturing position within a predetermined range (distance) from the current image capturing position. The predetermined range is, for example, 3 meters when an absolute position is assumed.

Step S154: When there is no past image capturing position within the predetermined range from the current image capturing position (Step S153: NO), the communication unit 51 determines whether an instruction to operate a past captured image has been acquired.

For example, the communication unit 51 determines whether an instruction to select (or designate) one icon from among multiple icons each representing the virtual camera IC1 and indicating a past image capturing position has been received from the participant A. When the communication unit 51 does not acquire an instruction to operate a past captured image (Step S154: NO), the communication unit 51 performs the processing of Step S156.

Step S155: When there is a past image capturing position within the predetermined range from the current image capturing position (Step S153: YES), or when an instruction to operate a past captured image is acquired (Step S154: YES), the generation unit 53 specifies a predetermined icon for a past image capturing position closest to the current image capturing position (the position of the icon 622b of the virtual camera IC1) within the predetermined range from the current image capturing position. In the example, the icon 622a is specified.

Step S156: The generation unit 53 superimposes, on the display area 620, the corresponding predetermined area 621b related to the icon 622b of the predetermined current virtual camera IC1. The generation unit 53 further superimposes, on the display area 620, the line 623b representing the line of sight of the virtual camera IC1 from the icon 622b to the center CP1b of the corresponding predetermined area 621b. The processing of Step S156 is substantially the same as or similar to that of Step S116.

Step S157: The generation unit 53 superimposes, on the display area 620, the corresponding predetermined area 621a related to the icon 622a of the predetermined current virtual camera IC1. The generation unit 53 further superimposes, on the display area 620, the line 623a representing the line of sight of the virtual camera IC1 from the icon 622a to the center CP1a of the corresponding predetermined area 621a. The processing of Step S157 is substantially the same as or similar to that of Step S116.

Step S158: The generation unit 53 superimposes a specific image indicating the position of the specific area 611a specified in the current captured image, on the display area 610 (an example of a first captured image display area) displaying a current predetermined-area image (an example of a first predetermined area image) corresponding to the icon 622b of the virtual camera IC1 as illustrated in FIG. 46. Further, the generation unit 53 displays text information of the time of capturing the current predetermined-area image in the display area 650 that places below the display area 610 of the screen 601.

Step S159: The processing unit 54 determines whether an association request is present or has been received. The association request is an instruction to associate a specific image indicating the position of the specific area 611a specified in the current captured image, between the current captured image and the past captured image, and received in response to a user operation of pressing the “ASSOCIATE” button 682 by the acquisition unit (the reception unit 92, the communication unit 51).

Step S160: When the association request or the instruction to associate is present (Step 159: YES), the processing unit 54 registers the specific area 611a being displayed in the display area 610 in the “SPECIFIC AREA INFORMATION” field of the movement history management DB 5004 (see FIG. 36) in association with the image and sound capturing date and time of the past predetermined-area image (predetermined area) being displayed in the display area 630. The processing unit 54 registers the current text (text information) being displayed in the display area 650 in the “TEXT INFORMATION FOR DIFFERENT DATE AND TIME” field of the movement history management DB 5004 (see FIG. 36) in association with the image and sound capturing date and time of the past predetermined-area image (predetermined area) being displayed in the display area 630.

Step S161: As illustrated in FIG. 47, the generation unit 53 generates the screen 601 in which a specific image of the specific area 631a indicating the position of the specific area 611a specified in the current captured image being displayed in the display area 610 is superimposed on and displayed in the display area 630. Further, as illustrated in FIG. 47, the generation unit 53 generates the screen 601 on which the current text information being displayed in the display area 650 is displayed in the display area 652 that places below the display area 630. FIG. 47 is a diagram illustrating a screen for displaying the current predetermined-area image at the communication terminal 9a, after registering the image capturing date and time.

According to FIGS. 46 and 47, since the specific image indicating the position of the specific area 611a specified in the current captured image can be superimposed on the specific area 631a of the past predetermined-area image in the display area 630, the user can easily recognize in the past captured image a part (for example, a part having a defect) in which the user has interest in the current captured image.

Further, according to FIGS. 46 and 47, since the current text information being displayed in the display area 650 can be displayed in addition to the past text information being displayed in the display area 652, the user can check a part of interest in the current captured image not only by the specific image but also by the text information, and thus can easily recognize the part of interest.

In the processing of Step S153 of FIG. 44, the generation unit 53 determines whether there is any icon representing the virtual camera IC1 and indicating a past image capturing position within a predetermined range (distance) from the current image capturing position. Alternatively, the generation unit 53 may determine whether a past captured image similar to the current captured image present.

When it is determined that there is a past captured image similar to the current captured image, the generation unit 53 specifies a predetermined icon at the past image capturing position associated with the past captured image similar to the current captured image in Step S155. The similarity of the image can be measured by using, for example, an existing image similarity index.

In the processing of Step S133 of FIG. 40 and the processing of Step S153 of FIG. 44, the generation unit 53 determines whether there is any icon representing the virtual camera IC1 and indicating a past image capturing position within a predetermined range (distance) from the current image capturing position. Alternatively, the generation unit 53 may determine whether past text information similar to the current text information being displayed in the display area 650 present.

When it is determined that there is past text information similar to the current text information, the generation unit 53 specifies a predetermined icon at the past image capturing position associated with the past text information similar to the current text information in Step S135 or in Step S155. The similarity of the text information can be measured by using, for example, an existing text similarity index.

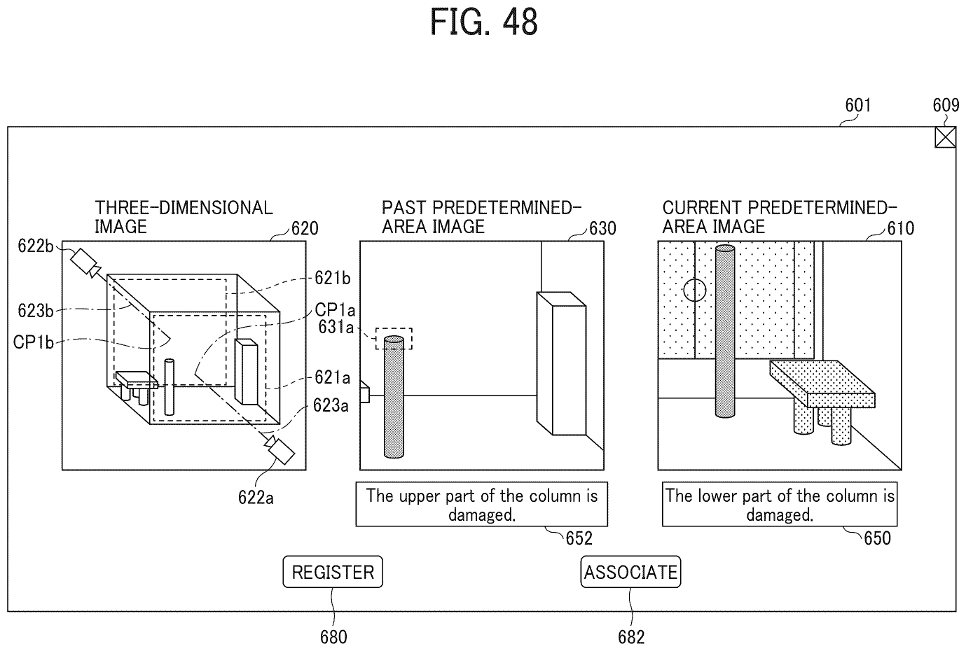

FIG. 48 is a diagram illustrating a screen for displaying the current predetermined-area image at the communication terminal 9a, after registering the image capturing date and time. In FIG. 48, the same reference numerals are given to the components in FIGS. 37 to 39, which function in substantially the same manner.

The generation unit 53 of the communication control apparatus 5 specifies, in the current wide-field image of the content data received by the communication unit 51, a current predetermined-area image to be displayed in the display area 610 as illustrated in FIG. 48, based on the virtual field of view of the virtual camera IC1 set in advance.

The processing unit 54 aligns the position of the virtual camera IC2 with an image capturing position associated with the current wide-field image and aligns the virtual field of view of the virtual camera IC1, which is set in advance, with the virtual field of view of the virtual camera IC2. Accordingly, the generation unit 53 generates a three-dimensional image to be displayed in the display area 620.

The generation unit 53 determines whether there is past text information similar to the current text information being displayed in the display area 650. When it is determined that there is past text information similar to the current text information being displayed in the display area 650, the generation unit 53 specifies a predetermined icon at the past image capturing position associated with the past text information similar to the current text information.

The generation unit 53 superimposes, on the display area 620, the corresponding predetermined area 621b related to the icon 622b of the predetermined current virtual camera IC1. The generation unit 53 further superimposes, on the display area 620, the line 623b representing the line of sight of the virtual camera IC1 from the icon 622b to the center CP1b of the corresponding predetermined area 621b.

Further, the generation unit 53 superimposes, on the display area 620, the corresponding predetermined area 621a related to the icon 622a of the predetermined current virtual camera IC1. The generation unit 53 further superimposes, on the display area 620, the line 623a representing the line of sight of the virtual camera IC1 from the icon 622a to the center CPla of the corresponding predetermined area 621a.

Then, the generation unit 53 superimposes a specific image indicating the position of the specific area 631a specified in the past captured image, on the display area 630 (an example of a second captured image display area) displaying a past predetermined-area image corresponding to the icon 622a of the virtual camera IC1 as illustrated in FIG. 48. Further, the generation unit 53 displays text information of the past predetermined-area image in the display area 652 that places below the display area 630 of the screen 601. When the “ASSOCIATE” button 682 is pressed, the processing unit 54 receives an instruction that is an association request for associating the current captured image and the past captured image that have text information similar to each other.

According to FIG. 48, since the current captured image and the past captured image having similar text information can be displayed on the screen 601, the user can easily check the current captured image and the past captured image having similar text information.

The past captured image displayed in the display area 630 is not limited to the captured image from the image capturing position aligned with the current captured image. The past captured image may be, for example, a captured image from an image capturing position different from that of the current captured image (for example, a captured image of another room, floor, or property having the same specifications).

According to the present embodiment described above, the processing unit 54 associates a first position in a captured image obtained by capturing a target object with a second position in a three-dimensional image including a three-dimensional area corresponding to the target object, and the generation unit 53 (or the generation unit 73, 93) generates the screen 601 including the display area 610, the display area 620, and the display area 630. The display area 610 displays a predetermined-area image that is the predetermined area in the captured image obtained by capturing the target object. The display area 620 displays at least a part of the three-dimensional image in which the first position in the captured image and the second position are associated with each other by the processing unit 54. The display area 630 displays a predetermined-area image that is the predetermined area in the wide-field image captured at a different date and time by the image capturing device 10.

Accordingly, the user can recognize what the predetermined-area image captures and where the predetermined-area image is captured by viewing the screen 601. Even if the back of an object is not captured, the user can check the state of the back of the object by viewing the screen 601. Accordingly, generating an image that complements the captured image obtained by image capturing enhances user convenience.

Further, the movement history management DB 5004 of FIG. 36 stores the image capturing date and time, the image capturing position, the field of view being displayed, the text (the text information for the current date and time and the text information for the different date and time), and the specific area in association. By so doing, when the participant A presses the “REGISTER” button 680 while the predetermined-area image is displayed in the display area 610, the processing unit 54 registers the image capturing date and time, the image capturing position, the field of view, the text information, and the specific area, for the captured image being displayed on the screen 601, in the movement history management DB 5004. Further, as illustrated in FIG. 42, the generation unit 53 superimposes the icon 622b of the virtual camera IC1 on the display area 620 at a position corresponding to the current image capturing position. The imaging area of the virtual camera IC1 is defined by the field of view represented by the current predetermined-area image being displayed. Further, as illustrated in FIG. 42, the generation unit 53 can display the icon 622a of the virtual camera IC1 at a past image capturing position in the display area 620. When the user such as the participant A presses the icon 622a, as illustrated in FIG. 42, the generation unit 53 generates the screen 601 to display a predetermined-area image of a past captured image indicting the field of view corresponding to the icon 622a in the display area 630, along with the text information. Accordingly, the user such as the participant A can check the past captured image associated with the position of the icon 622a of the virtual camera IC1, and the specific area 631a and the text information that are associated with the captured image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The number of each of the CPU 111, the CPU 301, and the CPU 501 serving as a processor that is hardware may be a single or multiple.

In FIG. 18, the text input by the users may be received by the reception unit 92 without using the text generation unit 56, and the text may be transmitted to the communication unit 51 of the communication control apparatus 5 via the communication unit 91, and the processing unit 54 may register the text in the movement history management DB 5004. The record at the time of registration is a record of the same image and sound capturing date and time as the date and time when the communication unit 51 receives the data of the text.

In the related art, by viewing a predetermined-area image corresponding to a viewable range of a wide-field image, the user can hardly recognize what is captured in the predetermined-area image or where the predetermined-area image is captured.

Further, an image capturing device captures a 360-degree view of the objects surrounding the image capturing position in a single imaging process. In other words, the image capturing device does not capture objects from all 360-degree directions relative to the object. Even if the object is within the imaging range, the back of the object may not be captured and the user is not able to check the state of the back of the object.

The above-described problem also occurs when the captured image is not a wide-field image that is a curved image.

According to an aspect of the present disclosure, an image that complements a captured image obtained by image capturing is generated and displayed to the user, thus enhancing user convenience.

1. An information processing apparatus, comprising
circuitry configured to generate a screen including a first captured image display area and a three-dimensional image display area, the first captured image display area displaying a first predetermined-area image being a first predetermined area of a first captured image, the first captured image being obtained by capturing an object by an image capturing device at a first image capturing position, the three-dimensional image display area displaying at least a part of a three-dimensional image aligned with the first captured image and a position image indicating a second image capturing position of the image capturing device at a specific image capturing date and time, wherein
the screen further includes a second captured image display area in which a specific image indicating a position of a specific area specified in a second captured image is superimposed on a second predetermined-area image being a second predetermined area of the second captured image, based on the second predetermined-area image and the specific area that are stored in a memory, the second captured image being obtained at the specific image capturing date and time associated with the second image capturing position.

2. The information processing apparatus of claim 1, wherein
the screen includes another position image indicating the first image capturing position in the three-dimensional image display area.

3. The information processing apparatus of claim 1, wherein
the screen includes a text display area to display text information in association with the specific image.

4. The information processing apparatus of claim 1, wherein
the circuitry is configured to generate the second captured image display area in the screen based on the first image capturing position and the second image capturing position.

5. The information processing apparatus of claim 1, wherein
the second captured image display area displays the specific image superimposed on the second captured image corresponding to the first captured image based on the first captured image.

6. The information processing apparatus of claim 3, wherein
the screen includes:
the text information corresponding to additional text information based on the text information in association with the second captured image and the additional text information in association with the first captured image; and
the specific image superimposed on the second captured image.

7. The information processing apparatus of claim 1, wherein
the circuitry is further configured to associate the specific area with the first captured image.

8. The information processing apparatus of claim 7, wherein
the screen includes a text display area to display text information in association with the specific image, and
the circuitry is further configured to associate the second captured image with the text information.

9. The information processing apparatus of claim 1, wherein
the circuitry is further configured to associate another specific area specified in the first captured image with the second captured image.

10. The information processing apparatus of claim 9, wherein
the screen includes a text display area to display text information in association with another specific image indicating a position of said another specific area specified in the first captured image, and
the circuitry is further configured to associate the second captured image with the text information.

11. The information processing apparatus of claim 1, wherein
the circuitry is further configured to specify at least one of another specific area in the first captured image or the specific area in the second captured image according to a user operation for specifying an area in at least corresponding one of the first captured image or the second captured image.

12. The information processing apparatus of claim 11, wherein
each of the specific area and said another specific area is specified by image recognition using text generated from voice captured with corresponding one of the first captured image and the second captured image, or using text input.

13. An information processing system, comprising:
the information processing apparatus of claim 1; and
a display terminal to display the screen, the display terminal being communicably connected to the information processing apparatus.

14. A screen generation method, comprising
generating a screen including a first captured image display area and a three-dimensional image display area, the first captured image display area displaying a first predetermined-area image being a first predetermined area of a first captured image, the first captured image being obtained by capturing an object by an image capturing device at a first image capturing position, the three-dimensional image display area displaying at least a part of a three-dimensional image aligned with the first captured image, the three-dimensional image including a position image indicating a second image capturing position of the image capturing device at a specific image capturing date and time, wherein
the screen further includes a second captured image display area in which a specific image indicating a position of a specific area specified in a second captured image is superimposed on a second predetermined-area image being a second predetermined area of the second captured image, based on the second predetermined-area image and the specific area that are stored in a memory, the second captured image being obtained at the specific image capturing date and time associated with the second image capturing position.

15. A non-transitory recording medium storing a plurality of instructions which, when executed by one or more processors, causes the one or more processors to perform a method, the method comprising
generating a screen including a first captured image display area and a three-dimensional image display area, the first captured image display area displaying a first predetermined-area image being a first predetermined area of a first captured image, the first captured image being obtained by capturing an object by an image capturing device at a first image capturing position, the three-dimensional image display area displaying at least a part of a three-dimensional image aligned with the first captured image, the three-dimensional image including a position image indicating a second image capturing position of the image capturing device at a specific image capturing date and time, wherein
the screen further includes a second captured image display area in which a specific image indicating a position of a specific area specified in a second captured image is superimposed on a second predetermined-area image being a second predetermined area of the second captured image, based on the second predetermined-area image and the specific area that are stored in a memory, the second captured image being obtained at the specific image capturing date and time associated with the second image capturing position.
